(19) United States
(12) Patent Application Publication
(10) Pub. No.: US 2023/0399115 A1
(43) Pub. Date: Dec. 14, 2023

(54) RANGE EXTENDING ENERGY POD (REEP) FOR AN AIRCRAFT

(71) Applicant: VerdeGo Aero, Inc., De Leon Springs, FL (US)

(72) Inventors: Richard Pat Anderson, De Leon Springs, FL (US); David N. Spitzer, Port Orange, FL (US); Austin Cassels, Daytona Beach, FL (US); Eric Richard Bartsch, Wilmette, IL (US)

(21) Appl. No.: 18/236,363

(22) Filed: Aug. 21, 2023

Related U.S. Application Data
(63) Continuation of application No. PCT/US22/17379, filed on Feb. 22, 2022.
(60) Provisional application No. 63/280,615, filed on Nov. 17, 2021.
(60) Provisional application No. 63/163,165, filed on Mar. 19, 2021.
(60) Provisional application No. 63/151,760, filed on Feb. 21, 2021.

(51) Int. Cl. B64D 27/24

(52) U.S. Cl. CPC B64D 27/24; B64D 2027/026

(57) ABSTRACT

An energy source for an aircraft includes an enclosure, an engine, an electric generator, and at least one fuel tank configured to provide fuel to the engine; and electrical connectors for outputting power generated by the electric generator to at least one electrical component or electrical bus of the aircraft. The engine, the electric generator, and the at least one fuel tank are each housed within the enclosure.

### CROSS-REFERENCE TO RELATED PATENT APPLICATIONS

This application is a continuation of PCT/US2022/017379, filed Feb. 22, 2022, which claims the benefit of U.S. Provisional Patent Application No. 63/280,615, filed Nov. 17, 2021, U.S. Provisional Patent Application No. 63/163,165, filed Mar. 19, 2021, and U.S. Provisional Patent Application No. 63/151,760, filed Feb. 21, 2021, the entire contents of each of which are hereby incorporated by reference in their entirety.

### BACKGROUND

Various types of aircraft may be used to transport goods or people, used as a hobby, etc. Various types of aircraft may identify a range based on their fuel capacity, aircraft type, engine or other propulsion system type, weather conditions, etc. That range may be indicative of how far that aircraft can safely fly in given conditions. Aircraft may not operate safely if it is attempted to fly the aircraft beyond its particular range.

### SUMMARY

In an embodiment, an energy source for an aircraft includes an enclosure, an engine, an electric generator, and at least one fuel tank configured to provide fuel to the engine; and electrical connectors for outputting power generated by the electric generator to at least one electrical component or electrical bus of the aircraft. The engine, the electric generator, and the at least one fuel tank are each housed within the enclosure.

In an embodiment, a method for using a removable energy source for an aircraft includes mounting the removable energy source to the aircraft. The removable energy source comprises an engine and an electric generator, and the engine and the electric generator are each housed within the enclosure. The method further includes connecting first electrical connectors of the removable energy source to second electrical connectors of the aircraft. The method further includes outputting power from the electric generator of the removable energy source to at least one electrical component or electrical bus of the aircraft.

In an embodiment, a energy source for an aircraft includes an enclosure, an engine, an electric generator, and mounting hardware for attaching the energy source to the aircraft. The energy source for the aircraft further includes electrical connectors for outputting power generated by the electric generator to at least one electrical component or electrical bus of the aircraft. The engine and the electric generator are housed within the enclosure.

### BRIEF DESCRIPTION OF THE DRAWINGS

FIG. 1 illustrates a perspective view of an aircraft having a range extending energy pod (REEP) in accordance with an illustrative embodiment.

FIG. 2 is a perspective view of an example range extending energy pod (REEP) therein in accordance with an illustrative embodiment.

FIG. 3 is a side view of the REEP of FIG. 5 in accordance with an illustrative embodiment.

FIG. 4 is a front view of the REEP of FIG. 5 in accordance with an illustrative embodiment.

FIG. 5 is a perspective view of the REEP of FIG. 5, showing an enclosure of the REEP as being partially transparent in accordance with an illustrative embodiment.

FIG. 6 is a perspective view of another range extending energy pod (REEP), showing an enclosure of the REEP as being partially transparent in accordance with an illustrative embodiment.

FIG. 7 is a front view of the REEP of FIG. 6 in accordance with an illustrative embodiment.

FIG. 8A is a side view of the REEP of FIG. 6 in accordance with an illustrative embodiment.

FIG. 8B is a flow chart illustrating an example method for using a REEP in accordance with an illustrative embodiment.

FIG. 9A illustrates an example flexible architecture for an aerospace hybrid system in accordance with an illustrative embodiment.

FIG. 9B illustrates an additional example flexible architecture for an aerospace hybrid system in accordance with an illustrative embodiment.

FIG. 10A illustrates a block diagram representative of a first aircraft control system for use with a flexible architecture for an aerospace hybrid system in accordance with an illustrative embodiment.

FIG. 10B illustrates a block diagram representative of a second aircraft control system for use with a flexible architecture for an aerospace hybrid system in accordance with an illustrative embodiment.

FIG. 11 illustrates a first example aircraft with which a flexible architecture for an aerospace hybrid system may be used in accordance with an illustrative embodiment.

FIG. 12 illustrates a second example aircraft with which a flexible architecture for an aerospace hybrid system may be used in accordance with an illustrative embodiment.

FIG. 13 illustrates a third example aircraft with which a flexible architecture for an aerospace hybrid system may be used in accordance with an illustrative embodiment.

FIG. 14 is a flow chart illustrating a first example method for using a flexible architecture for an aerospace hybrid system in different flight phases of an aircraft with a main pusher propeller in accordance with an illustrative embodiment.

FIG. 15 is a flow chart illustrating a second example method for using a flexible architecture for an aerospace hybrid system in different flight phases of an aircraft with a main pusher propeller in accordance with an illustrative embodiment.

FIG. 16A illustrates an example flexible architecture for an aerospace hybrid system having a flywheel in accordance with an illustrative embodiment.

FIG. 16B illustrates an example flexible architecture for an aerospace hybrid system having a flywheel and a spring coupling in accordance with an illustrative embodiment.

FIG. 17 illustrates a perspective view of an example flexible architecture for an aerospace hybrid system in accordance with an illustrative embodiment.

FIG. 18 illustrates a top view of the example flexible architecture of FIG. 17 in accordance with an illustrative embodiment.

FIG. 19 illustrates a side view of the example flexible architecture of FIG. 17 in accordance with an illustrative embodiment.

FIG. 20 illustrates a perspective view of another example flexible architecture for an aerospace hybrid system in accordance with an illustrative embodiment.

FIG. 21 illustrates example downstream and upstream components for propelling an aircraft in accordance with an illustrative embodiment.

FIG. 22 illustrates an example schematic of a cooling system for a hybrid powerplant in accordance with an illustrative embodiment.

FIG. 23 illustrates an example hybrid powerplant with a cooling system in accordance with an illustrative embodiment

FIG. 24 illustrates a cross-sectional view of the example hybrid powerplant with a cooling system of FIG. 23 in accordance with an illustrative embodiment.

FIG. 25 illustrates a partial cross-sectional perspective view of the example hybrid powerplant with a cooling system of FIG. 23 in accordance with an illustrative embodiment.

FIG. 26 illustrates a second example schematic of a cooling system for a hybrid powerplant in accordance with an illustrative embodiment.

FIG. 27 illustrates a third example schematic of a cooling system for a hybrid powerplant in accordance with an illustrative embodiment.

FIG. 28 illustrates a fourth example schematic of a cooling system for a hybrid powerplant in accordance with an illustrative embodiment.

FIG. 29 illustrates a fifth example schematic of a cooling system for a hybrid powerplant in accordance with an illustrative embodiment.

FIG. 30 illustrates a top view of an example hybrid powerplant with a cooling system in accordance with an illustrative embodiment.

FIG. 31 illustrates a cross-sectional view taken along line A-A of FIG. 30 showing the example hybrid powerplant of FIG. 30 in accordance with an illustrative embodiment.

FIG. 32 illustrates a cross-sectional view taken along line B-B of FIG. 31 showing the example hybrid powerplant of FIG. 30 in accordance with an illustrative embodiment.

FIG. 33 illustrates an alternate view of the example hybrid powerplant of FIG. 30 showing detail of cooling fins of an engine in accordance with an illustrative embodiment.

FIG. 34 illustrates a side view of the example hybrid powerplant of FIG. 30 with a cooling system in accordance with an illustrative embodiment.

FIG. 35 is a diagrammatic view of an example system for providing a direct current (DC) bus with a stable voltage, in accordance with an illustrative embodiment.

FIG. 36 is a flow chart illustrating an example method for maintaining a stable DC bus voltage based on communications from an aircraft-level controller, in accordance with an illustrative embodiment.

FIG. 37 is a flow chart illustrating an example method for maintaining a stable DC bus voltage based on measurements by a hybrid-electric genset-level controller, in accordance with an illustrative embodiment.

FIG. 38 is a diagrammatic view of an example of a computing environment, in accordance with an illustrative embodiment.

FIG. 39 illustrates a side cross-sectional view of an enclosure having noise reduction components in accordance with an illustrative embodiment.

FIG. 40A is a front perspective view showing an air inlet of an example enclosure having noise reduction components therein in accordance with an illustrative embodiment.

FIG. 40B is a side view showing the example enclosure of FIG. 40A in accordance with an illustrative embodiment.

FIG. 40C is a rear view showing the example enclosure of FIG. 40A in accordance with an illustrative embodiment.

FIG. 40D is a top view showing the example enclosure of FIG. 40A in accordance with an illustrative embodiment.

FIG. 41 is a rear perspective view showing an air outlet of the enclosure of FIG. 40A in accordance with an illustrative embodiment.

FIG. 42 is a top perspective view of noise reducing channels in the noise reducing chamber of the enclosure of FIG. 40A in accordance with an illustrative embodiment.

FIG. 43 is a top perspective view of another example enclosure having noise reduction components therein in accordance with an illustrative embodiment.

FIG. 44 is a side view of the enclosure of FIG. 43 in accordance with an illustrative embodiment.

FIG. 45 is a front view of the enclosure of FIG. 43 in accordance with an illustrative embodiment.

FIG. 46 is a perspective view of the enclosure of FIG. 43, showing the enclosure as being partially transparent in accordance with an illustrative embodiment.

FIG. 47 is a perspective view of another example enclosure, showing the enclosure as being partially transparent and having noise reduction components therein in accordance with an illustrative embodiment.

FIG. 48 is a top view of the enclosure of FIG. 47 in accordance with an illustrative embodiment.

FIG. 49 is a side view of the enclosure of FIG. 47 in accordance with an illustrative embodiment.

FIG. 50 is a rear view of the enclosure of FIG. 47 in accordance with an illustrative embodiment.

FIG. 51 is a rear view of the enclosure of FIG. 47, except showing the enclosure as opaque in accordance with an illustrative embodiment.

### DETAILED DESCRIPTION

Aviation today is undergoing a revolution with the widespread adoption of electrified propulsion. Many vehicles are under development across the globe where the delivery of power to fans/props/rotors used for propulsion, lift, and/or control is via electrical wire rather than mechanical shaft. The use of electricity to transfer power to locations remote from its creation and storage is a design factor for many new designs.

Electrified propulsion relies on three key factors: system voltage, energy, and power. Energy is the total storage capacity (measured in kilowatt-hours or kWh) while power is a measure of the flow of energy (measured in kW). Furthermore, many new-generation aircraft using distributed electric propulsion may rely on direct current (DC) for the storage and transmission of the power and energy.

A common device for storing electrical energy and delivery power is a battery pack. With batteries, the conversion of energy involves chemistry—energy or power are added to the battery pack for storage (resulting in a chemical transformation) and then later extracted from the battery pack in a reverse reaction for use as needed. Another device used for storage of energy or power is supercapacitors or ultracapacitors. While these devices can deliver exceptionally high power levels, the total energy storage is very low for a given product weight so they are seldom chosen for primary energy storage on aircraft.

Battery packs may be comprised of individual cells arranged into modules and further arranged into a battery pack of multiple battery modules or packs. Safety regulations and performance requirements may require the use of battery management systems (to maintain balanced cell voltages throughout multiple charge/discharge cycles), cooling systems, venting in case of fire or other unwanted release of chemical products/gases, and/or safety circuitry. All these support systems may contribute to the total mass of the battery pack(s). In many cases, the specific energy of complete battery packs suitable for safe operation on manned aircraft (measured in watt hours per kilogram (Wh/kg)) is far below that which is may be required by an aircraft design and given mission for an aircraft. In short, current batteries may be too heavy for many aircraft designs today and/or for many missions/flight plans desired to be implemented by aircraft today.

Described herein are hybrid-electric gensets to help address the problem of battery's low specific energy. In particular, the high energy density of liquid fuels may be used in an engine to convert to shaft power, and a generator may be used to convert that power to electricity. In this way, the specific energy of the total system can be much higher than batteries, depending on the amount of fuel on board the aircraft. As described herein, hybrid-electric gensets of various embodiments of the present application may deliver more than six times (6×) the specific energy (energy per unit of mass) of a battery and at a desired power level.

Those hybrid-electric gensets may include components for interface and interaction of physical mounts, wiring, liquid fuel storage, and airflow between the aircraft and the hybrid-electric genset. In some cases, an aircraft may be complete with no design provision for the addition of an internal genset but only a plan for battery storage of energy. As such, it may be desirable to have supplemental energy or power in certain circumstances without having to redesign major aspects of the aircraft. As such, the availability of the range-extending energy pods (REEPs) would be highly useful. The REEPs described herein may perform the same exact function as an external battery: attachment of a physical item and an electrical connection.

As such, described herein are various embodiments for a range-extending energy pod (REEP) for an aircraft. The REEP may include a hybrid-electric powerplant and/or other various desired elements in a single, compact package or enclosure. Within the enclosure, an engine, electric generator, one or more fuel tank(s), etc., and anything else for supplying electrical power to an electrified aircraft may be included. As such, the REEP could be advantageously removably connected to an aircraft whenever additional power is desired. For example, some aircraft may have a particular, limited range. However, the REEP as described herein may be attached to such an aircraft to supply additional electric power and thereby extend the range of the aircraft. In this way, the REEP may act similar to a battery from the perspective of the aircraft, in that the REEP may just plug into the existing electrical system of the aircraft such as through a high voltage bus and supply power to the aircraft as a battery would.

The REEP may also include mounting hardware so that the REEP may be easily mechanically fastened to the aircraft and removed from the aircraft as desired. For example, the REEP may be bolted to an aircraft, and electrical connectors, such as two high-voltage wires, may be plugged in. Then the aircraft may be supplied with significant power or energy beyond what its permanently affixed on-board systems may be able to provide. The electrical power or energy from the REEP may be used to drive propulsion systems (e.g., electric motors configured to turn rotors, propellers, etc.) and/or may be used for other purposes by the aircraft, such as powering other electronics (e.g., accessories) or charging batteries of the aircraft. The embodiments described herein therefore advantageously provide for additional power and energy to be used by aircraft.

Battery-powered electric aircraft may be able to perform missions or flights that conventional aircraft using conventional powerplant solutions cannot perform or would not be permitted to perform. For example, electric aircraft may be able to takeoff or land in smaller spaces that conventionally powered aircraft may not be able to takeoff or land in. Electric aircraft may also be permitted to operate in areas where conventional aircraft would not be permitted to operate, for example due to the large amount of noise created by some conventional aircraft.

However, batteries may be quite heavy and, in many cases, may supply insufficient energy or power to enable a given mission or flight path (e.g., may not supply enough energy or power for certain power intensive tasks like takeoff or landing, or may not supply enough energy for a long enough flight route as desired). As such, described herein are various embodiments for a hybrid-electric powerplant genset that converts liquid fuel to electrical energy and power that may be utilized by an electric aircraft (or any aircraft with electric components). The range extending energy pods (REEPs) described herein may advantageously include any fuel, power conversion, thermal treatment, and wiring to make the REEPs (which may function as a hybrid battery) completely independent of the aircraft fuselage and simple to install. As just one example, a REEP may be attached to an aircraft using four bolts for support and two wires to transfer the electricity. As such, the REEPs described herein may be attached to aircraft that have their own propulsion mechanisms and powerplants, such that those aircraft may fly with or without the REEP attached. Instead, the REEP may provide additional power beyond what the aircraft has on its own without the REEP, for example to extend the range of the aircraft, the speed at which the aircraft may fly, etc.

As just one example, an embodiment may include storage for a volume of fuel that is suitable for delivery of 185 kilowatts (kW) of power at 800 volts direct current (VDC) for 3 hours nonstop. This is approximately 555 kilowatt hours (kWh) of energy. Such an embodiment may have a weight of approximately 450 kg, giving an energy density of over 1200 watt hours per kilogram (Wh/kg). Current battery packs available today for aviation, when considered at the pack level including cooling components and required battery management hardware to maintain safe operation, may only deliver a maximum energy density of approximately 200 Wh/kg. As such, example embodiments described herein may provide at least a sixfold benefit based on energy per unit weight compared to battery systems. The embodiments herein also provide for significant simplicity of use for that significant gain in energy density, as the REEPs described herein may be removably attached to an aircraft, for example using only 4 bolts and a simple electrical connection.

Example embodiments of a REEP may include an integrated hybrid-electric genset (e.g., any of the flexible architectures described herein, such as under the Flexible Architecture Elements heading below), which may include provision for power conversion from liquid fuel to direct current (DC) electrical power (e.g., including any of the components described herein related to power components, such as under the Direct Current (DC) Bus Elements heading below). The hybrid-electric genset may further include one or more integrated cooling systems (e.g., any of the cooling systems or elements described herein, such as under the Air Cooling Elements heading below). Example embodiments of a REEP may further include one or more storage tanks for liquid fuel, along with components to safely connect this fuel storage to the hybrid-electric genset. Example embodiments of a REEP may further include noise reduction elements (e.g., any of the noise reduction components described herein, such as under the Noise Reduction Elements heading below).

Example embodiments of a REEP may further include various physical structures, such as an enclosure (e.g., cowling) for the elements of the REEP, mounting hardware, such as a physical frame for the elements of the REEP, holes for bolts used to mount the REEP, etc. For example, a structural frame of the REEP may be attachable to an aircraft at just four attachment points. In other embodiments different numbers of attachment points may be used. The attachment points may be located on or extend below a bottom of the REEP (e.g., for mounting on top of existing aircraft surfaces), located on or extending above the system (e.g., for mounting under existing aircraft surfaces), or may be configured in any other way as desired to provide mounting points for the REEP to attach to an aircraft. Mounting hardware may also include any aspect of a REEP that is designed to facilitate connection of the REEP to an aircraft. For example, any sort of mechanical structure configured to be attached to an aircraft may be part of the mounting hardware. For example, if a cowling, housing, or enclosure of the REEP is designed to be flush with and welded or otherwise fastened to a surface or portion of an aircraft, the cowling, housing, or enclosure may also be mounting hardware. If a frame on which components of the REEP inside a cowling, housing, or enclosure are mounted is also used to securely attach the REEP to an aircraft (e.g., bolting a portion of the frame of the REEP to a portion of the aircraft), the frame or structural component of the REEP may also be part of the mounting hardware.

An enclosure of the REEP may be or may include an aerodynamic firewall package to control cooling flows, limit transmission of system noise, reduce aerodynamic drag, and/or provide a clean integrated package. In other words, the enclosure may house the elements of the REEP to make them more aerodynamic, more visually appealing, safer, and less noisy. The entire REEP including the enclosure may be attached to an aircraft, for example, with 4 bolts. The attachment points may be arranged with enough lateral and longitudinal spread spacing to provide suitable support for the hybrid-electric genset in terms of strength and stiffness. The total weight of an example REEP may be about 1000 pounds (lbs) in an embodiment, so the attachment hardware may include 4×AN-4 bolts (¼-28) in such an embodiment.

Electrical connectors may be used for the transfer of high-voltage current (energy and power). Depending on voltage, this may be a single pair of wires (positive and negative) or more pairs of wires. For example, one embodiment of a REEP may provide 800 VDC with up to 185 kW of power. Such an embodiment may therefore have 230 amps (A) of DC current and a single wire pair using a 3/0 or 4/0 wire size may be used. In various embodiments, other sizes of wire and number of wires may be used.

Various embodiments may also have electrical or electronic communication between the REEP and a control system of the aircraft, thereby allowing the aircraft systems to influence and/or control the startup or shutdown of the REEP and/or the flow of energy and power from the REEP. This same communication interface may provide system health and stability information of the REEP for aircraft and pilot use. As such, additional wiring may be used to connect the REEP and the aircraft for communication and control.

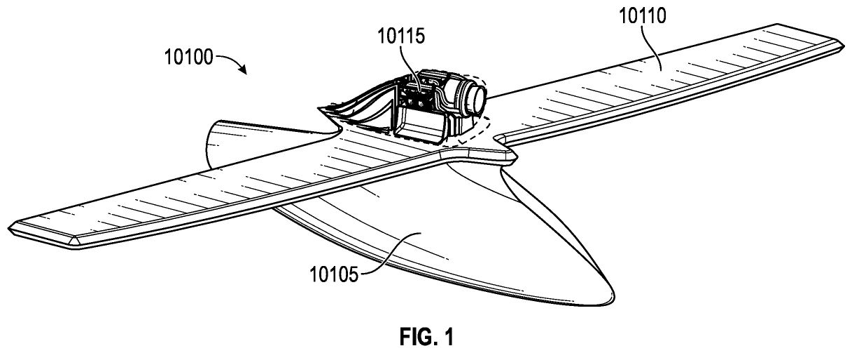

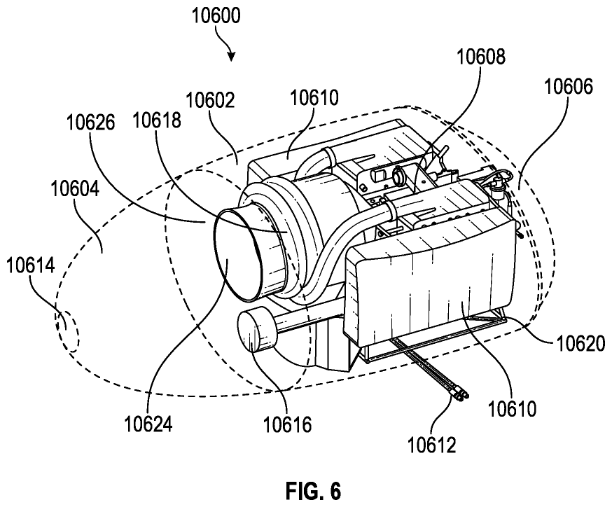

Various embodiments also provide for a REEP that has good aerodynamic performance. Since the REEP is configured to attach to an aircraft, such as an external surface of an aircraft, the REEP advantageously has an aerodynamic profile so as not to affect the flight of the aircraft negatively. In other embodiments, the REEP may fit in a battery enclosure of an aircraft within a fuselage or other aerodynamically designed portion of an aircraft, such that the enclosure may not be aerodynamically designed. Examples of aerodynamic shapes may include enclosures with a rounded external shell to provide low drag when connected to an aircraft. Such a shape (e.g., as shown in FIGS. 6-8) may provide surfaces that are distant from any adjacent aircraft surface, so the REEP is designed to be aerodynamic on its own. Other embodiments (e.g., as shown in FIGS. 1-5) may have an enclosure with an external shell designed to blend and coordinate with adjacent aircraft surfaces. To facilitate such blending and aerodynamic coordination, the REEP may be designed with a principal external shell that makes up ˜80% of the shell, leaving a ˜20% of the shell to be designed for a specific aircraft usage, providing an aerodynamic margin that is specific to each aircraft. In various embodiments, other proportions than 80/20 may be used for the portion of a shell/enclosure that is set versus a portion of the shell/enclosure that is customizable based on the target aircraft. As such, the REEPs may be optimized to be aerodynamic with different aircraft.

In various embodiments, the REEPs described herein may be used to retrofit an aircraft that may not have been designed to have internal spaces or other configurations/spaces to hold a hybrid powerplant internally. As such, an aircraft without a hybrid powerplant may have one or more hybrid powerplants added in the form of the REEPs described herein. In other words, the REEPs described herein may be removable (e.g., put on and taken off an aircraft for certain missions/uses) or may be used to retrofit an aircraft (e.g., where it is desired to use a REEP more permanently for an aircraft, such that an aircraft designed without provisions for hybridization may still be converted or retrofit to have a hybrid powerplant).

FIG. 1 illustrates a perspective view of an aircraft 10100 having a range extending energy pod (REEP) 10115 in accordance with an illustrative embodiment. The REEP 10115 is attached to a middle of a wing 10110 and fuselage 10105 of the aircraft 10100. This may be mounted as such so that the REEP 10115 does not imbalance the aircraft 10100. In various embodiments, more than one REEP may be used. In such embodiments, the multiple REEPs may each be placed along a middle axis of an aircraft, or may be placed equidistant from the middle axis so that the aircraft continues to be balanced even where more than one REEP is used. In embodiments where the REEPs are placed on either side of the middle axis of the aircraft, it may be desirable to have an even number of REEPs to balance the aircraft. In various embodiments, REEPs may be mounted on the underside or top side of a wing away from the fuselage, for example. As such, a REEP may be connected to an aircraft similar to a drop tank that is attachable to aircraft at specific hardpoints on one or more wings (e.g., to hang from a wing). In various embodiments, REEPs may be connected to any other part of an aircraft as desired. As described herein the REEP 10115 may be removable from the aircraft 10100 so that it is only used when desired (e.g., for a longer flight). The REEP may be connected to the aircraft 10100 via mechanical fasteners such as bolts, and may electrically connect to the aircraft 10100 via wired connectors that may be releasably attached to a connector of the aircraft 10100. Although not shown in FIG. 1, the aircraft 10100 may have propulsion systems that are powered by electricity (e.g., DC power from the REEP 10115), such that the REEP, at least in part, powers the aircraft 10100.

In various embodiments, a REEP may also be connected to an aircraft in a more permanent or non-removable way. For example, a housing of a REEP may be connected to a portion of an aircraft using a more permanent method of affixation, such as welding, riveting, or bonding the housing to the wing, fuselage, or other component of an aircraft. In this way, the more permanent attachment than bolts, for example, make the REEP a more permanent installation on the aircraft. Accordingly, the REEPs described may be a self-contained engine, generator, fuel tank, firewall, and noise mitigation all contained within a housing or enclosure that may be removable from an aircraft by disconnecting mechanical connectors or may be more permanently attached to an aircraft. In any case, the enclosure/housing may wall off the components inside at a distinct location outside the fuselage, so that it advantageously isolates these components from the fuselage, offering risk management advantages (e.g., less fire risk at or near the fuselage). In various embodiments, the REEP accomplishes these and other goals by having various components within a housing or enclosure, where the only components that may pass through the enclosure or housing are wiring for power output and/or control signals. The enclosure or housing may also be an aerodynamic enclosure as described and shown herein, such that the REEP may not create to much drag being outside the fuselage, and can be removable as described herein, or at least placed on an aircraft in a more permanent way without redesigning an existing aircraft to accommodate the REEP. For example, hardware such as bolts, nuts, etc. that may be used to connect a REEP to an aircraft may be considered removable because they may be unfastened non-destructively (e.g., they may be used to put on the REEP to an aircraft more than once). In various embodiments, if a component of the REEP is welded to, riveted to, bonded to etc. an aircraft, those fastening mechanisms may only be destructively removed, and therefore may be used when a more permanent connection of the REEP to the aircraft is desired. In various embodiments, mechanisms that may be removed non-destructively may be used alone, mechanism that may be removed only destructively may be used alone, or mechanisms that may be both destructively and non-destructively removed may be used to fasten or otherwise secure a REEP to an aircraft. In addition, the enclosure of the REEPs described herein also serves as a mechanism to channel and reduce noise that is output by the REEP (e.g., including the noise reduction components described herein). As such, the REEP advantageously offers a package of components that provides power to an aircraft either removably or permanently without having to redesign an aircraft or otherwise add components like noise reduction components beyond attaching the REEP itself.

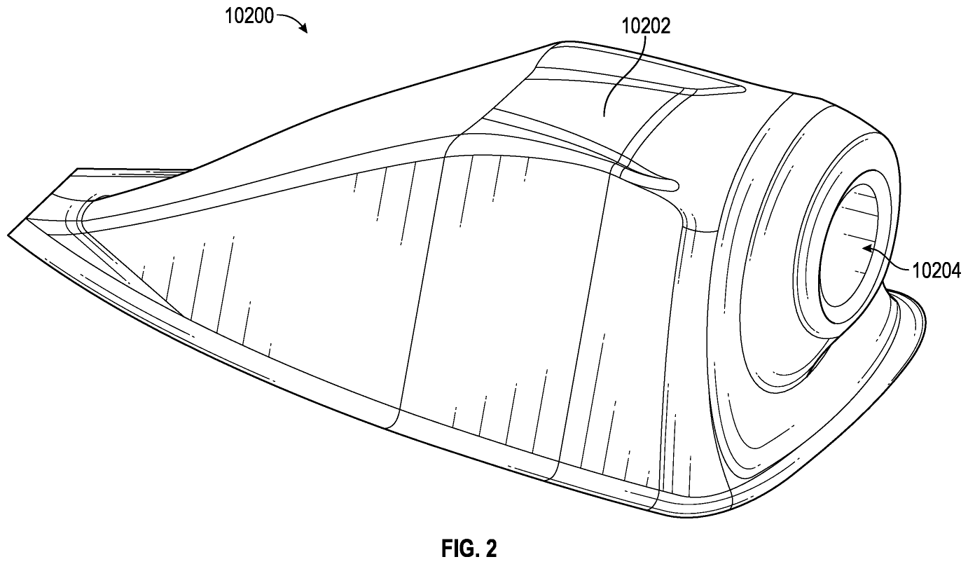

FIG. 2 is a perspective view of an example range extending energy pod (REEP) 10200 therein in accordance with an illustrative embodiment. The REEP 10200 includes an enclosure 10202 and an air inlet 10204. The air inlet 10204 may be used to take in air for an engine, cooling, etc. As described herein, the REEP 10200 may be aerodynamically designed for attachment to an aircraft, such as the aircraft 10100 in FIG. 1.

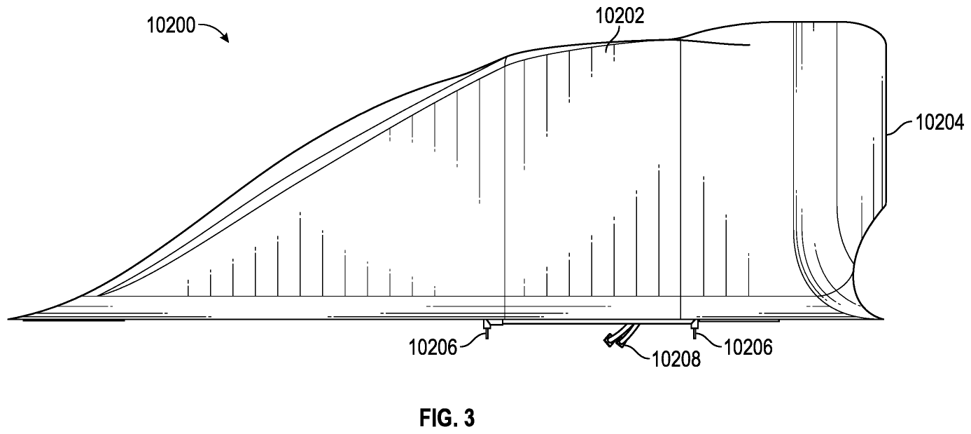

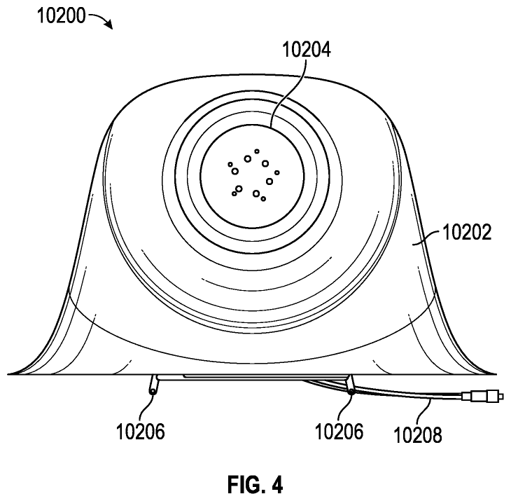

FIG. 3 is a side view of the REEP 10200 of FIG. 2 in accordance with an illustrative embodiment. FIG. 4 is a front view of the REEP 10200 of FIG. 2 in accordance with an illustrative embodiment. The REEP 10200 further includes attachment hardware 10206 and wiring 10208, so that the REEP 10200 may be attached to an aircraft, such as the aircraft 10100 as described herein. For example, the attachment hardware 10206 may be connected to a structural frame that supports the components of the REEP 10200, and to which the components of the REEP 10200 may be mounted. The attachment hardware 10206 may further accommodate fasteners for attaching the REEP 10200 to an aircraft, such as bolts. The wiring 10208 may output power to an aircraft or other power consuming or distribution device. The wiring 10208 may output AC power as it is generated by an electric machine (e.g., generator), or may output DC power (e.g., after being converted from AC to DC power by an inverter of the REEP 10200).

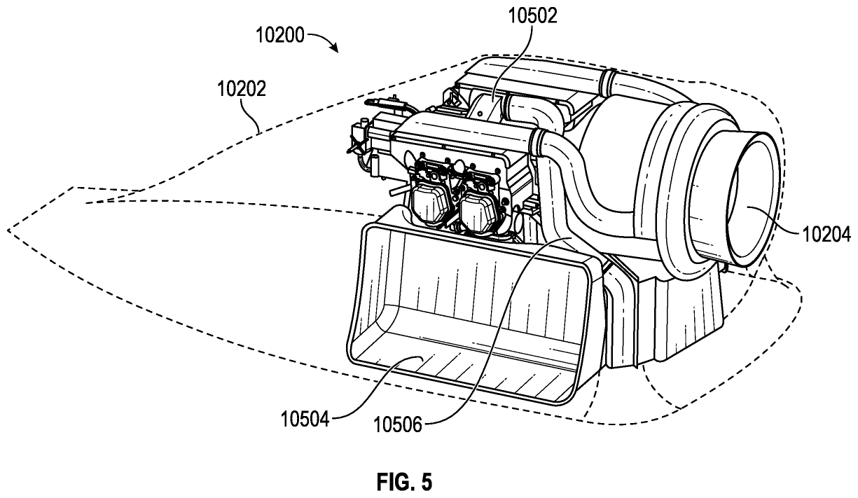

FIG. 5 is a perspective view of the REEP 10200 of FIG. 2, showing the enclosure 10202 of the REEP as being partially transparent in accordance with an illustrative embodiment. The REEP 10200 as shown in FIG. 5 further includes a hybrid-electric genset as described herein (e.g., in the Flexible Architecture Elements, Air Cooling Elements, Direct Current (DC) Bus Elements, and/or Noise Reduction Elements sections below). As such, within the enclosure 10202, for example, may be included an engine, electric generator, cooling system(s), noise reduction elements, power electronics for supplying DC power and energy, etc. In addition, a fuel tank 10504 may be included to store fuel to be consumed by an engine of the hybrid-electric genset. While only a single fuel tank 10504 is shown, another fuel tank may be placed on the opposite side of the enclosure 10202 to balance the weight of the REEP 10200. Fuel from the fuel tank 10504 may be moved to the engine of the REEP 10200 via tubing 10506, for example. Also not shown in FIG. 5, one or more of the fuel tanks (e.g., the fuel tank 10504) may have openings or ports that facilitate filling the fuel tanks, and those openings may be in or may pass through the enclosure 10202. Such openings may also be fitted with caps or other similar covering so that no fuel may escape the fuel tanks while the fuel tanks are not being filled. In various embodiments where there are multiple fuel tanks, there may also have a balance tube running between the multiple fuel tanks so that the tanks may balance fuel between them, and allow for easy filling of multiple fuel tanks at once.

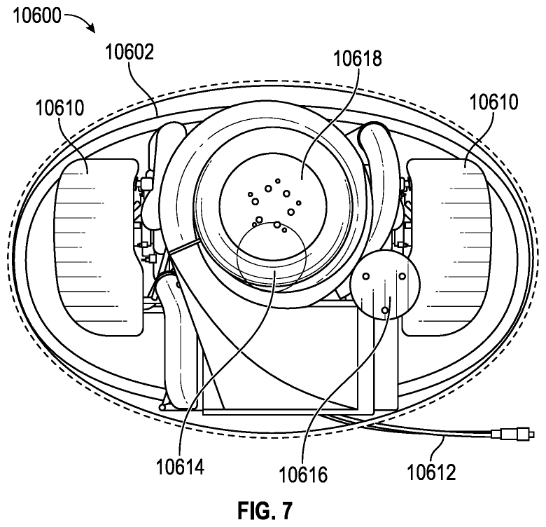

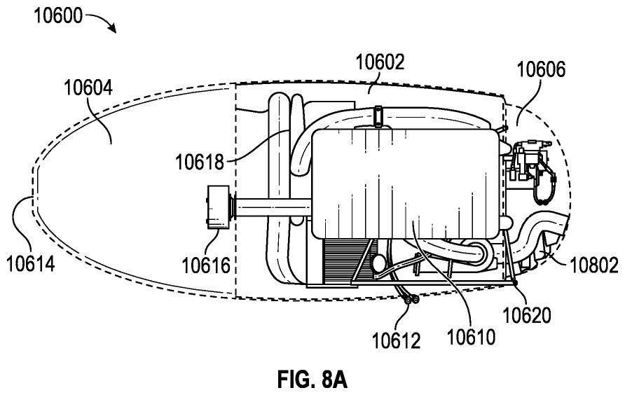

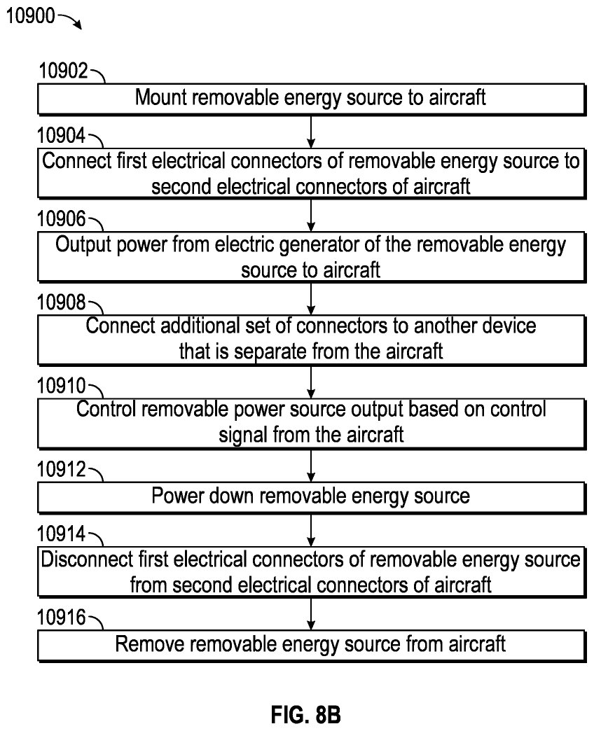

FIG. 6 is a perspective view of another range extending energy pod (REEP) 10600 showing an enclosure 10602 of the REEP as being partially transparent in accordance with an illustrative embodiment. FIG. 7 is a front view of the REEP 10600 of FIG. 6 in accordance with an illustrative embodiment. FIG. 8A is a side view of the REEP 10600 of FIG. 6 in accordance with an illustrative embodiment. The enclosure 10602 may again house a hybrid-electric genset 10608 and fuel tanks 10610, similar to FIG. 5 described above. The REEP 10600 may also include a structural frame 10620, to which components of the REEP 10600 may be permanently affixed, and which may provide for removable attachment to an aircraft (e.g., the structural frame 10620 may also serve as mounting hardware).

Air may enter a cooling system 10618 at inlet 10624, which may be formed in an inner wall 10626 separating a main compartment of the enclosure 10602 from a noise reduction chamber 10604 of the enclosure 10602. Similarly, another noise reduction chamber 10606 may be affixed to the back of the enclosure 10602 and again may have a wall separating the noise reduction chamber 10606 from the main compartment of the enclosure 10602. The noise reduction chambers 10604 and/or 10606 may have noise reduction elements (e.g., channels formed by walls of noise attenuating material as described herein) within. In this way, the REEP 10600 may be designed to minimize noise output by the REEP 10600 during use.

The REEP 10600 further includes wiring 10612 configured to removably electrically connect the REEP 10600 to an aircraft as described herein. The power and energy supplied to the aircraft may be DC power and energy, such as would be supplied by a battery pack. In this way, aircraft that are designed to work off of battery power may be supplied with power from the REEP 10600 without having to change how the battery powered components of the aircraft operate.

The REEP 10600 further includes an air inlet filter 10616 which admits filtered air into the engine 10608 for combustion and to produce power.

FIG. 8A further shows that the noise reducing chamber 10606 of the enclosure 10602 may have an air outlet 10602. In this way, air used by the cooling system 10618 may have a way to be output, but such that the air passes through the noise reducing chamber to reduce noise that is released into the atmosphere.

FIG. 8B is a flow chart illustrating an example method 10900 for using a REEP. At an operation 10902, the removable energy source or REEP is mounted to an aircraft. As described herein, the REEP may include an engine and an electric generator, where the engine and the electric generator are each housed within the enclosure. At an operation 10904, first electrical connectors of the REEP are connected to second electrical connectors of the aircraft. At an operation 10906, power is output from the electric generator of the REEP to at least one electrical component or electrical bus of the aircraft. In various embodiments, the REEP may also have a third set of electrical connectors so that the REEP may be electrically connected to another power consuming or distribution device that is not the aircraft. As such, at 10908, the additional or third set of connectors may be connected to another device that is separate from the aircraft to power another device without disconnecting the REEP from the aircraft. In various embodiments, the REEP may output AC power from the electric generator of the REEP, or the REEP may include an inverter so that the AC power from the electric generator may be converted to DC power for output by the REEP through any of its connectors. In various embodiments, the REEP may be configured to output AC power through a first set of connectors and DC power through a second set of connectors.

At 10910, the REEP may be controlled based on a control signal from the aircraft transmitted through the first electrical connectors and second electrical connectors, which may include connectors for controls wiring. For example, one or more controls wires/connectors may be used to receive, from a controller of the aircraft at a controller of the removable energy source, a throttle control signal or power request signal via the connectors. In this way, the aircraft may be able to control the amount of power generated and output to the aircraft. In various embodiments, other types of control signals and/or wiring/connectors may be used between the REEP and the aircraft. For example, status signals from the REEP may be transmitted to the aircraft, such as different sensor readings in the REEP (e.g., temperature, fuel level, power currently being output, etc.). Other signals may be transmitted from the aircraft to the REEP to control the REEP, such as an on/off signal to power the REEP up or down, whether to output AC or DC power and how much of each, etc.

At 10912, the REEP is powered down such that power is no longer being output to the aircraft from the REEP. At 10914, the electrical connectors of the REEP are disconnected from the electrical connectors of the aircraft. At 10916, the REEP is removed from the aircraft. In this way, the method 10900 demonstrates how a REEP may be attached to an aircraft to supply power to that aircraft, and how that REEP may also be removable from the aircraft. In this way, the REEP may be a temporary and removable power source for an aircraft.

As such, described herein are various embodiments for a REEP that may be affixed to an aircraft (using either components that are non-destructively removable or destructively removable) to provide electrical energy used to drive propulsion systems elsewhere on the aircraft (e.g., propulsion motors, rotors, etc. that are not part of the REEP or within the housing/enclosure of the REEP). Such an aircraft may therefore function with the REEP removed (e.g., the aircraft may have its own built-in or internal energy source while the REEP provides an external, additional energy source for providing electric power to the aircraft). The REEP may, for example, be connected to an electrical bus and/or other components such as wiring in the aircraft, where at least one electric propulsion motor and/or at least one propulsive battery (e.g., a battery used to power a propulsion motor) attached to the electric bus and/or other components. In this way, the REEP may be configured to augment the electrical energy already contained in other parts of the aircraft. As such, the REEP may provide energy to the same propulsive motors that may also be fed by batteries or other energy sources elsewhere on the aircraft than where the REEP is mounted or affixed. The REEP may therefore serve as an external energy source to supplement or augment the power already available to the aircraft from its own or internal energy source. The REEP or external energy source may therefore allow an aircraft to be flown or be flyable with or without the REEP/external energy source attached to the aircraft via a structural connection.

### Flexible Architecture Elements

Aircraft typically have custom designed propulsion mechanisms and methods for powering those propulsion mechanisms. In this way, the propulsion mechanisms and power supplied to those propulsion mechanisms can be optimized to provide the amount of propulsion needed for a particular type and size of aircraft, while minimizing weight of the components in the aircraft. In other words, the propulsion mechanisms and power for those propulsion mechanisms are often optimized for a particular type and size of aircrafts such that components of one aircraft could not be easily used in a different types of aircraft drive architectures, such as direct drive aircraft, parallel drive aircraft, and serial drive aircraft.

Described herein are various embodiments for a flexible architecture for an aerospace hybrid system and optimized components thereof. A hybrid system may be or may include a system where fuel is burned in a piston, rotary, turbine, or other engine, and an output of the piston engine may be operatively connected to an electric generator for outputting electric power. The embodiments described herein may include flexible systems that can provide power for many different types of aircraft and propulsion mechanisms. Such systems may advantageously reduce the complexity of designing different types of aircraft, may reduce the costs of manufacturing such systems as less customization allows for economies of scale in mass producing the systems, and ultimately may reduce the complexity of aircraft that use the systems described herein.

The flexible architectures described herein may further be used to provide power to propulsion mechanisms in different ways, either in a same aircraft or in different aircraft. For example, a flexible architecture for providing power to propulsion mechanisms may be able to operate in multiple different modes to provide power to different types of propulsion mechanisms. A first aircraft may utilize one, some, or all of the multiple different modes in which the flexible architecture may operate. A second aircraft may utilize one, some, or all of the multiple different modes, and the modes utilized by the second aircraft may be different than those utilized by the first aircraft.

Therefore, different aircraft may take advantage of different modes of providing power to propulsion mechanisms provided by the flexible architectures described herein. While use of the flexible architectures may be customized in this way, the physical hardware of the flexible architectures may be adapted to use by different aircraft with minimal or no changes to the physical components of the flexible architectures described herein. Instead, the use of different modes in different aircraft may be accomplished largely based on how the components of the flexible architectures are controlled using a processor or controller. As such, computer readable instructions may therefore also be stored on a memory operably coupled to a processor or controller, such that when the instructions are executed by the processor or controller, a computing device that includes the processor or controller may control the various components of the flexible architectures described herein to utilize any possible mode of use desired for a particular implementation, aircraft, flight phase, etc.

Power generation and propulsion systems for aircraft may also utilize various cooling systems to ensure that the various components of an aircraft remain at safe temperatures for operation, as well as maintaining components within temperature ranges where they may operate more efficiently. Further described herein are advantageous cooling systems that leverage various aspects of the hybrid architecture described herein to efficiently cool components of a flexible architecture for providing power to propulsion mechanisms of an aircraft.

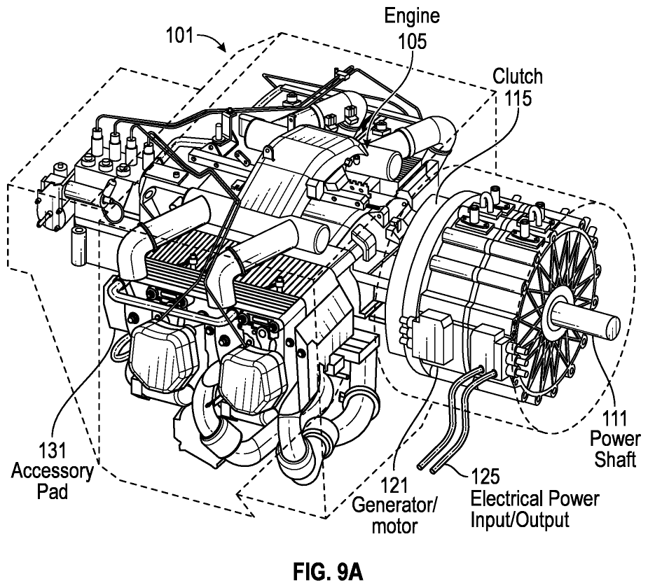

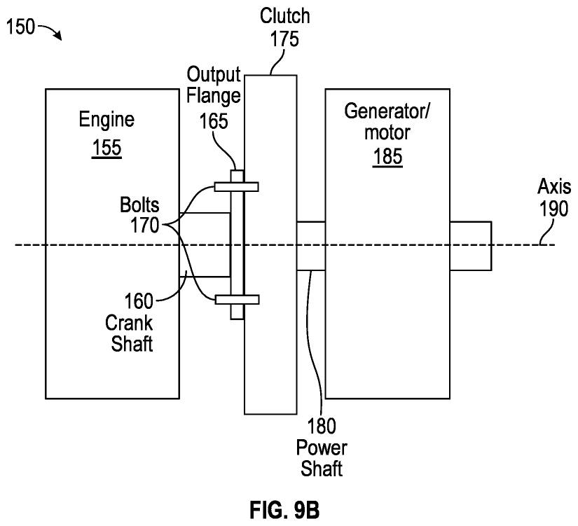

Aircraft that have hardware for providing different modes of power to its propulsion mechanisms, may have a variety of components for which it may be desirable to provide cooling. Thus, a single cooling system that efficiently moves air to the different components that enable different modes of power may cut down on weight of the aircraft, as well as power consumption of the cooling systems. FIGS. 1-8 and their accompanying description below specifically relate to example flexible architectures for providing power to propulsion systems of an aircraft, and FIGS. 9-21 and their accompanying description below relate to various embodiments of cooling systems for the example flexible architectures.

FIG. 9A illustrates an example flexible architecture 101 for an aerospace hybrid system in accordance with an illustrative embodiment. As discussed herein, the flexible architecture 101 may be efficiently used in a wide array of applications with a single hybrid generator system that can be applied in multiple ways depending on the aircraft requirements and phase of flight (e.g., used in different modes).

The flexible architecture 101 of FIG. 9A is a hybrid generator that includes an engine 105, a clutch 115, a generator/motor 121, and a power shaft 111. As described further below, the flexible architecture 101 may be used to implement various different modes depending on requirements of a specific aircraft installation or a specific phase of flight as desired. The engine 105 may be a combustion engine, such as an internal combustion engine. The engine 105 may further specifically be one of a piston internal combustion engine, a rotary engine, or a turbine engine. Such engines may use standard gasoline, jet fuel (e.g., Jet A, Jet A-1, Jet B fuels), diesel fuel, biofuel substitutes, etc.. In various embodiments, other types of engines may also be used, such as a smaller engine for drone implementations (e.g., a Rotax gasoline engine).

As described above, the engine 105 may be a piston combustion engine. A piston combustion engine may advantageously spin an output rotor or shaft at rotations per minute (RPMs) that may be more desirable for direct output to power a generator and/or a propulsion mechanisms (e.g., a propeller) than other engines. For example, a piston combustion engine may have an output on the order of thousands of RPMs. For example, a piston combustion engine may have an output anywhere from 2200 to 2500 RPM, which may be a desirable RPM for a propeller. In particular, a propeller may be designed to have a size that yields a desired tip speed of the propeller based on the RPM output of the piston combustion engine (e.g., of 2200 to 2500 RPM). Other types of engines, such as a turbine engine, may output rotational power on the order of tens of thousands of RPMs, much higher than a piston combustion engine. Another embodiment may drive the motor/generator at the higher RPM of a turbine engine to benefit the efficiency, power output, or other important factors. In some embodiments, a gear box could be added between the output of a high RPM engine and the other components of FIG. 9A to step down the output RPM of the engine 105. However, the addition of a gear box may also add weight to the system that is undesirable in some embodiments. A piston combustion engine may further be advantageous with respect to noise as compared to turbine engines. Turbine engines typically are louder than piston combustion engines, and the noise perceived by humans from a turbine engine is typically more offensive to a listener than the noise produced by a piston combustion engine. Quieter engines may also be more valuable in urban or more dense settings where reduced noise is desirable.

The engine 105 may output rotational power to the clutch 115, which may be controlled to engage or disengage the power shaft 111. In other words, the power shaft 111 may be engaged with the rotational output of the engine 105 by the clutch 115, so that rotational force may be transferred between the engine 105 output and the power shaft 111. When the clutch 115 disengages the output of the engine 105 and the power shaft 111, the power shaft 111 may rotate independently of the output of the engine 105. The clutch 115 may be physically located between the engine 105 and the generator/motor 121, and may even contact the engine 105 and the generator/motor 121 on opposing sides in order to reduce the overall footprint of the flexible architecture. In FIG. 1A and further described herein and shown in other figures is the clutch 115. However, in various embodiments, any mechanism that is capable of releasably decoupling the engine 105 and the power shaft 111 may be used additionally or alternatively to a clutch. For example, this decoupling may be based on absolute rotations per minute (RPM) or relative RPM between the engine 105 output and the power shaft 111, such as in an overrunning clutch.

The generator/motor 121 may also be engaged or disengaged with the power shaft 111. In other words, the generator/motor 121 may be controlled to switch off such that rotation of the power shaft 111 does not cause the generator/motor 121 to generate electrical power. Similarly, the generator/motor 121 may also be controlled to switch on such that the rotation of the power shaft causes the generator/motor 121 to generate electrical power. The generator/motor 121 is referred to as a generator/motor because it may function as either a generator or a motor. In various embodiments, the generator/motor 121 may be referred to as an electric machine, where an electric machine may be an electric generator, an electric motor, or both.

The flexible architecture further includes an electrical power input and output (I/O) 125 connected to the generator/motor 121. As described further herein, the generator/motor 121 may generate electrical power based on rotation of the power shaft 111 that is output via the electrical power I/O 125 or may receive electrical power via the electrical power I/O 125 that may be used to drive the power shaft 111. Wiring for the electrical power I/O 125 may include more than one wire. In various embodiments, the wiring for inputting electric power into the generator/motor 121 may be the same wiring that is used for outputting electric power out of the generator/motor 121. In various other embodiments, first wiring may be used for input of electric power and different second wiring may be used for output of electric power (so that different wires are used for input and output). In various embodiments, the generator/motor 121 may also have wiring connected thereto that is used for control of the generator/motor 121, to relay sensor or other data about the operation of the generator/motor 121 to a controller, etc.

The generator/motor 121 may also act as a driver for the power shaft 111. Upon receiving electrical power via the electrical power I/O 125 from batteries or some other form of electrical energy storage elsewhere in the system, the generator/motor 121 may impart a rotational force on the power shaft 111 to drive the power shaft 111. This may occur as long as the generator/motor 121 is controlled to be switched on to engage with the power shaft 111. If the generator/motor 121 is controlled to be switched off such that it does not engage with the power shaft 111, the power shaft 111 may not be rotated by the generator/motor 121.

Electrical power output from the electrical power I/O 125 may be used to drive an electric motor for an electric propulsion mechanism (e.g., a propeller). Electrical power output from the electrical power I/O 125 may also be used to power and/or charge other devices on an aircraft or aerospace vehicle. For example, electrical power output from the electrical power I/O 125 may be used to charge one or more batteries. The electrical power output from the electrical power I/O 125 may also be used to power other devices or accessories on an aircraft or aerospace vehicle. Because the electrical power I/O 125 also has an input, the power shaft 111 may be driven by any electrical power received via the electrical power I/O 125, such as power from one or more batteries. The power generated by the generator/motor 121 may be an alternating current (AC) power. That AC power may be converted by power electronics (e.g., a rectifier or inverter) into direct current (DC) power and output to a DC bus. That DC bus may be connected to batteries and/or an electric propulsion mechanism. In this way, the electric propulsion mechanism may be supplied with power via a DC bus. In various embodiments, a motor of the electric propulsion mechanism may use AC power, and the DC power from the DC bus may therefore be converted from DC power to AC power before it is used by the electric propulsion mechanism (e.g., by an inverter). In various embodiments, the AC power generated by a generator may be fed directly to a motor or other device without being converted to DC power and back again. In such embodiments, such AC power may be transmitted via an AC power bus or similar wiring.

Any rotation of the power shaft 111 itself, whether driven by the engine 105 or the generator/motor 121, may also be used to drive one or more propulsion mechanisms. For example, rotation of the power shaft 111 may be used to direct drive a propeller or may be used to power an electric motor that drives a propulsion mechanism. The rotation of the power shaft 111 may also drive a gearbox operably connected to another component, such as one or more propellers, one or more rotors, or other rotating devices for various uses on an aircraft.

An accessory pad 131 may also be coupled to the engine 105, and may include a lower voltage direct current (DC) generator for electrical power that is separate from the generator/motor 121 and the electrical power I/O 125, which may be configured for high voltage and high power I/O. In some embodiments, the generator/motor 121 may also have two different windings and the electrical power I/O 125 may have two different outputs (e.g., high voltage and low voltage). Accessory power may be associated with one of the electrical power I/O 125 outputs in addition to or instead of the accessory pad 131 output. The accessory pad 131 may be used to provide power to devices or accessories on an aircraft or aerospace vehicle that does not require high voltage or current outputs that may be output by the generator/motor 121 at the electrical power I/O 125. A high voltage (HV) of an aircraft may be, for example, 400 volts (V) or 800 V, but may also be anywhere between 50 V to 1200 V. A low voltage (LV) of an aircraft may be 12 V, 14 V, 28 V, or any other voltage below 50 V.

FIG. 9B illustrates an additional example flexible architecture 150 for an aerospace hybrid system in accordance with an illustrative embodiment. In particular, the flexible architecture 150 of FIG. 9B includes some components that may be the same as or similar to the components described above with respect to FIG. 9A, including an engine 155, a clutch 175, a power shaft 180, and/or a generator/motor 185. The flexible architecture 150 further illustrates the output of the engine 155 in the form of a crankshaft 160, which is rigidly connected to an output flange 165. The output flange 165 is rigidly connected to one side of the clutch 175 with bolts 170.

The clutch 175 may be configured to engage the power shaft 180 to translate rotational motion from the crankshaft 160 and the output flange 165 to the power shaft 180. The clutch 175 may be further configured to disengage the power shaft 180 such that the power shaft 180 may rotate independently with respect the crankshaft 160 and the output flange 165. In addition, FIG. 9B demonstrates how the rotatable components of the flexible architecture 150 may be all be aligned along a single axis 190. The rotatable components of FIG. 9A may similarly be aligned along a single axis as shown in FIG. 9B. In addition, the power shaft 180 may be a splined shaft that fits into an inner diameter opening of the clutch 175 and the generator/motor 185. Other features than a spline may also be used, such as a taper. In any case, the generator/motor 185 and/or the clutch 175 may be configured to accommodate and connect to a spline, taper, or other feature on the power shaft 180 so that the components may properly engage with one another.

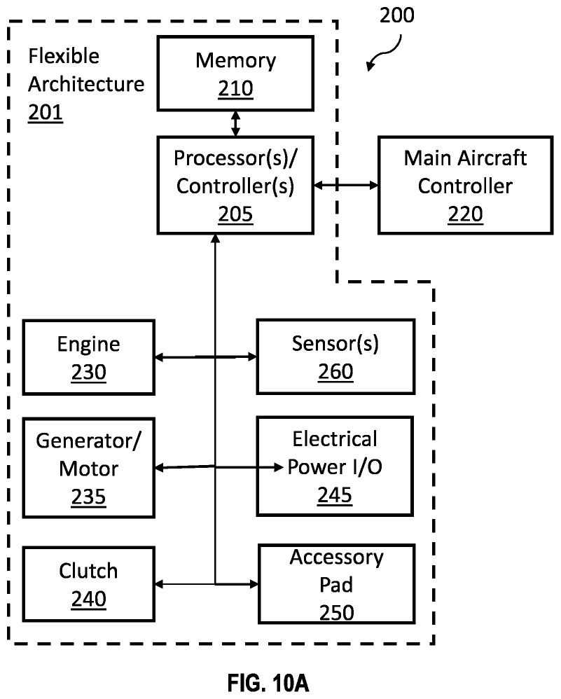

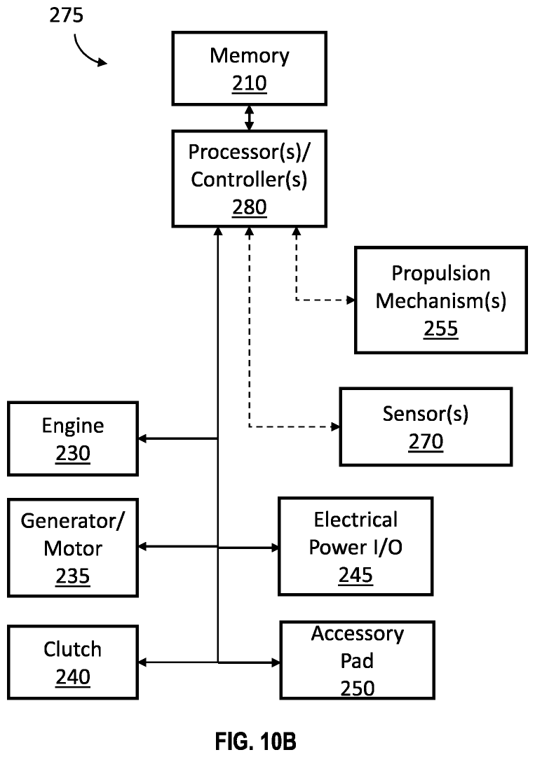

In various embodiments, the clutch 175 may be different types of clutches or other mechanisms capable of decoupling the power shaft 180 from the output of the engine 155. For example, the clutch 175 may be a plate style clutch, and may be a dry or wet clutch. Such a plate style clutch may be engaged/disengaged or otherwise controlled mechanically, hydraulically, and/or electrically (e.g., by controllers 205, 220, and/or 280 of FIGS. 10A and Plate style clutches may also have different numbers of plates, such as 3, 5, or 10 plates. In various embodiments, the clutch 175 or any other clutch described herein may be a one-way clutch, overrunning, or sprag clutch. The one-way or sprag clutch may be configured to disengage the output of the engine from the power shaft while the electric machine is rotating the power shaft faster than the output of the engine. In other words, if the engine 155 is outputting less power than the generator/motor 185 onto the power shaft 180, the clutch 175 may automatically mechanically disengage the output of the engine 155 from the power shaft 180, for example without any electrical control input used to accomplish said disengagement. Upon the engine 155 having a higher RPM or outputting more power than the generator/motor 185, the one-way or sprag clutch may then engage so that power is applied from the output of the engine 155 to the power shaft 180. Another type of clutch that may be used is a centrifugal clutch, where weights in the plates of a clutch trigger one or more levers progressively as the RPM increases to squeeze the plates of the centrifugal clutch and engage the plates to connect, for example, the output of the engine 155 and the power shaft 180.

Advantageously, the generator/motor 121 of FIG. 9A and/or the generator/motor 185 of FIG. 9B may be used as a starter for the engine 105 or the engine 155, respectively. In other words, the generator/motor 185 may be used to turn the crankshaft 160 while the clutch 175 is engaged in order to start up the engine 155. Such a system may be advantageous where, for example the generator/motor 185 may be powered by a battery or other electrical power source. The engine 155, which may be a piston combustion engine as described herein, therefore may not require separate starter components, reducing the weight and complexity of the flexible architectures described herein.

FIG. 10A illustrates a block diagram representative of an aircraft control system 200 for use with a flexible architecture 201 for an aerospace hybrid system in accordance with an illustrative embodiment. The aircraft control system 200 may be used, for example, to implement one or more of the various modes discussed below in which the flexible architectures described herein may be used. The flexible architecture 201 may be the same as, similar as, or may have some or all of the components of the flexible architectures 101 and/or 150 of FIGS. 9A and/or 9B. The aircraft control system 200 may include one or more processors or controllers 205 (hereinafter referred to as the controller 205), memory 210, a main aircraft controller 220, an engine 230, a generator/motor 235, a clutch 240, an electrical power I/O 245, an accessory pad 250, and one or more sensor(s) 260. The connections in FIG. 10A indicate control signal related connections between components of the aircraft control system 200. Other connections not shown in FIG. 10A may exist between different aspects of the aircraft and/or aircraft control system 200 for providing electrical power, such as a high voltage (HV) or low voltage (LV) power for an aircraft.

The memory 210 may be a computer readable media configured for instructions to be stored thereon. Such instructions may be computer executable code that is executed by the controller 205 to implement the various methods and systems described herein, including the various modes of using the flexible architectures herein and combinations of those modes. The computer code may be written such that the various methods of implementing different modes of the flexible architectures herein are automatically implemented based on various inputs that indicate, for example, a particular flight phase (e.g., landing, takeoff, cruising, etc.). In various embodiments the computer code may be written to implement the various modes herein based on input from a user or pilot of the aircraft or aerospace vehicle, or may be implemented based on a combination of user input and automatic implementation based on non-human inputs (e.g., from sensors on or off the aircraft, based on planned flight plans, etc.) The controller 205 may be powered by a power source on the aircraft or aerospace vehicle, such as the accessory pad 131, one or more batteries, an output of the electrical power I/O 125, a power bus of the aircraft powered by any power source, and/or any other power source available.

The controller 205 may also be in communication with each of the engine 230, the generator/motor 235, the clutch 240, the electrical power I/O 245, the accessory pad 250, and/or the sensor(s) 260. In this way, the components of flexible architectures may be controlled to implement various modes as described herein. In various embodiments, engine 230, the generator/motor 235, the clutch 240, the electrical power I/O 245, and the accessory pad 250 may be similar to or may be the similarly named components shown in and described above with respect to FIG. 9A. The electrical power I/O 245 may also include pre-charge electronic components, for example, for protecting the electrical components of the flexible architectures, including a direct current (DC) bus, as described herein from excessive in rush current on startup. For example, if a high-voltage (HV) bus is at 400V and a new component is connected to the HV bus at 0v, the instantaneous current rush may be extremely high and may be damaging to the HV bus and/or the component. As a result, the pre-charge electronic components may provide for slowly bringing up a component voltage before making a full connection to the HV bus or other power supply.

The sensor(s) 260 may include various sensors for monitoring the different components of the flexible architecture 201. Such sensors may include temperature sensors, tachometers, fluid pressure sensors, voltage sensors, current sensors, state sensors to determine, for example, a current state of the clutch 240, or any other type of sensor. For example, voltage and/or current sensors may be used to inform function and settings of a motor/generator, a state chosen for the clutch, or for adjusting any other component of a system. A state sensor could also indicate a specific mode the flexible architecture is being used in, and the system may receive inputs (e.g., from a pilot, from an automated flight controller), to change the system to a different state or mode for a certain phase of flight that may be upcoming. Other sensors may include a pitot tube for measuring aircraft airspeed, an altimeter for measuring aircraft altitude, and/or a global positioning system (GPS) or similar geographic location sensor for determining a location relative to the ground and/or known/mapped structures.

The components of FIG. 10A inside the flexible architecture 201 dashed line may be associated with the flexible architecture as described herein, while the main aircraft controller 220 may be associated with the broader aircraft systems. In other words, the main aircraft controller 220 may control aspects of the aircraft other than the flexible architecture 201, while the controller 205 controls aspects of the aircraft related to the flexible architecture 201. The main aircraft controller 220 and the controller 205 may communicate with one another to coordinate providing power to the various propulsion mechanisms of the aircraft. For example, the main aircraft controller 220 may transmit signals to the controller 205 requesting particular power output levels for one or more particular propulsion mechanisms. The controller 205 may receive such control signals and determine how to adjust the flexible architecture 201 (e.g., what modes to enter and how to control the elements of the flexible architecture 201) to output the desired power levels based on the control signals from the main aircraft controller 220. In various embodiments, the main aircraft controller 220 may transmit signals that are related to controlling specific aspects of the flexible architecture 201. In other words, the controller 205 may act as a relay to retransmit control signals from the main aircraft controller 220 to the components of the flexible architecture 201, in addition to or instead of transmitting desired power output signals to the controller 205 from which the controller 205 determines how to control the individual components of the flexible architecture 201.

In various embodiments, the main aircraft controller 220 may also transmit control signals related to future desired power outputs, future flight phase or flight plan information, etc. In this way, the controller 205 may receive and use information about the expected power demands of the aircraft to determine how to control the aspects of the flexible architecture 201 at both a present moment and in the future. For example, flight plan information may be used to determine when battery power should be used, when batteries should be charged, etc. In another example, if a big demand for power is expected, the controller 205 may ensure that the engine 230 is running at a desired RPM to begin delivering a desired level of power.

In various embodiments, the controller 205 may also be in communication with one or more batteries to monitor their charge levels, control when the batteries are charged or discharged, control when the batteries are used to power the generator/motor 235, control when the batteries are used to directly power another aspect of the aircraft. However, in other embodiments, the main aircraft controller 220 may be in communication with batteries of the aircraft, and/or may relay information related to the batteries and control thereof to the controller 205. Similarly, if the batteries of the aircraft are controlled with the main aircraft controller 220 rather than the controller 205, the controller 205 may transmit control signals related to the batteries to the main aircraft controller so that the batteries may be controlled as needed or desired with respect to the functioning of the flexible architecture 201.

In various embodiments, the electrical power I/O 245 may include two different outputs (e.g., a high voltage (HV) output and low voltage (LV) output) that are associated with two different windings of the generator/motor 235. As such, two different voltages (e.g., HV and LV) may be output and controlled by the controller 205 and/or the main aircraft controller 220. The electrical power I/O 245 may additionally or alternatively have voltage conversion components (e.g., a DC to DC converter) such that two or more different voltages may be output. In such an embodiment, two different outputs may be achieved without the use of two separate windings. The two different outputs may, for example, be output to different power busses on the aircraft, such as a HV bus and a LV bus. The two outputs of the electrical power I/O 245 may also be separately controlled by the controller 205. As such, the outputs may be turned off (e.g., by letting the power shaft and rotor of the generator spin or freewheel with respect to the rest of the motor/generator by turning off field current of the motor/generator).

In some embodiments, the accessory pad may not be controlled by the controller 205 and/or the main aircraft controller 220. The accessory pad may simply always be on when the engine 230 is operating, or may be controlled separately (e.g., by a manual switch flipped by a user) to control when and how power is supplied to accessories on the aircraft.

In some embodiments, the controller 205 may be in communication with a wireless transceiver that may be on-board an aircraft or aerospace vehicle, so that the controller 205 may communicate with other computing devices not hard-wire connected to the system 200. In this way, instructions or inputs for implementing the various modes for the flexible architectures described herein may also be received from a remote device computing device wirelessly. In other embodiments, the system 200 may only communicate with components on-board the aircraft.

FIG. 10B illustrates a block diagram representative of a second aircraft control system 275 for use with a flexible architecture for an aerospace hybrid system in accordance with an illustrative embodiment. In the example of FIG. 10B, the system 275 does not have a separate main aircraft controller as in FIG. 10A. Instead, the entire aircraft has a single main controller 280 that controls all aspects of the flexible architecture and the aircraft (including, e.g., propulsion mechanisms 255 of the aircraft).

The controller 285 may be in communication with one or more of the propulsion mechanism(s) 255 on the aircraft to control them. The controller 285 may also be in communication with one or more sensor(s) 270 on an aircraft or aerospace vehicle, which may be sensors of the aircraft and sensors of the flexible architecture. In particular, the sensor(s) 260 may also be embedded in any of the components of FIGS. 9A and/or 9B described above, and therefore may be used to inform how the devices of FIGS. 9A and/or 9B are controlled and/or how the modes described herein are implemented as described herein.

In either of FIG. 10A or 10B, the controller 205, the controller 285, and/or the main aircraft controller 220 may also be in communication with a cooling system configured to cool and/or heat any components of the flexible architecture, one or more batteries, or any other aspect of an aircraft. As such, a cooling system may also be controlled in concert with the other systems and methods described herein.

Described below are five specific modes that may be implemented using various embodiments of the flexible architecture described herein (including, e.g., the flexible architectures shown in and described with respect to FIGS. 9A, 9B, 10A, and 10B).

In a first mode, which may be referred to herein as a hybrid generator mode, a clutch (e.g., the clutch 115 of FIG. 9A and/or the clutch 175 of FIG. 9B) may be controlled to engage an engine (e.g., the engine 105 of FIG. 9A and/or the engine 155 of FIG. 9B) to a power shaft (e.g., the power shaft 111 of FIG. 9A and/or the clutch output/power shaft 180) that runs between the clutch to a generator/motor (e.g., the generator/motor 121 of FIG. 9A and/or the generator motor 185 of FIG. 9B) such that the engine spins the power shaft within the generator/motor to generate electrical power to be supplied via an electrical power I/O (e.g., the electrical power I/O 125 of FIG. 9A) to other systems on an aircraft such as propulsion mechanisms/systems. For example, such propulsion mechanisms/systems may be powered using electric motors, and the electrical power output by the generator/motor in the first mode may be used to drive such propulsion mechanisms/systems. In short, in the first mode, the engine may be engaged with the power shaft using the clutch to drive the generator/motor and output electrical power from the generator/motor.

In a second mode, which may be referred to herein as a direct drive engine mode, a clutch (e.g., the clutch 115 of FIG. 9A and/or the clutch 175 of FIG. 9B) may engage an engine (e.g., the engine 105 of FIG. 9A and/or the engine 155 of FIG. 9B) output to a power shaft (e.g., the power shaft 111 of FIG. 9A and/or the clutch output/power shaft 180) that runs through a generator/motor (e.g., the generator/motor 121 of FIG. 9A and/or the generator motor 185 of FIG. 9B) to provide mechanical power to a propulsion mechanism like a propeller on an aircraft. In such a mode, the field may be removed from the generator/motor (e.g., the generator/motor may be controlled to be off or disengaged) such that a power shaft and rotor of the generator/motor is spinning or freewheeling and an electrical power I/O (e.g., the electrical power I/O 125 of FIG. 9A) of the generator/motor is therefore disengaged and not outputting electrical power. In short, in the second mode, the engine may drive a power shaft to mechanically or otherwise power a propulsion mechanism, while the power shaft spins within the generator/motor without receiving or outputting electrical power at the electrical power I/O.

In a third mode, which may be referred to herein as an augmented thrust mode, a clutch (e.g., the clutch 115 of FIG. 9A and/or the clutch 175 of FIG. 9B) may engage an engine (e.g., the engine 105 of FIG. 9A and/or the engine 155 of FIG. 9B) to a power shaft (e.g., the power shaft 111 of FIG. 9A and/or the clutch output/power shaft 180) that runs through a generator/motor (e.g., the generator/motor 121 of FIG. 9A and/or the generator motor 185 of FIG. 9B) and the generator/motor is used as a motor to pull power in through an electrical power I/O (e.g., the electrical power I/O 125 of FIG. 9A) from an external source such as a battery pack. This provides a higher mechanical power output on the power shaft than either the engine or the generator/motor may be capable of delivering. In short, in the third mode, both the engine and the generator/motor are used to drive the power shaft simultaneously to send power to a propulsion mechanism.

In a fourth mode, which may be referred to herein as a direct drive generator/motor mode, a clutch (e.g., the clutch 115 of FIG. 9A and/or the clutch 175 of FIG. 9B) may disengage an engine (e.g., the engine 105 of FIG. 9A and/or the engine 155 of FIG. 9B) from a generator/motor (e.g., the generator/motor 121 of FIG. 9A and/or the generator motor 185 of FIG. 9B) such that power can be fed to the generator/motor via an electrical power I/O (e.g., the electrical power I/O 125 of FIG. 9A) to drive the generator/motor as a motor and provide mechanical power to a power shaft (e.g., the power shaft 111 of FIG. 9A and/or the clutch output/power shaft 180). In short, in the fourth mode, the generator/motor alone may provide power to a propulsion mechanism based electrical power received at the electrical power M.

In a fifth mode, which may be referred to herein as a split engine power mode, a clutch (e.g., the clutch 115 of FIG. 9A and/or the clutch 175 of FIG. 9B) may engage an engine (e.g., the engine 105 of FIG. 9A and/or the engine 155 of FIG. 9B) to a generator/motor (e.g., the generator/motor 121 of FIG. 9A and/or the generator motor 185 of FIG. 9B) such that the engine may cause the generator/motor to spin as a generator and provide both electrical power to other systems on the aircraft via an electrical power I/O (e.g., the electrical power I/O 125 of FIG. 9A) as well as providing mechanical power to a power shaft (e.g., the power shaft 111 of FIG. 9A and/or the clutch output/power shaft 180) to drive systems like a propeller. In short, in the fifth mode, the engine may be used to drive the power shaft and the generator/motor to output power via the electrical power I/O and the power shaft.

As described herein, any of these five modes (or variations thereof) may be used with the single flexible architecture described herein. In addition, certain modes and or combinations of modes may be beneficial for certain aircraft or aerospace vehicle types, certain propulsion mechanism types, certain flight phases of an aircraft or aerospace vehicle, etc.

For example, in a hybrid electric vertical takeoff and landing (VTOL) aircraft with electric motor driven propellers, the flexible architecture herein may be used solely as a source of electrical power. As such, the flexible architecture may drive the aircraft in the first mode (e.g., the hybrid generator mode) during any portion of a phase of flight in which power must be provided to a power bus of the aircraft or one or more motors of the aircraft.

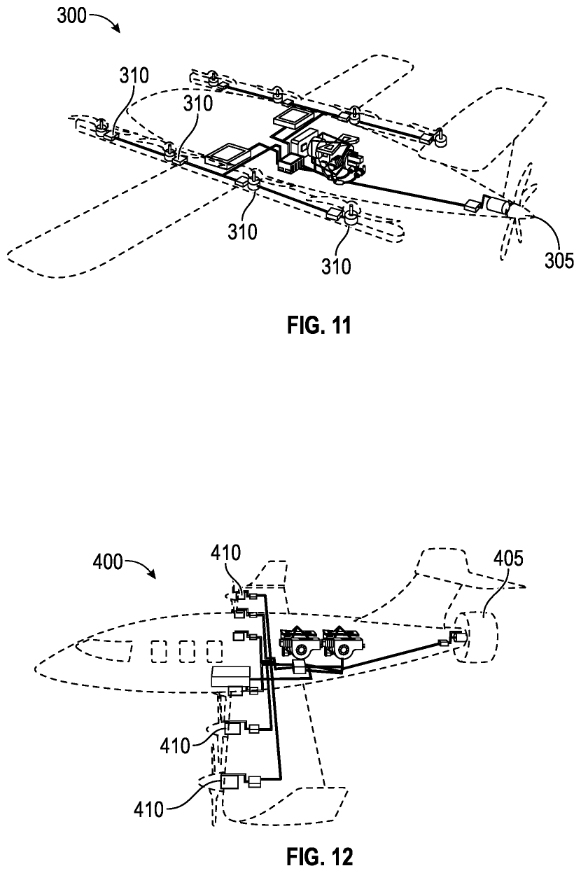

In another example, in an aircraft with a single, large main pusher propeller (e.g., at the rear of a fuselage of an aircraft) and array of electric motors/propellers (e.g., on a wing of an aircraft) the flexible architecture may be used in the fifth mode (e.g., split engine power mode) during takeoff to supply power mechanically to the main pusher propeller and electrically to the wing-mounted motors. FIGS. 11 and 12 illustrate two examples of such an aircraft 300 and 400 with which a flexible architecture for an aerospace hybrid system may be used in accordance with an illustrative embodiment. For example, the aircraft 300 has a main pusher propeller 305, and the aircraft 400 has a main pusher propeller 405 in the form of a ducted pusher fan. In both examples the fifth mode described herein may be used to supply power mechanically to the main pusher propellers 305 and 405 from a power shaft. Additionally, wing mounted electric motors/propellers 310 and 410 may be driven with electrical power from a motor/generator as described herein.

Alternatively, the flexible architecture described herein may be used to power configurations like those shown in FIGS. 11 and 12 in the third mode (e.g., augmented thrust mode) on takeoff by having a battery pack supply power to both the wing-mounted motors and to augment the engine power on the power shaft driving the main pusher propeller. In cruising flight, the aircraft may use the second mode (e.g., the direct drive engine mode) to just drive the main pusher propeller. In another example, during cruising flight, the aircraft may be equipped with a clutch between the power shaft and the pusher propeller, and the controller may cause the aircraft to operate in the first mode (e.g., hybrid generator mode) driving the wing mounted motors by disengaging the power shaft from the pusher propeller and outputting power from the generator/motor to the wing mounted motors. In another example (e.g., an emergency situation such where the engine failure), the pusher prop may be driven in the fourth mode (e.g., the direct drive generator/motor mode) using power input to the electrical power I/O such as from one or more batteries.

In another example, an aircraft may be a VTOL aircraft with a gyrocopter style main rotor that may be operated powered or unpowered, and may have forward propulsion motors and propellers mounted on wings. In an embodiment, the flexible architecture may be used entirely in the first mode (e.g., the hybrid generator mode) with electrical power supplied from the electrical power input/output (and the generator/motor) driving a motor coupled to the gyrocopter style main rotor and driving the wing-mounted motors using electrical power. In an embodiment, the aircraft may also be configured with a clutch between the power shaft and the gyrocopter style main rotor such that the flexible architecture may use the second mode (e.g., the direct drive engine mode) or the third mode (e.g., augmented thrust mode) to spin the gyrocopter style main rotor (e.g., to get the gyrocopter style rotor up to speed for takeoff). In such an example, the controller may then cause the flexible architecture to switch to the first mode (e.g., the hybrid generator mode) after the gyrocopter style rotor is up to speed (e.g., switch to the first mode for cruising flight). The fourth mode (e.g., the direct drive generator/motor mode) may again be used in the event of an engine failure to use electrical power to drive the power shaft (and therefore the gyrocopter style rotor) from a power source such as one or more batteries.

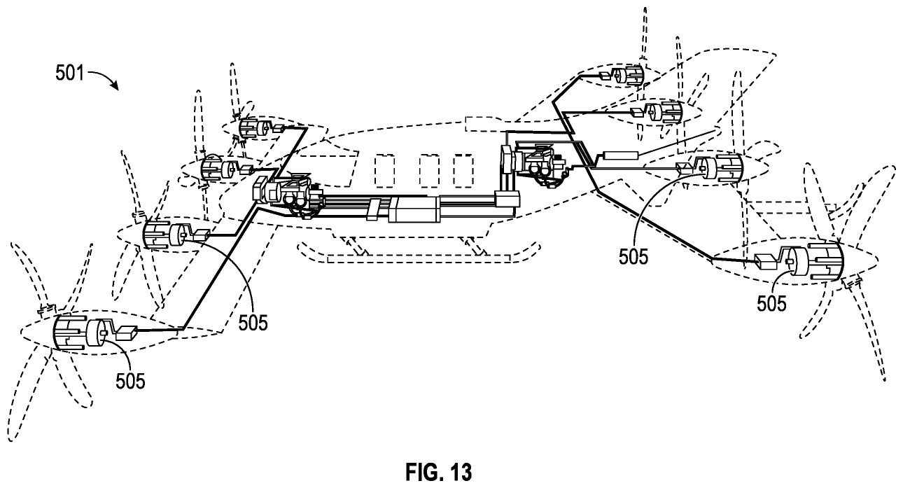

FIG. 13 illustrates another example aircraft 501 with which a flexible architecture for an aerospace hybrid system may be used in accordance with an illustrative embodiment. For example, the aircraft 501 may include multiple (e.g., 8) electric motors/propellers 505 on tilt wings, which may be powered using the first mode described herein (e.g., the hybrid generator mode), where an engine may be engaged with a power shaft using a clutch to drive a generator/motor and output electrical power from the generator/motor to the various electric motors/propellers 505 on the tilt wings.

Accordingly, described herein are advantageous flexible architectures for aircraft through which a variety of modes for supplying power to propulsion mechanisms may be achieved. While particular aircraft and propulsion mechanism configurations may not utilize each mode described herein that a flexible architecture is capable of, the flexible architectures may still be implemented in different aircraft to achieve different modes. Similarly, while an example of a flexible architecture with five different modes for powering propulsion mechanisms is described in detail herein, other flexible architectures with fewer, more, or different modes for powering propulsion mechanisms are also contemplated herein.

For example, a flexible architecture may not have a clutch as described herein and may still be able to implement various modes described herein where it is desirably to have the engine output coupled to the motor/generator and/or an output power shaft of the system. For example, in the first mode, the engine may rotate a power shaft to cause the generator to generate electricity. In the second mode, the engine may direct drive a mechanical propulsion component, for example, but the engine need not be disengaged from the motor/generator or power shaft because the motor/generator can be turned off or allow the power shaft and rotor of the motor/generator to freewheel within the motor/generator. In the third mode, the engine and motor/generator are used to drive the power shaft, so it would not be desirable to disengage the engine and the motor/generator using a clutch. In the fifth mode, the engine may rotate a power shaft to cause the generator to generate electricity and to cause the power shaft to mechanically power a propulsion mechanism. As such, the power shaft need not be disengaged from the engine output in an aircraft that utilizes any of the first, second, third and/or fifth modes as described above. As such, for an implementation that uses any combination of the first, second, third, and/or fifth modes (and not the fourth mode), a clutch may not be used as the system may have the output of the engine constantly connected to the power shaft in the motor/generator. Such an embodiment may be valuable because clutches may be heavy and/or unreliable.

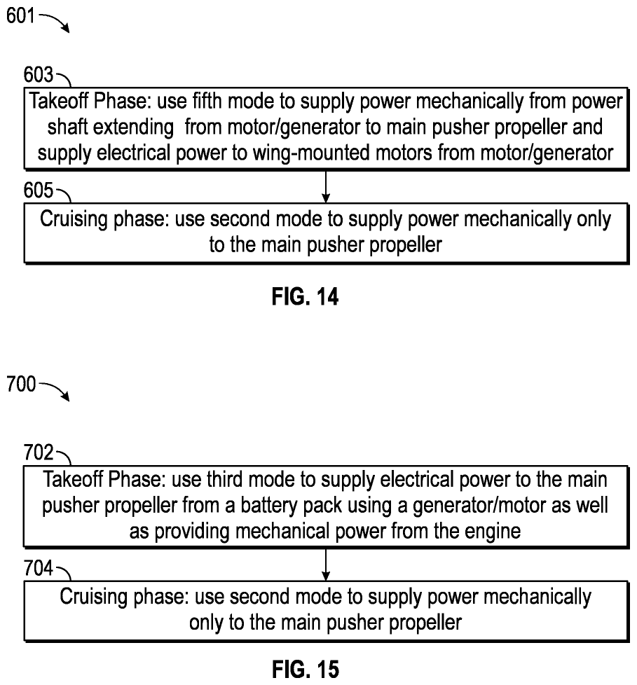

FIG. 14 is a flow chart illustrating a first example method 601 for using a flexible architecture for an aerospace hybrid system in different flight phases of an aircraft with a main pusher propeller in accordance with an illustrative embodiment. In particular, the aircraft may be an aircraft with a single larger pusher propeller and an array of electric motors and corresponding smaller propellers on the wings. During a takeoff flight phase at 603, the fifth mode described herein may be used to supply power mechanically to main pusher propeller and electrical power to wing-mounted motors. During a cruising flight phase at 605, the second mode described herein may be used to supply power mechanically only to the main pusher propeller and not supply power to the smaller electric motors/propellers.

FIG. 15 is a flow chart illustrating a second example method 700 for using a flexible architecture for an aerospace hybrid system in different flight phases of an aircraft with a main pusher propeller in accordance with an illustrative embodiment. In particular, the aircraft may be an aircraft with a single larger pusher propeller and an array of electric motors and corresponding smaller propellers on the wings. During a takeoff flight phase at 702, the third mode described herein called augmented thrust may be used to supply electrical power via a generator/motor to the main pusher propeller (drawing power from batteries) and providing power mechanically directly from the engine to the main pusher propeller. In addition, electrical power (generated by the generator/motor and/or directly from the batteries) may also be provided to the electric motors on the wings during takeoff. During a cruising flight phase at 704, the second mode described herein may be used to supply power mechanically only to the main pusher propeller and not supply power to the smaller electric motors/propellers.

Referring back to FIG. 9A, if the clutch 115 is engaged such that the engine 105 applies power to the power shaft 111 and the generator/motor 121 is not active or on, the power shaft 111 may freewheel within the generator/motor 121 (e.g., the second mode described above). Similarly, the power shaft 180 of FIG. 9B may freewheel within the generator/motor 185 in various embodiments. However, the engine 105 and/or the engine 155 may create torque pulses on the power shaft 111 and/or the power shaft 180 that can be dangerous to a generator, such as the generator/motor 121 and/or the generator/motor 185 when the clutch 115 and/or the clutch 175 is engaged with their respective power shafts 111 and/or 180. In other words, large torque pulses on a shaft similar to those that may occur when certain types of engines fire (e.g., diesel piston combustion engines) may cause high angular accelerations that may cause fatigue or damage to components of the generator/motor 121 and/or the generator/motor 185 that are coupled to the power shafts 111 and/or 180. As such, components to mitigate this torque may be used such as a flywheel or other heavy damping or spring coupling system to smooth out torque on the power shafts 111 and/or 180.

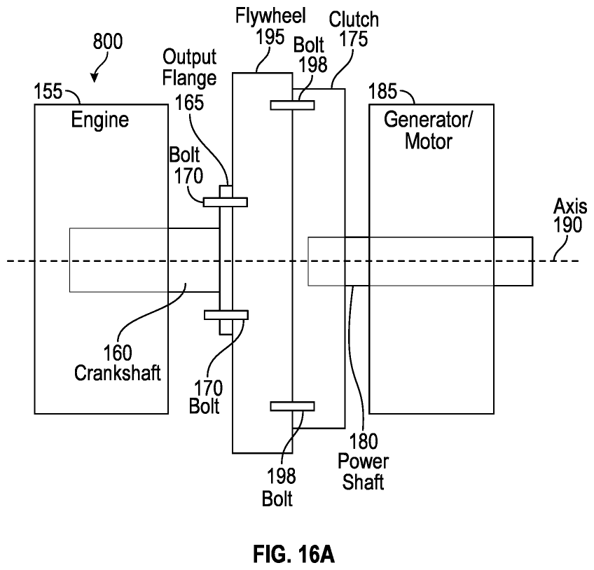

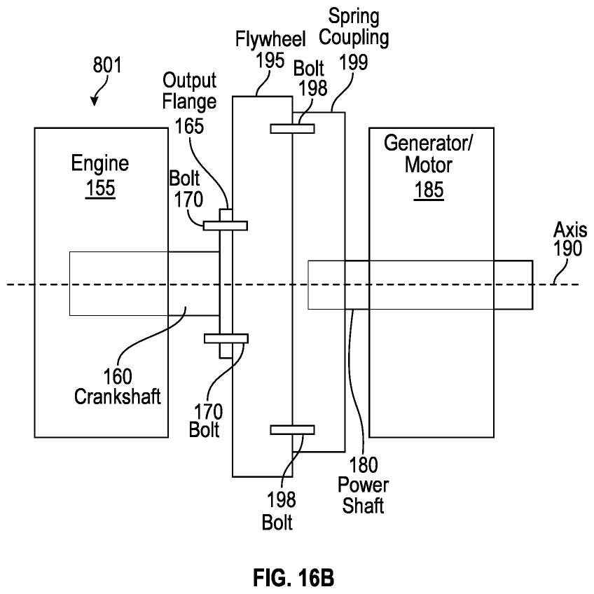

FIG. 16A illustrates an example flexible architecture 800 for an aerospace hybrid system having a flywheel for absorbing oscillatory torque in accordance with an illustrative embodiment. In particular, the flexible architecture 800 includes similar or the same components to that shown in and described with respect to FIG. 9B, but includes a flywheel 195 rigidly connected to the output flange 165 with the bolts 170. The flywheel 195 is further connected rigidly to one side of the clutch 175 by bolts 198. Rotational motion may therefore be translated from the engine 155 through the crankshaft 160, the output flange 165, and the flywheel 195 to the clutch 175. The clutch 175, may in turn engage or disengage with the power shaft 180 to selectively translate the rotational motion received from the flywheel 195 to the power shaft 180. The flywheel 195 may further be, for example, a dual mass flywheel or spring coupling.

In other various embodiments, a flywheel may not be used. For example, further embodiments of damping systems and apparatuses are described herein that can damp torque on a power shaft (e.g., the power shaft 111) but do not include a flywheel. Further, in various embodiments, a flywheel and other damping systems or components may be used in combination to damp or smooth out torque applied to a power shaft.

For example, the power shaft or rotor within the generator/motor itself may be rigidly coupled to a crankshaft of the generator/motor. In this way, the crankshaft and rotor together can damp the torque pulses on the power shaft or rotor, and may reduce tangential acceleration due to the torque pulses from an engine. In such embodiments, a clutch may be omitted. As such, a damping system would be internal to the generator/motor, and the footprint and weight of the damping systems may be less than a flywheel or other damping system that may be external to a generator/motor. In particular, the rigid coupling of the power shaft or rotor with the crankshaft may increase the inertia of the power shaft or rotor, such that the additional inertia helps prevent the power shaft from slowing down or otherwise rotating in a manner that would make it more susceptible to acceleration from torque pulses of an engine. In such embodiments, the power shaft or rotor and the crankshaft may function similarly to a flywheel.

In various embodiments, a generator/motor having a static inner portion and a spinning outer portion may be used. This may increase an inertia of the spinning portion and may allow the magnets in the generator/motor to spin and avoid being dislodged by torque spikes. In other words, the magnets may be already spinning in the outer portion and therefore may have a constant stabilizing radial force applied in addition to any tangential inertial force due to torque spike acceleration.

A torque damping system may also be configured as part of the power shaft or rotor that connects the output of the engine to the generator/motor. For example, a hub between the power shaft or rotor of the generator/motor may include a coupling that has torsional spring and/or damping properties. Torsional damping couplings may include an elastomeric component or spring (e.g., made from steel or another metal) that reduces potentially harmful torque impulses from being passed from an engine output to a power shaft or rotor of a generator. Torsional damping couplings may be similar to or may also be referred to as a resonance damping coupling. For example, such torsional damping couplings may reduce an overall system weight and size as opposed to systems that use a flywheel or other large damping system. One or more torsional damping couplings may be installed at any one or more of, within an engine, between an engine and clutch, in the clutch, between the clutch and the generator, and/or within the generator to achieve damping before the power shaft or rotor damages components of the generator itself.

Other ways of damping torque on a power shaft or rotor of a generator may also be used. For example, a magnetic field on a generator may be controlled to pulse it such that it acts upon the power shaft or rotor of the generator to cancel some or all of the torque pulses imparted on the power shaft or rotor by an engine. Such pulses on the field of the generator may be controlled based on a measurement of the torque pulses applied by the engine, and may result in the generator components not being damaged by the diesel engine. For example, the third mode described above where both an engine and a generator/motor apply power to a power shaft, pulses to the power shaft from the generator may both apply power to the power shaft and protect the components of the generator from being damaged. In the other modes described herein, pulses to the power shaft using the generator may be applied whenever the power shaft is being driven in whole in part by the engine. Thus, in order to properly protect the components of the generator in such a method, the pulses applied by the magnetic field of the generator to the power shaft or rotor may be configured to correlate to the torque pulses of the engine to properly counteract those torque pulses.

FIG. 16B illustrates an example flexible architecture 801 for an aerospace hybrid system having a flywheel and a spring coupling for absorbing oscillatory torque in accordance with an illustrative embodiment. In particular, the flexible architecture 801 includes similar or the same components to that shown in and described with respect to FIG. 16A, but includes a spring coupling 199 rigidly connected to the flywheel 195 and the power shaft 180. The size, weight, etc. of the flywheel 195, as well as characteristics of the spring coupling 199, may be tuned according to the output of the engine 155 and the characteristics of one another, so that oscillatory torque may be reduces as much as desired and/or possible. For example, different engines may produce different amounts of oscillatory torque, so the various embodiments herein include flywheels and/or spring couplings having different characteristics to reduce vibration that is passed from the crankshaft 160 to the power shaft 180. In various embodiments, the flexible architecture 801 may not have a clutch, such that the crankshaft 160 and the power shaft 180 are always coupled to one another. In various embodiments, a flexible architecture similar to that of FIG. 16B may also include a clutch so that the output of the engine 155 can ultimately be releasably decoupled from the power shaft 180. In various embodiments, such a clutch may be connected between the spring coupling 199 and the power shaft 180, or the power shaft may be split into multiple shafts with a clutch connecting the multiple shafts, or the clutch may be located anywhere else between the engine 155 and the generator/motor 185 so that the output of the engine 155 can be selectively decoupled from a portion of the power shaft 180 that passes through the generator/motor 185. In various embodiments, a clutch may additionally or alternatively be positioned after the generator/motor 185 so that the power shaft 180 may be decoupled from a load (e.g., a propulsion mechanism of an aircraft).

Further described below are examples of how the flexible architectures described herein may be packaged and/or used in an actual aircraft. For example, certain aircraft may use electric motors to drive propulsion systems, and therefore must have sufficient on-board electrical energy or ways to generate such on-board electrical energy to drive those propulsion systems. In addition, regulations in a given jurisdiction may also require sufficient reserve energy to comply with operational regulations of an aircraft. The flexible architectures described herein may provide such electrical energy for propulsion systems and/or reserve energy such that they systems described herein may work with a variety of electric aircraft. For example, the embodiments herein provide for efficient conversion of jet fuel (or other liquid or gas fuel) to electricity, such that electric aircraft may be powered using widely available fuel sources.

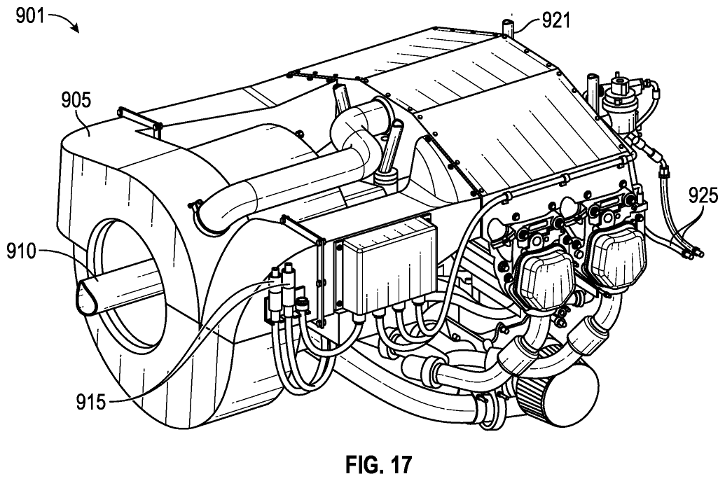

FIG. 17 illustrates a perspective view 901 of an example flexible architecture for an aerospace hybrid system in accordance with an illustrative embodiment. This hybrid unit may be used as the core powerplant of a variety of aircraft types and implementations. The hybrid unit of FIG. 17 is a tightly integrated powerplant that may include some, all, and/or additional elements shown in and described with respect to FIGS. 9A, 9B, 10A, 10B, and/or FIGS. 16A/16B.

In addition, the hybrid unit may include an integrated cooling system 905 that cools various aspects of the hybrid unit, heat exchangers related to the hybrid unit, or heat sinks such as finned attachments for any aspects of the hybrid unit. A power output 910 may be a power shaft (e.g., the power shaft 111 of FIG. 9A, the power shaft 180 of FIG. 9B or FIGS. 16A/16B) or connected to a power shaft, so that rotational power may be output from the hybrid unit to propulsion systems or other aspects of an aircraft. Electrical connectors 915 may also be used to output electrical power (or input electrical power) as described herein. The electrical connectors 915 may be, for example, an Amphenol Surlok Plus™ connector or equivalent, or may be any other type of suitable connector. In this way, a main bus, such as a direct current (DC) bus, of the hybrid unit may be connected to through the electrical connectors 915 (e.g., the electrical power input/output 125 of FIG. 9A, the electrical I/O power 245 of FIG. 10A or 10B). These or other connectors may also facilitate connection to and control of the components of the hybrid unit, such as using a controller area network (CAN) bus, a CAN 2.0 bus, and/or an SAE J1939 bus. Such communications busses may operate at different speeds, such as 250 kilobytes per second (kbps), 500 kbps, 1000 kbps, etc. In various embodiments, the electrical connectors 915 and/or other connectors may be customized for a given application, such as different types of aircraft and the communications and power systems that those aircraft use.

By virtue of the power output 910 and the electrical connectors 915, the hybrid unit of FIG. 17 may output either mechanical power via the power output 910 and/or electric power via the electrical connectors 915 and the DC bus in the hybrid unit (e.g., the electrical power input/output 125 of FIG. 9A, the electrical I/O power 245 of FIG. 10A or 10B). Similarly, electrical power may be received via the electrical connectors 915 to drive the power output 910, just as mechanical power may be received via the power output 910 to generate electricity for output via the electrical connectors 915. For example, if an aircraft includes one or more batteries, extra power from a battery may be received via the electrical connectors 915 to boost power applied to the power output 910, such that the power output 910 is driven by both an engine and power from the batteries of an aircraft as described herein.

The hybrid unit of FIG. 17 may further include connectors 925 for connecting the engine to a fuel source. The connectors 925 may be quick fuel connects, such as AN6 quick fuel connects. In this way, the engine may be supplied with fuel to power the power output 910 and/or to generate electricity to be output via the electrical connectors 915. The hybrid unit of FIG. 17 may additionally include mounting hardware 921 for mounting the hybrid unit to an aircraft. While the mounting hardware 921 is shown on the top of the hybrid unit in FIG. 17, mounting hardware in other embodiments may additionally or alternatively be located on any of the top, bottom, sides, etc. of the hybrid unit, so that the hybrid unit may be mounted as desired to an aircraft.

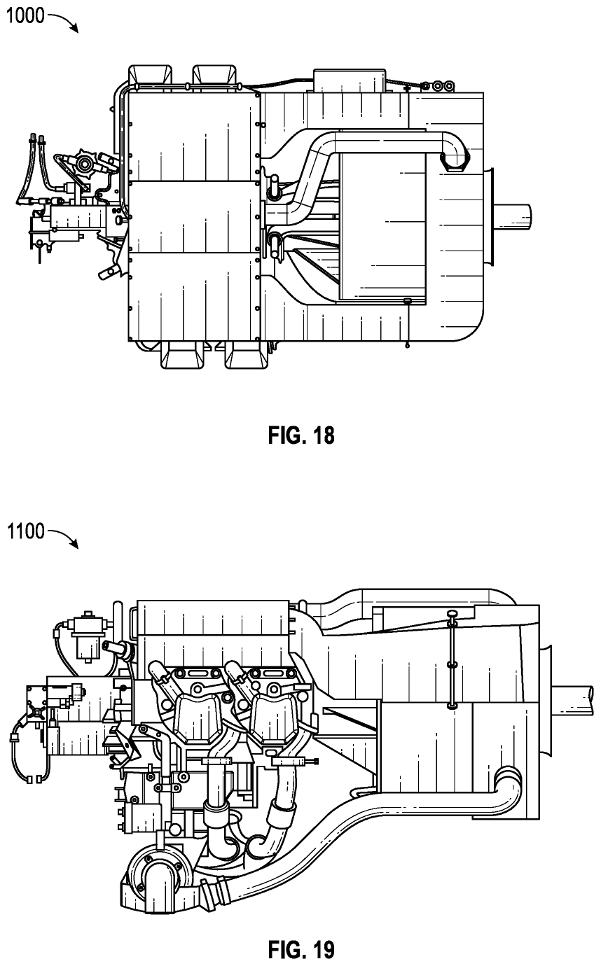

FIG. 18 illustrates a top view 1000 of the example flexible architecture of FIG. 9 in accordance with an illustrative embodiment. FIG. 19 illustrates a side view 1100 of the example flexible architecture of FIG. 17 in accordance with an illustrative embodiment.

Accordingly, the hybrid units described herein may be used to power an electric or hybrid electric aircraft, and may offer better power than a battery pack alone would. For example, a hybrid unit as shown in FIGS. 17-19 may offer better energy density than batteries (e.g., 5 to 7 times better energy density). For example, the hybrid units described herein may have anywhere from 600-1200 or more Watt-hours per kilogram (Wh/kg) equivalent energy density. The hybrid units described herein may also advantageously have better fuel economy than other systems (e.g., 40% better fuel economy than a turbine engine), and may use readily available fuel such as Jet-A, diesel, kerosene, biofuel substitutes, or any other suitable or desired fuel. In other words, the hybrid units herein may include, in a compact package, an engine, a generator, an inverter, and thermal management using air cooling, such that aircraft in which the flexible architecture is installed may advantageously utilize these components as a powerplant. Outputs at various voltages, (e.g., 400 Volts (V), 800V, 1000V, 1200V, etc.) may be supplied from the hybrid architecture, as well as having connections for other accessory or system power (e.g., 28V). The flexible architectures described herein may also be quieter than other systems (e.g., quieter than turbine engine systems). For example, noise may be below 70 decibels (dB) at one hundred feet or less from the current systems.

The flexible architectures described herein may also be scalable. For example, in a larger aircraft, two or more of the flexible architectures described herein may be used. The flexible architectures may also be used in different aircrafts designed for different functions and purposes. For example, the flexible architectures described herein may be useful in urban air mobility (UAM) systems, such as electric vertical takeoff and landing (eVTOL) aircraft, electric short takeoff and landing (eSTOL) aircraft, electric conventional takeoff and landing (eCTOL) aircraft, etc. One example flexible architecture, such as the one shown in FIGS. 17-19, may have the specifications shown in Table 1 below.

TABLE 1
SPECIFICATIONS

| | SI Units | | SAE Units | |
|---|---|---|---|---|
| Max Continuous E-Power | 185 | kW | 248 | hp |
| Max Continuous Shaft Power | 185 | kW | 248 | hp |
| Max Burst Shaft Power* | 370 | kW | 496 | hp |
| Nominal system bus voltage | 400 or 800 V | | 400 or 800 V | |
| Specific Fuel Consumption | 250 | g/kWh | 0.41 | lb/hp-h |
| Ambient temperature range | −40 to 50 C. | | −40 to 122 F. | |
| Ceiling for full takeoff power | 3050 | m | 10,000 | ft |
| Certified ceiling | 6100 | m | 20,000 | ft |
| Dimensions (L × W × H) | 140 × 93 × 84 cm | | 55 × 37 × 33 in | |
| Mass, dry** | 295 | kg | 650 | lb |

*Max burst shaft power depends upon battery configuration
**Dry mass includes engine, generator, inverter, and thermal systems

As shown above, a 185 kW hybrid unit may be provided. Accordingly, two hybrid units may be provided in a given aircraft to provide 370 kW of power.

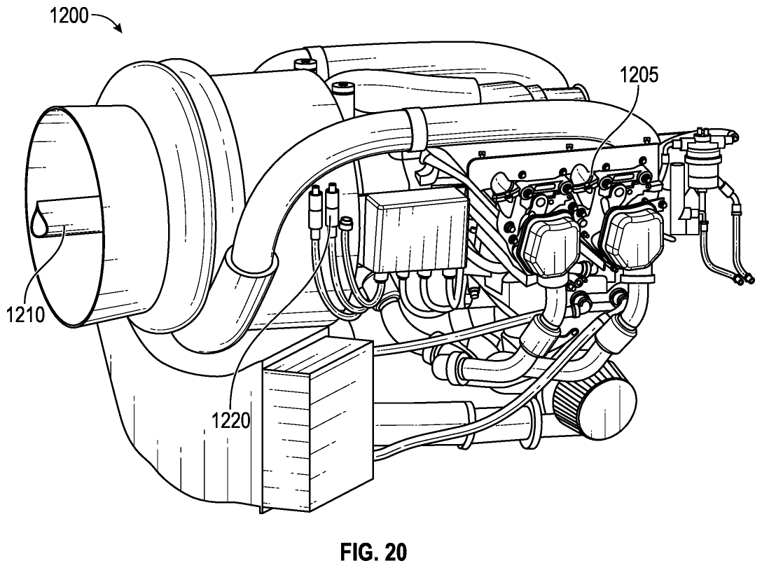

FIG. 20 illustrates a perspective view 1200 of another example flexible architecture for an aerospace hybrid system in accordance with an illustrative embodiment. The flexible architecture of FIG. 20 includes an engine 1205 and a generator, which is hidden or not visible because of other components such as the cooling ducts of the system. However, like the hybrid unit of FIGS. 17-19, a mechanical output power 1210 and electrical output power 1220 (which are also both optionally capable of receiving power as well) are provided.

As such, the various embodiments herein provide for a hybrid electric powerplants that may be incorporated into various different types of aircraft in the aerospace market. In doing so, aircraft manufacturers may not have to build their own systems that are made up of an engine, a generator, power electronics, cooling systems, and/or control systems to provide power to those aircraft. This may be advantageous, as a development process to create a powerplant system and certify it to aerospace standards may last 4+ years and may cost more than $10M.

As such, the hybrid powerplants or flexible architectures described herein may be design, manufactured, etc. separably from the design of the aircraft. A few aspects of the flexible architectures may be customized as desired by an aircraft manufacturer, but in a way that does not cause the total system to be redesigned or reconfigured. The embodiments herein therefore provide for an integrated unit that includes the engine, generator, power electronics, cooling systems, and/or control systems in one package to be installed on an aircraft. Combining these elements into a single standalone unit further advantageously allows for that unit to go through the Federal Aviation Administration (FAA) certification process as a system. Then, multiple aircraft manufacturers may use the certified system, removing that certification burden and development burden from the aircraft developer as well as adding efficiencies where multiple aircraft manufacturers will not have to seek certification of many different powerplant systems specifically designed for their aircraft.

By providing a combined unit having an engine, generator, power electronics, cooling systems, and/or control systems, the hybrid flexible architectures described herein may be optimized as a whole system rather than as individual components. entire system rather than optimization of the pieces. Additionally, such a hybrid unit may be used in multiple aircraft designs, whereas systems designed as part of an aircraft design process are configured such that it is difficult to reapply them elsewhere. Having a hybrid unit that may be applied in multiple market segments and aircraft designs with common power requirements leads to faster development of aircraft where a major component (e.g., the hybrid units or flexible architectures) of an aircraft is already certified and in production.

Hybrid electric systems for aviation have historically been designed from scratch for each application/aircraft. Such a process is inefficient and addressed by the embodiments herein. For example, some aircraft have unique powerplants designed specifically for the aircraft. Such a solution may include custom engine, generator, power electronics, control systems, cooling systems, battery pack, propulsion motors, and/or propellers. The embodiment herein provide for a compact hybrid system for an aircraft that may make up one half of two distinct halves within an aircraft power and propulsion system: upstream and downstream ends of a powertrain (such as a hybrid powertrain as described herein).

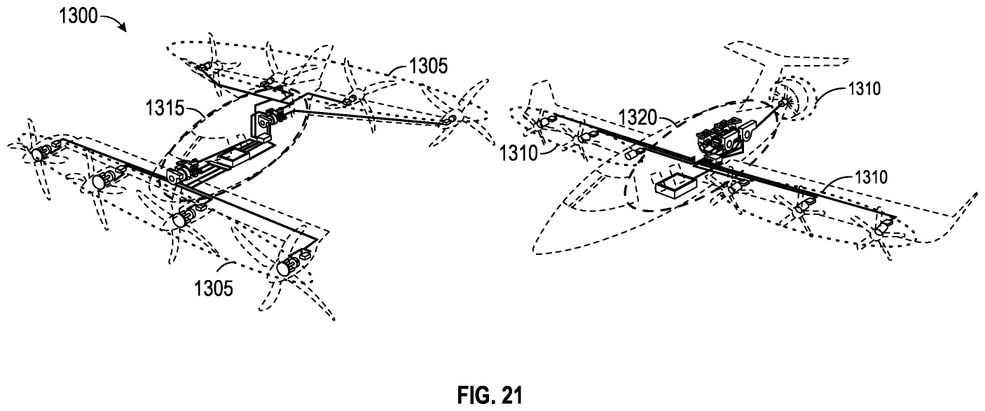

FIG. 21 illustrates example downstream 1305, 1310 and upstream 1315, 1320 components for propelling an aircraft 1300 in accordance with an illustrative embodiment. For example, downstream components 1305, 1310 of an aircraft system may include motors, rotors/propellers, attitude control components, etc., that are more related to the specific design of an aircraft. Upstream components 1315, 1320 of an aircraft that may be repeatable within different aircraft may include any of engines, generators, batteries, power distribution, fuel, generator noise abatement, etc.

Specifically, the upstream end of the powertrain may include hybrid powertrain elements responsible for producing electrical power. Such components may include the engine, generator, power electronics, control systems (for the upstream power generation components), cooling systems (for the upstream components), battery pack, and/or fuel. The downstream end of the powertrain may include hybrid powertrain elements responsible for turning the electrical power into thrust, attitude control, and/or active control of aerodynamics. These downstream components may further include electric motors, propellers, motor controllers, and/or control systems for the propulsion system.

As such, there may be common upstream powertrain needs across very different electric aircraft designs that are of similar sizes and total power requirements. However, the downstream powertrains may have little consistency from one aircraft to the next and therefore these components may not be standardized to work on many aircraft designs the way the upstream components can. Furthermore, the upstream elements that lend themselves to standardization may include the components that are linked to the power requirements but not the total energy requirements. In the case of the engine, generator, power electronics, cooling systems, and/or control systems, these elements of the upstream powertrain may be sized to fit a specific power requirement (kW or hp) of an aircraft. However, the quantity of fuel and the size of the battery pack may be driven by total energy requirements (kWh or hp hr) and these may vary from aircraft to aircraft. In such embodiments, the volume of fuel may be scaled by changing the size of the fuel tank to match the requirements of the aircraft design, and the capacity of the battery pack in kWh may be scaled by adjusting the number of parallel stacks of cells within a battery pack or by adding additional battery packs.

Therefore, provided herein are embodiments for supplying a hybrid powerplant that tightly integrates the engine, generator, power electronics, control systems (for the power generation system), and/or cooling systems in a weight-efficient and space efficient manner that can be certified as a standalone unit designed to provide propulsive power that is separable from the aircraft.

In addition, as described herein, a rotor inside the generator may be optimized to serve multiple purposes in the context of a hybrid powerplant. Conventional combustion engines may have a flywheel mass attached to the rotational shaft to enhance smoothness of operation. However, in the context of an aerospace system it may be unattractive to add extra mass. When an engine is coupled to a generator in a hybrid powerplant as described herein, the rotor in the generator may be designed to withstand any torque impulses from the engine and it may be designed to be the rotating mass that the engine utilizes for smoothness of operation.

Further, while auxiliary power units are known in the prior art, these systems may be designed for different purposes than as a primary source of propulsion power for an aircraft, and therefore may not have control systems capable of being certified to the standards required for use in propulsion. Additionally, such systems may be designed without the cooling systems, leaving that aspect to the airframe designer. As such, these systems are not certified to Part 33 (FAA regulations for aircraft powerplants). Also, these auxiliary power unit systems are designed to be lightweight auxiliary systems that are used intermittently rather than for highly efficient propulsion systems that are used in all phases of flight. Additionally, auxiliary power units may be designed to produce alternating current (AC) power, whereas hybrid electric powerplants as described herein may produce direct current (DC) power so that the hybrid electric powerplants may be coupled to a large propulsive battery pack, as battery packs provide and are charged using DC power.

Turbogenerators are a type of adapted auxiliary power units that have been proposed for hybrid power. Such systems lack cooling system integration that provides an airframe developer with a cooling system that is part of the hybrid powerplant. As such, airframe developers may be left to design their own cooling systems to accompany use of a turbogenerator. Using the embodiments herein, separate cooling systems for cooling the hybrid powerplants described herein may advantageously not need to be designed or developed for particular airframes, as such cooling systems are already included in the flexible architectures described herein.

As such, the flexible architectures and hybrid electric powerplants described herein advantageously provide an engine that converts liquid fuel (or gaseous fuel) into rotational mechanical power, a generator coupled to the engine that is configured to convert the rotational mechanical power to electricity, and/or power electronics coupled to the generator that are configured to convert the direct AC output of the generator to high voltage DC power. The flexible architectures and hybrid electric powerplants described herein further advantageously provide control systems that are configured to vary the power output of the engine to match the power demand on a main propulsive electrical bus of an aircraft to meet the demands of an aircraft for electric power.

Hybrid powerplant control systems, power electronics, generator, and/or engine designs described herein may further comply with regulatory requirements for the reliability of propulsive aerospace systems (e.g., failure should have a probability of less than 10⁻⁶ or ten to the power of negative six). Flexible architectures and hybrid electric powerplants may further include a control interface that enables the flexible architecture or hybrid powerplant to communicate with a vehicle-level flight control systems to enable propulsive power commands to be provided from the vehicle-level flight control systems to the hybrid-powerplant control systems, and also advantageously provide for the hybrid-powerplant control systems to send status messages back to the vehicle-level flight control systems (e.g., feedback for use in controlling the flexible architecture or hybrid powerplant). Flexible architectures and hybrid electric powerplants may further include cooling systems that maintain the temperature range of the generator, power electronics, and/or engine over a full range of operating power output of the flexible architectures and hybrid electric powerplants described herein.

Various embodiments of flexible architectures or hybrid electric powerplants described herein may further include control systems that vary power output by varying engine torque and/or maintain rotations per minute (RPM) substantially constant over a significant range of power output. Such embodiments may provide for faster response of the flexible architectures or hybrid electric powerplants by eliminating throttle lag and a longer response time relating to system rotational inertia.

Various embodiments of flexible architectures or hybrid electric powerplants described herein may further include the option to provide a portion of the engine's power output as mechanical shaft power and a portion provided as DC electrical power. Various embodiments of flexible architectures or hybrid electric powerplants described herein may further include that the engine may be a piston engine, diesel piston engine, turbine engine, rotary engine, or other forms of combustion engine. Various embodiments of flexible architectures or hybrid electric powerplants described herein may further include examples where the rotor of the generator is designed to be a flywheel for the engine. Various embodiments of flexible architectures or hybrid electric powerplants described herein may further include a clutch between the engine and generator to enable operation of the generator as a motor that can be operated while the engine is shut down in some types of parallel hybrid installations as described herein.

### Air Cooling Elements

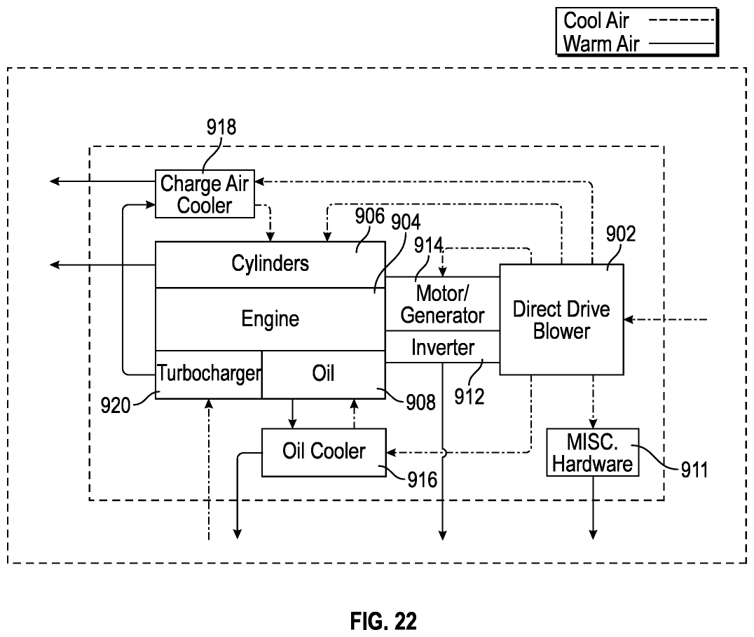

As described further below with respect to FIGS. 22-34, various embodiments described herein also provide for simultaneous air cooling of multiple elements of a hybrid powerplant, such as the hybrid flexible architectures described herein. For example, an engine (e.g., a piston engine, rotary engine, turbine engine, etc.), an electric machine (e.g., generator, motor, or generator/motor as described herein), power electronics, and/or induction air for an engine of a hybrid system may all advantageously be efficiently and simultaneously cooled with the cooling systems described herein. Thus, disparate components of a hybrid powerplant with separate cooling components may be linked together with a combined air cooling system that may reduce weight of the aircraft, increase reliability of the aircraft, etc.

Various embodiments of the cooling systems described herein utilize air cooling, such that air is provided to different aspects or components of a hybrid powerplant. Air is lighter than other mediums that may be used for cooling, such as water. Thus, the embodiments described herein may have a weight advantage over other systems, such as those that use liquids such as water as a primary medium for cooling. Water cooling systems, in addition to their greater weight than air-based systems, may also encounter problems with icing, particularly in aircraft that may be operated at higher altitudes and therefore experience low temperatures.

An example embodiment advantageously connects a fan, impeller, and/or blower to a power shaft or crankshaft of the flexible architectures described herein (e.g., power shaft 111 of FIG. 9A, crankshaft 160 of FIG. 9B, power shaft 180 of FIG. 9B), such that the fan, impeller, and/or blower is mechanically driven based on power imparted on the power shaft or crankshaft by an engine (e.g., engine 105 of FIG. 9A, engine 155 of FIG. 9B) or a generator/motor (e.g., generator/motor 121 of FIG. 9A, generator/motor 185 of FIG. 9B) of the flexible architectures described herein. As such, the fan, impeller, and/or blower is configured to provide air cooling directly off mechanical power received from the spinning power shaft and/or crankshaft and may provide air to multiple system elements for cooling, which may include providing air directly to components for cooling or providing air to one or more heat exchangers or finned heat sinks that are used to cool other components (e.g., components that have their own liquid cooling systems). It should be understood that unless otherwise stated, the terms fan, blower, and/or impeller may be used individually to refer to any of a fan, blower, impeller, or any other similar component, as well as any combination thereof of such elements.

The embodiments described herein provide for lighter weight systems than those that use separate cooling for individual components of a flexible architecture. In addition, since mechanical power from a power shaft or crankshaft may be provided directly to drive a fan, the embodiments herein may reduce conversion losses that may occur in systems where mechanical power is converted to electric power to drive electric fans. As such, mechanical power from the flexible architecture may be converted directly to air cooling flow. The embodiments described herein further provide for lightweight and efficient systems because the cooling fan and associated ductwork may be closely coupled or placed with respect to the rest of the flexible architecture, thereby yielding an efficient, lightweight, and compact system for powering an aircraft. The embodiments also increase efficiency by reducing distance between a cooling inlet for the air cooling system and the devices or components that are being cooled.

FIG. 22 illustrates an example schematic of a cooling system for a hybrid powerplant in accordance with an illustrative embodiment. The hybrid powerplant may be, for example, any of the flexible architectures described and/or shown in this application, such as those discussed with respect to and shown in FIGS. 1-8.

The cooling system of FIG. 22 includes a blower 902 that is powered via direct mechanical energy from a shaft passing through the generator/motor 914. The shaft may also be connected to the engine 904. In this way, the shaft may be driven by either or both of the generator/motor 914 and the engine 904. The engine 904 may be a piston engine, a turbine engine, a rotary engine, or any other type of combustion or other engine. An inverter 912 may further be attached to the generator/motor 914 so that electrical power may be generated from rotation of the shaft or electrical power may be used to input into the generator/motor 914 to rotate the shaft (e.g., from a battery pack or other source of electrical power). The engine 904 may further include cylinders 906, oil for an oil cooling system 908, and a turbocharger 920. A charge air cooler 918 may further be included in the system to work with the turbocharger 920. The system further includes an oil cooler 916 and miscellaneous hardware 911 (e.g., control or other electronics).

The blower 902 is configured to rotate upon the engine 904 and/or the generator/motor 914 turning the shaft to which the blower 902 is connected. The cool air from the blower 902 may be directed through various ductwork to the motor/generator 914, the miscellaneous hardware 911, the cylinders 906 of the engine 904, the oil cooler 916 (e.g., a heat exchanger), the charge air cooler 918 (e.g., a heat exchanger), or any other components that are desired to be cooled. In various embodiments, some of the components to which air are directed may be or may include a heat exchanger (e.g., an air-air heat exchanger, an aid-fluid heat exchanger), such that air from the blower 902 may be used to indirectly cool a component via a heat exchanger. In various embodiments, any of the components of FIG. 22 or otherwise part of a flexible architecture may include heat sink elements, such as a set of fins configured to sink heat from a component into air from the blower 902. As such, components may also be indirectly cooled through a heat sink feature that is in contact with cool air from the blower 902. In various embodiments, a combination of a heat exchanger and a heat sink (e.g., fins) may be used to cool a component. For example, a heat sink element may release heat into air or fluid on a first side of a heat exchanger, and air from the blower 902 may be directed to a second side of the heat exchanger to remove heat from the air or fluid on the first side of the heat exchanger.

Accordingly, the blower 902 may be used to cool various components of a flexible architecture as further described herein. For example, air from the blower 902 may be directed to the oil cooler 916, which is an air-fluid heat exchanger that is configured to exchange heat between air from the blower 902 and oil in the oil cooler 916. Cooled oil from the oil cooler 916 may then be circulated into the oil cooling system 908 of the engine 904 to cool the engine 904 (e.g., remove heat from the engine 904 by transferring it to the oil). Hot oil from the oil cooling system 908 may then be circulated back to the oil cooler 916 to again be cooled via air from the blower 902.

Cool air may also be provided to the charge air cooler 918. Ambient air may enter the turbocharger 920, be compressed, and then output to the charge air cooler 918. The compressed air from the compressor inlet side of the turbocharger 920 may then be cooled at the charge air cooler 918 using air directed to the charge air cooler 918 from the blower 902. In other words, the charge air cooler 918 may act as an air-air heat exchanger. Cool air may then be output from the charge air cooler 918 to an intake of the engine 904 to be used, for example, in a combustion cycle of the engine 904. The exhaust output from the engine 904 may then be directed to a turbine or hot side of the turbocharger 920, which then outputs the air as exhaust into the environment. In this way, air used by a turbocharger and or engine may ultimately be cooled indirectly using an air-air heat exchanger of a charge air cooler as part of a turbocharger cycle.

As such, various components of a flexible architecture as described herein may be cooled. Cylinders (or rotors) of diesel aircraft engines (e.g., a piston combustion engine) may be air cooled or liquid cooled. In the example of FIG. 22, the cylinders 906 are air cooled. However, the cylinders may additionally or alternatively be liquid cooled by adding a heat exchanger between the liquid of the cylinder liquid cooling system and cool air provided by the blower 902. If liquid coolant is used, that liquid may be a water-glycol mix, for example. Similarly, cylinder heads of a diesel aircraft engine (e.g., a piston combustion engine) may be air cooled, oil cooled, or water-glycol cooled. As such, air from blower 902 may be used to directly or indirectly (using a heat exchanger or finned heat sinks), similar to the cylinders described herein. In other engines than a piston engine, such as turbine or rotary engines, components of those engines may include liquid or air cooling systems as well, and therefore benefit from the cooling systems described herein as well (e.g., through direct cooling using air from the blower 902 or via a heat exchanger between air from the blower 902 and liquid coolant of a separate cooling system of or associated with the engine).

Engine oil of an engine may also be cooled in a flexible architecture. In the example of FIG. 22, the oil of the oil cooling system 908 is circulated through the oil cooler 916, which exchanges heat between the oil of the oil cooling system 908 and the cool air provided by the blower 902. Heat absorbed by the oil of the oil cooling system 908 in the engine 904 may come from bearing shear within the engine 904, and oil may also be used for other cooling such as cylinder heads and/or pistons (or rotors).

Charge air (induction air) is typically air cooled and this is required due to turbocharging. Turbocharging is very common on aircraft to expand the usable range of altitude with power to meet the mission, plus turbocharging significantly improves overall thermal efficiency of the engine. Compressing the intake air raises its temperature, and this temp must be reduced before being introduced to the cylinders to avoid problems related to piston cooling, detonation, and others.

An electric motor/generator (also referred to herein as an electric machine), such as the motor/generator 914 of FIG. 22, may also be cooled due to the presence of electrical resistance and current in the electrical and electronic components of the motor/generator 914. This cooling may be accomplished by air cooling, such as from the blower 902, or liquid cooling, such as via a heat exchanger provided with cool air from the blower 902. Liquid cooling may be via water-glycol mix or a dielectric (non-conductive) fluid, for example.

An inverter (with associated power electronics), such as the inverter 912 of FIG. 22, may be cooled, again owing to heat created in electrical circuits such as high-speed switches and other hardware therein. Such cooling may be accomplished via air cooling, such as from the blower 902, or liquid cooling, such as via a heat exchanger provided with cool air from the blower 902. Liquid cooling may be via water-glycol mix or a dielectric (non-conductive) fluid, for example.

Other elements of the hybrid powerplants described herein may achieve passive cooling. In other words, cooling requirements for system elements including but not limited to a clutch (if present), couplers, supervisory or other controller(s), fan bearings/seals, etc. may be satisfied by their normal service environment with no active design feature (fan, pump, radiator) to enhance the cooling provided. In various embodiments, as needed, active cooling via air cooling, such as from the blower 902, or liquid cooling, such as via a heat exchanger provided with cool air from the blower 902 may be provided to any component of an aircraft as described herein.

As discussed above, air or fluid systems may be used to cool various aspects of an aircraft. However, the embodiments herein provide for reducing the number of fluid cooling systems that may be used in an aircraft for cooling various aspects of that aircraft. Fluid cooling systems may use one or more pumps in order to circulate fluid. Such a pump may be mechanical or electrical. If it is a mechanical pump, there is weight and complexity related to the pump. The pump itself must also be located on the aircraft, adding weight and complexity to the aircraft. A pump may also have, bearings, seals, and/or plumbing joints that may leak. If a pump is powered by electricity, such a pump may be rated for heat transfer and therefore require relatively high power (e.g., 5000 Watts (W) or more).

Fluid systems may also be designed to accommodate expansion and contraction of the fluid during service, for bleeding air during system fill, for system draining during service or for other reasons, and/or provision for fluid spills in design and/or operations of the aircraft. All of these factors may represent engineering complexity and certification challenges and there may be advantages in avoiding them and using the air cooling systems as described herein.

Fluid systems may also have issues with ice formation, such as at temperatures below −35F (−35C). Thus, systems can fail or be less efficient when ice forms, or additional components to avoid ice may be added, which further adds weight and complexity to a cooling system.

Fluid systems may also use a heat exchanger of some sort. This may be fluid-fluid to transfer the heat of a hotter fluid into a cooler fluid, or it may be fluid-air to transfer the heat to air which is exiting overboard. In any case, each heat exchanger represents weight and volume (which contributes to weight for the flexible architecture/powerplant system and/or the entire aircraft), several potential failure points where leaks can take place (at least two, plus a bleed and a drain), and often includes welding which has specific metal fatigue risks. While some heat exchangers may still be used in the embodiments described herein (e.g., to cool engine oil), reducing the number of heat exchangers and/or fluid cooling systems may be advantageous as described herein.

In some example aircraft where a fluid cooling system uses a fluid-air cooler, depending on the aircraft and the overall system design, such a system may use a dedicated fan to move air and execute the desired heat transfer. Such fans may be electrically driven, which may therefore require high power motors that are rated for heat transfer (e.g., 5000 W or more). As discussed above, pumps for fluid systems may also be used that are rated for high power given their use in a heat transfer application.

The use of high power rated pumps and fans may be particularly disadvantageous for an aircraft cooling system. Numerous pumps, coolers, and/or fans may be heavy, complex, take up a lot of space, and introduce multiple potential points of failure. To the extent electric pumps and/or fans are used, suitable electricity must also be supplied to keep the cooling systems running. If an aircraft, for example, is on an extended mission (e.g., more than a few minutes), stored energy (e.g., batteries) may not be sufficient to provide power to such pumps and fans, and therefore a generator or other power source would be provided. In some cases, such a generator may be an alternator directly attached to an engine, it may be via a separate generator, or via one or more DC-DC converters. In particular, on an aircraft characterized by distributed electric propulsion with high-voltage electrical power intended for one or more lift or propulsion motors, it may be logical to use DC-DC to convert a portion of this high-voltage power to low-voltage for use by pumps and fans. However, such components again add complexity and weight to a cooling system.

Any additional electrical circuitry may have additional connections for power, ground, and control. These connections may be heavy, and necessarily have size and stiffness (e.g., minimum bend radius), therefore taking up additional volume around a given electronic device for safe connection and provision of power to the device. Each powered device may also have short-circuit protection components such as a fuse or breaker, which protects the device but may also be resettable for safety reasons. Various electronic devices may also include components that provide for safe handling of service crew and/or possibly may include a control element to tailor the function of devices for various parameters of a mission. Any such components again add weight and complexity to a cooling system.

If a DC-DC conversion is used, and the direction of voltage is from higher to lower voltage, then significant heat may be generated resulting in lost efficiency and yet another system element which may require active cooling.

In addition, wherever additional electrically powered devices are added, conductors made of copper may be used. Copper is often preferred for carrying of electrical current in aircraft. The gauge of copper (diameter of the wire) is determined by a combination of the current in service and the local heat transfer available. Everything associated with wiring may be heavy: the conductor, the insulation, connectors at each end, physical support of the wire to prevent chafing, and/or additional armor applied to the wiring to prevent physical damage. Since active heat transfer of conductors and connectors may not be practical, size of conductors may be increased to keep temperatures low resulting in higher weight. As such, it is again desirable to reduce the number of electrically powered devices to reduce weight and complexity of a system. Similarly, it is therefore also desirable to reduce the number of components or systems that utilize fluid cooling in an aircraft.

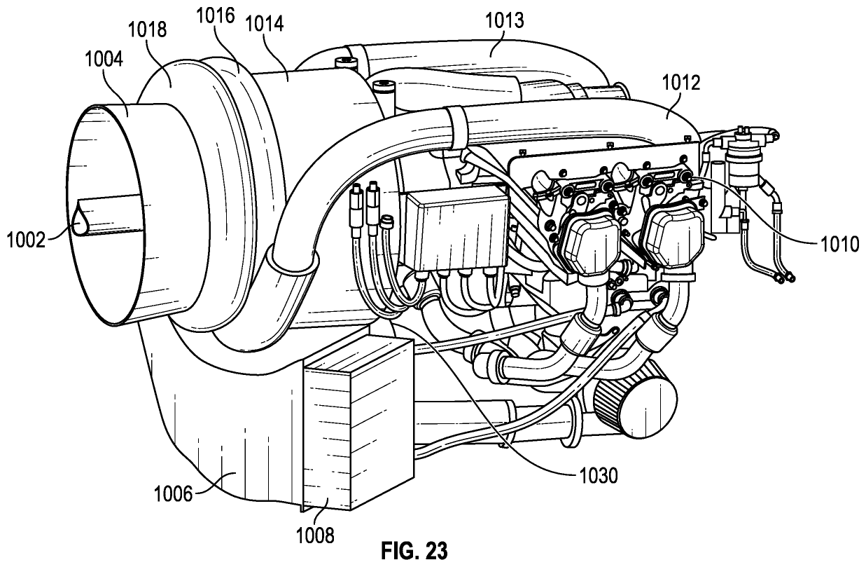

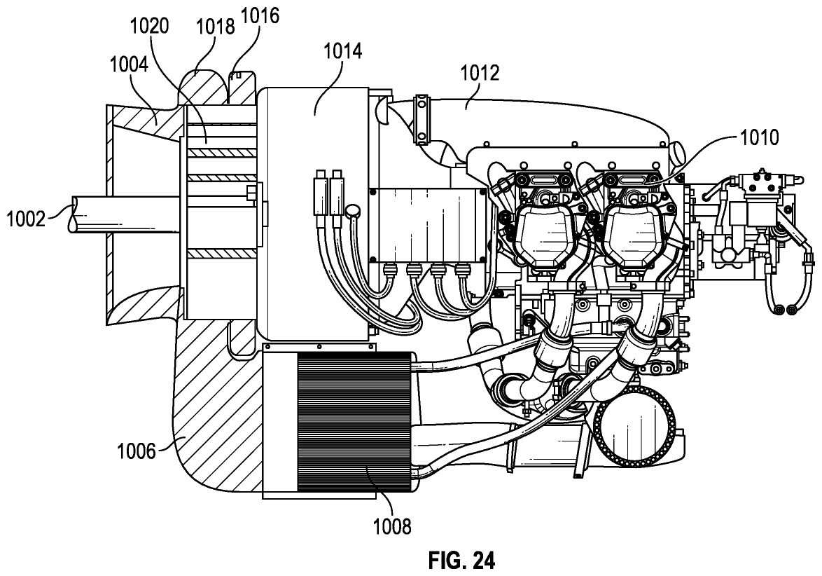

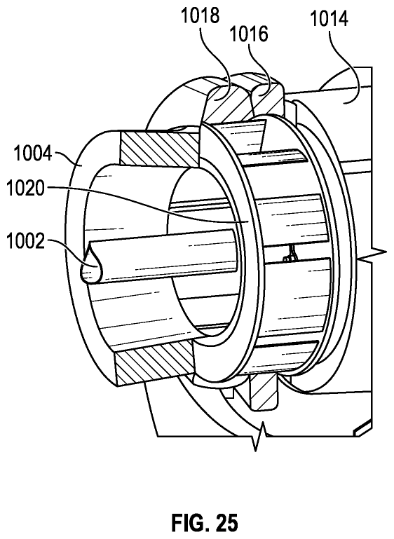

FIG. 23 illustrates an example hybrid powerplant with a cooling system in accordance with an illustrative embodiment. FIG. 24 illustrates a cross-sectional view of the example hybrid powerplant with a cooling system of FIG. 23 in accordance with an illustrative embodiment. FIG. 25 illustrates a partial cross-sectional perspective view of the example hybrid powerplant with a cooling system of FIG. 23 in accordance with an illustrative embodiment.

In particular, FIGS. 23-25 together depict a cooling system that may be used with a hybrid powerplant, where the cooling is powered directly by mechanical power and provides cool air for various systems of the hybrid powerplant simultaneously, thereby achieving the various advantages of reducing fluid cooling and electrically powered systems present in an aircraft. A shaft in the generator/motor may provide power from an engine 1010 and/or a generator/motor (not shown, as it is within housing/shroud 1014) to a fan blade 1020. The shaft 1002 may provide power to a mechanical component, such as a fan or a propulsion mechanism like a propeller. An inlet 1004 receives ambient air and the fan blade 1020 moves the air into duct work 1006, 1012, 1013, 1016, 1018, and the shroud 1014 (e.g., an annular. In the example of FIGS. 10-12 the fan blade 1020 is a centrifugal blower, such that it directs air that is approximately perpendicular or normal to an axis of the fan blade 1020. In various embodiments, an axial blower and/or a combination blower may be used additionally or alternatively to a centrifugal blower as shown in FIGS. 10-12.

Because such blowers as the fan blade 1020 may be mechanically driven from the shaft 1002, there may be no of little conversion losses and the power consumed is may be measurable in cooling air pressure and flow rate provided to cool other components of the system. In contrast, electrical fans may suffer from losses due to conversion of shaft power to electrical power (generation), conversion of voltage (DC-DC), transmission of power (I²R loss), and possibly other losses.

As such, the cooling system depicted in FIGS. 10-12 provides simultaneous cooling of multiple devices and systems from one shaft, turning at one set rotations per minute (RPM) rate, with an airflow inducing element attached. In various embodiments, more than one airflow inducing elements (fans or blowers) may be attached to the single shaft such as the shaft 1002. In this way, different airflow inducing elements may direct different amounts of air, in different directions, with different pressure levels, etc. as described for a given system or component.

Various embodiments may provide series or parallel cooling (or both) of various combinations of system components. The system shown in FIGS. 23-25 provides for parallel cooling of various components via different ductwork. Air may be introduced to ductwork 1018 (at a point A in FIG. 25) from the fan blade 1020 and travel through ductwork 1006 to a heat exchanger 1008. The heat exchanger 1008 may be used, for example, as the charge air cooler 918 or the oil cooler 916. In the example of FIGS. 23-25, both a charge air cooler (or other induction air heat exchanger) and an oil cooler may be present, but only one of those components is visible in the views of FIGS. 23-25, while the other component is blocked from view (though it is partially visible as heat exchanger 1030 in FIG. 23). The heat exchangers 1008 and 1030 may be connected to ductwork 1018 with two separate ducts, only one of which is visible in FIGS. 23 and 24 (e.g., ductwork 1006).

Air may be introduced to ductwork 1016 (at a point B in FIG. 25) from the fan blade 1020 and travel through ductwork 1012 and 1013 to cool cylinders of the engine 1010 (similar to the cylinders 906 of FIG. 22). A shroud 1014 may be placed over or around an electric machine (e.g., a generator motor), and may act as ductwork to provide cool air to cool such an electric machine. Air may be introduced to the shroud 1014 (at a point C in FIG. 25) from the fan blade 1020 and travel through to the shroud 1014 (e.g., to cool motor/generator 914 and/or the inverter 912 of FIG. 22. As such, in FIGS. 23-25, a single centrifugal blower may be shaft driven using power from the engine crankshaft or a power shaft, causing cooling air to enter the blower along and parallel to the axis of rotation. Air then moves radially outward and is collected by three volutes A, B, and C arranged side by side around the blower wheel.

With further reference to FIG. 25, section A of the volute that is most distant from the attachment of the blower wheel to the hybrid powerplant, collects airflow into the enclosed duct 1018. This duct 1018 is then arranged to feed cooling airflow with elevated pressure to two aluminum heat exchangers in a V shape arrangement. One of these coolers may be for engine oil, while the other may be for engine induction air.

Section B of the volute that is between Section A and C (e.g., the middle section) collects airflow into two ducts spaced 180 degrees apart from each other, diametrically opposed. These two ducts are arranged to feed cooling airflow to cylinders of a piston engine. Section C of the volute that is most proximal to where the fan blade 1020 attaches to the hybrid powerplant, is a thin section dedicated to cooling of an electric motor and inverter. This airflow may be contained in a shroud 1014 and forced to flow parallel through the shroud 1014. The shroud 1014 may include within it machined aluminum fins connected to the electric motor and/or inverter housing for the purpose of permitting flow of cooling air and transfer of heat from the electric motor and/or inverter housing to the cooling flow.

Various embodiments may also include more than one centrifugal or radial blower wheel and/or more than one axial fan blade, and they may spin at different RPMs where a gearbox is used. These blowers or fans may be connected to one or more ducts that feed air to a number of dedicated radiators (e.g., fluid-air or air-air heat exchangers) or directly to components that designed to be cooled by airflow (like our cylinders and our motor/generator).

In various embodiments, a single spinning shaft may be used as described herein with two centrifugal blower elements connected back-to-back to one another both attached to the shaft. In such an embodiment, one side of the hub may drive a larger blower that satisfies multiple cooling requirements with relatively high pressure rise and high mass flow. The other side of the hub may drive a relatively smaller blower with the same or a different radius, a provide a different level of pressure rise and mass flow.

In various embodiments, devices may be mechanically driven off the crankshaft and/or power shaft of the hybrid powerplant, including one or more centrifugal blowers and/or one or more axial fan blade sets. This may achieve different packaging requirements/footprints for the system, and/or may be used to provide different airflows with different pressure rise, mass flow, or other engineering parameters desired for a given aircraft and its respective propulsion system and cooling needs.

In various embodiments, a mechanical drive system may not rotate at only a single RPM, but may include gearing or another style off transmission (e.g., belts, continuously variable transmission (CVT), fluid torque converter) to change the RPM of the fan system relative to the crankshaft or power shaft RPM. With such a feature, all the benefits described of avoiding electrically driven cooling systems would be achieved, and the gearing would add flexibility in aerodynamic fan/blower design.

In various embodiments, the ductwork of such systems may be made from various components, such as aluminum, composite materials, three-dimensional (3D) printed materials, etc., or any combination thereof, to achieve a light weight system, where the ductwork material is also capable of being shaped into complex curved surfaces, provide aerodynamic efficiency, etc. Composites such as carbon fiber and epoxy may also be used to bring about a weight reduction in comparison with materials such as aluminum or other metals. The ducts themselves (e.g., between the shaft-driver blower or fan and the devices that require cooling) may also be carefully designed to help balance the pressure drop and air mass flow rate to multiple devices on the genset. This may include shape and size of ducts, constriction along an otherwise straight or simple duct section for engineering purposes.

In various embodiments, thermostatic control may also be added to prevent overcooling (e.g., when ambient air temperature is low). Various embodiments may also include active dampers in ducts to change ratio of air flowing in each duct (e.g., to each component to be cooled). Temperature of those components that are cooled may also be monitored by a controller so that if a component gets too hot the controller can adjust air flow to that component to provide a greater volume and/or pressure of cooling air.

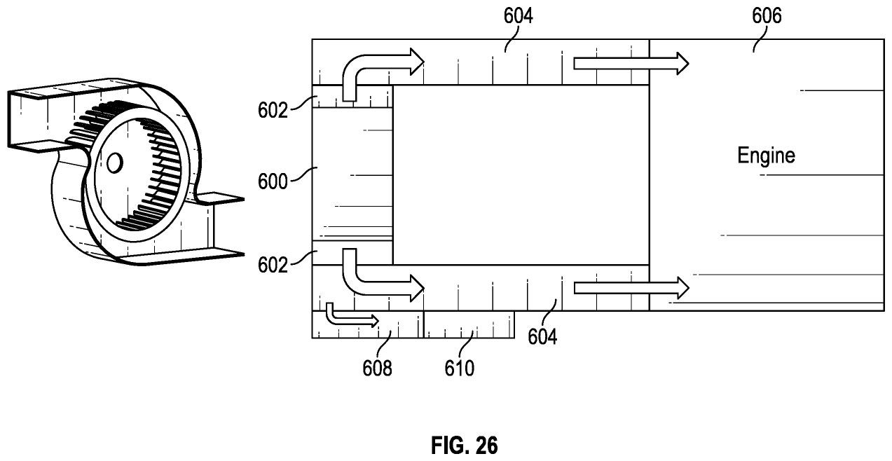

FIG. 26 illustrates a second example schematic of a cooling system for a hybrid powerplant in accordance with an illustrative embodiment. A blower 600 may intake air and provide it to a charge air cooler (e.g., engine intercooler), where the air then passes to ducts 602 and onto the engine 606 to cool cylinders of the engine. Other air may pass through duct 608 an engine oil cooler 610.

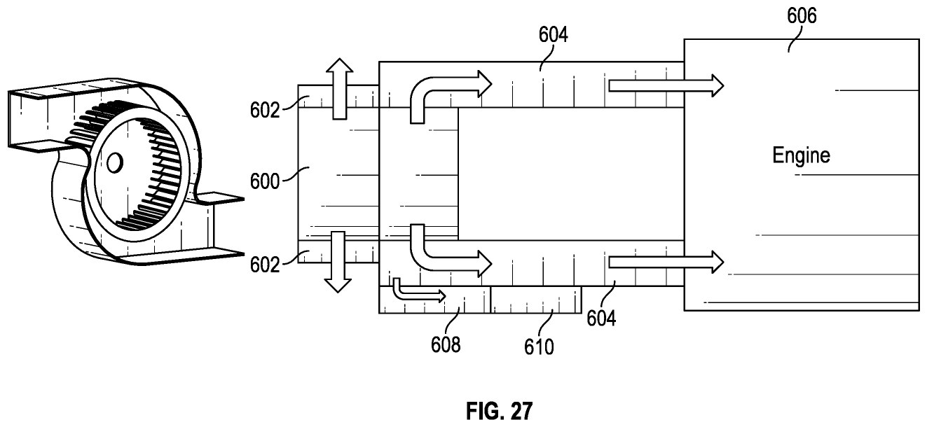

FIG. 27 illustrates a third example schematic of a cooling system for a hybrid powerplant in accordance with an illustrative embodiment. A blower 600 may provide air to a charge air cooler via ducts 602 and may separately provide air to ducts 604 to cool cylinders of an engine 606. Other air may pass through duct 608 an engine oil cooler 610.

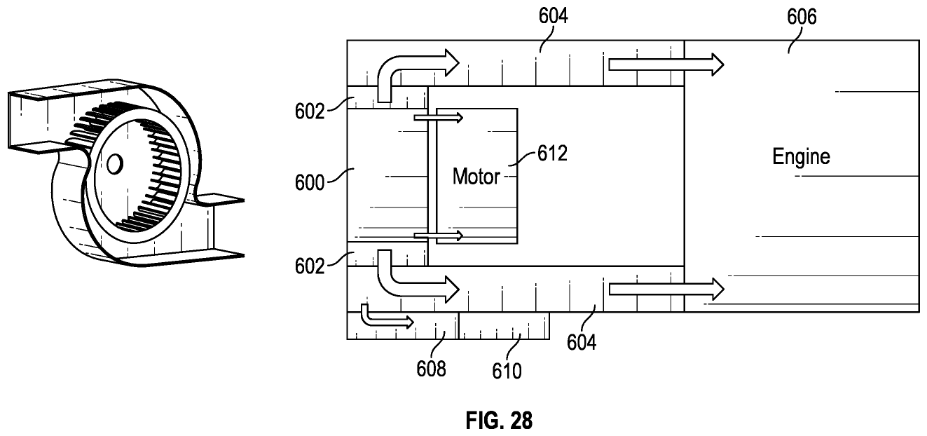

FIG. 28 illustrates a fourth example schematic of a cooling system for a hybrid powerplant in accordance with an illustrative embodiment. FIG. 28 is similar to FIG. 26, example that air is also provided from the blower 600 to a motor 612 (e.g., an electric machine or motor/generator as described herein).

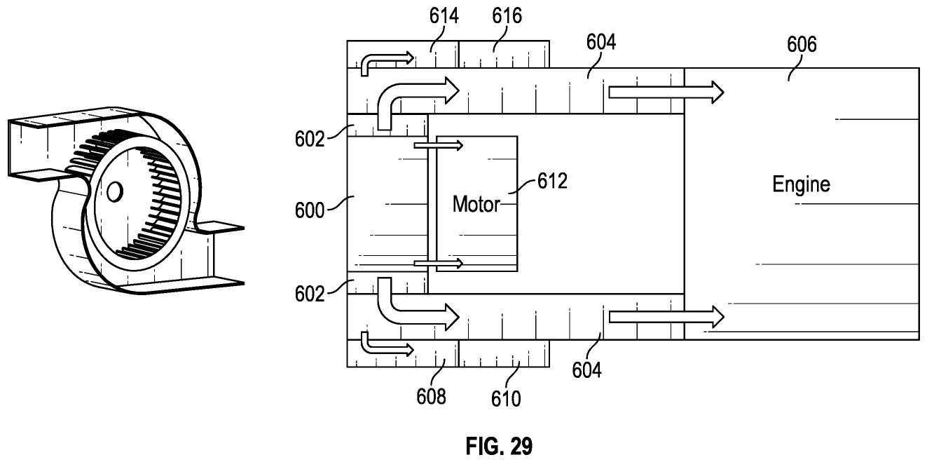

FIG. 29 illustrates a fifth example schematic of a cooling system for a hybrid powerplant in accordance with an illustrative embodiment. FIG. 29 is similar to FIG. 28, except that additional air is provided through duct 614 to a liquid air cooler 616 to cool a motor/generator and/or other power electronics.

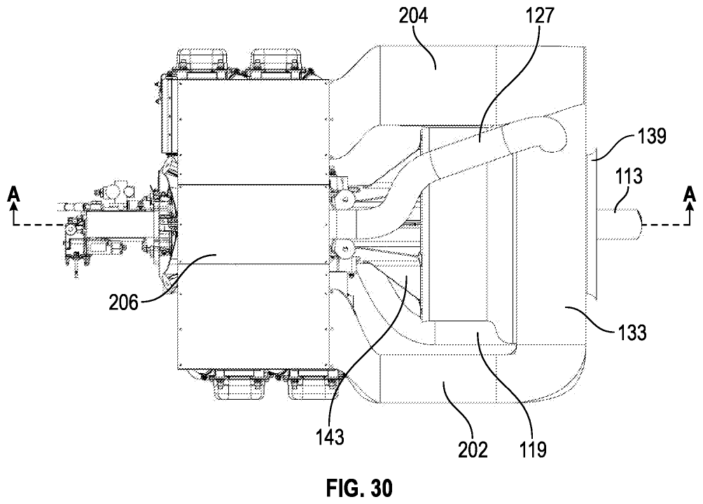

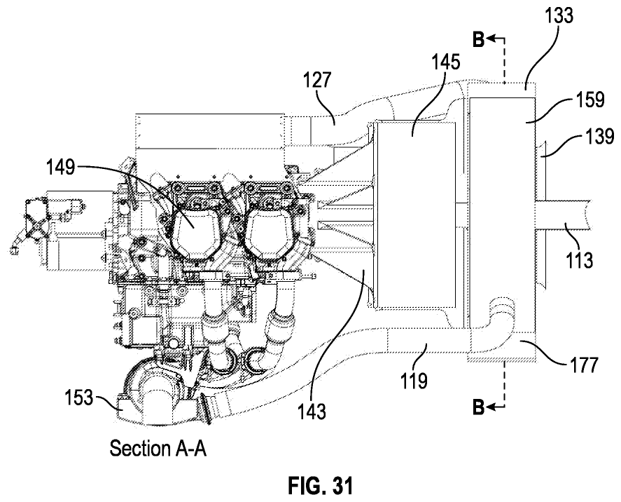

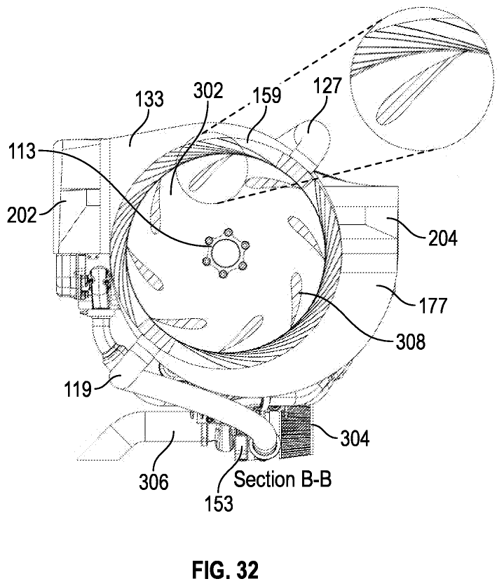

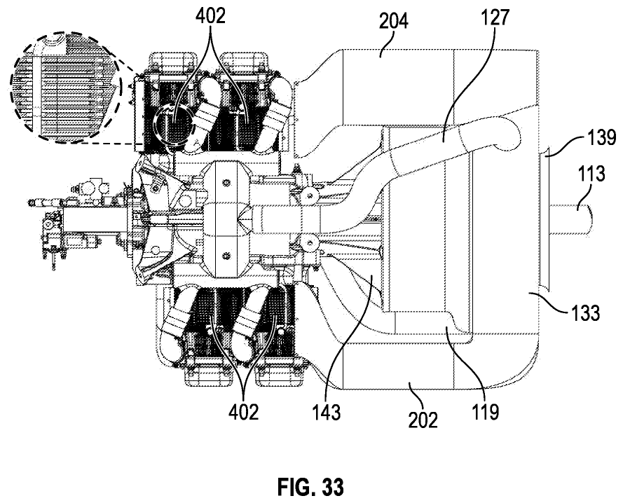

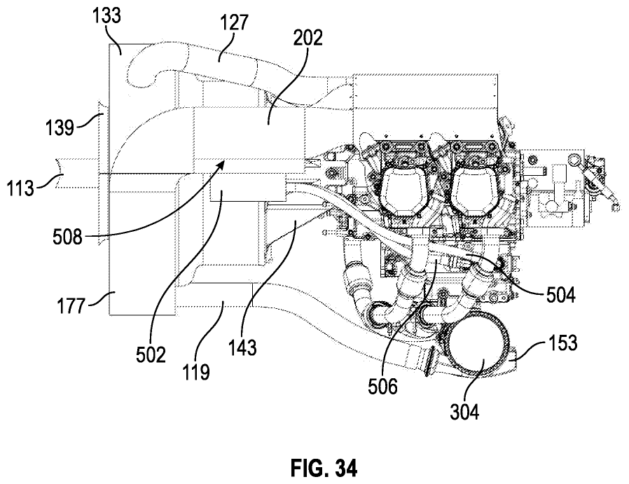

FIG. 30 illustrates a top view of an example hybrid powerplant with a cooling system in accordance with an illustrative embodiment. FIG. 31 illustrates a cross-sectional view taken along line A-A of FIG. 30 showing the example hybrid powerplant of FIG. 30 in accordance with an illustrative embodiment. FIG. 32 illustrates a cross-sectional view taken along line B-B of FIG. 31 showing the example hybrid powerplant of FIG. 30 in accordance with an illustrative embodiment. FIG. 33 illustrates an alternate view of the example hybrid powerplant of FIG. 30 showing detail of cooling fins of an engine in accordance with an illustrative embodiment. FIG. 34 illustrates a side view of the example hybrid powerplant of FIG. 30 with a cooling system in accordance with an illustrative embodiment.

In particular, FIGS. 30-34 depict an engine 149, where a shaft 113 powers a fan wheel 302 to bring air through a blower intake 139. That air is passed through a top volute 133, a bottom volute 177, a right duct 202, and a left duct 204. The fan wheel 302 may also be surrounded by a charge air cooler 159, which receives heated charge air from a turbocharger 153 inlet through a duct 119 and outputs cooled charge air through a duct 127 to the engine 149, and cooled by air provided by rotation of the fan wheel 302. FIG. 32 further shows an engine intake filter 304 and an engine exhaust 306. FIG. 32 also shows a fan wheel fin 308 of the fan wheel 302.

A motor/generator mount 143 also mounts a motor generator 145 to the engine 149. The right duct 202 and left duct 204 also provide air to engine baffling 206 to cool the engine 149. FIG. 33 shows the engine cylinder fins 402 used to cool the engine with cool air from the ducts 202 and 204. FIG. 34 further depicts an engine oil cooler 502 that may receive air via the duct 202 to cool oil for the engine, which is fed to the engine through feed 504 and returned to the cooler via a return 506. A portion of the duct 202 may also be separated with a duct separator 508 so that some air is directed to the engine cylinders while other air is directed to the oil cooler 502.

### Direct Current (DC) Bus Elements

Described herein are various embodiments for implementing a hybrid-electric aircraft. Such an aircraft may utilize a high voltage electrical bus to distribute power to various components of the aircraft, such as motors for propulsion mechanisms of the aircraft. In such a hybrid-electric aircraft, it may be desirable to stabilize the high voltage electrical bus within a specific, predetermined voltage range (e.g., around a nominal voltage level) so that the propulsion motors may perform adequately. Various embodiments described herein may specifically use a direct current (DC) bus, so maintaining a desired DC voltage range may be desirable. Advantageously, the various embodiments herein provide for efficiently maintaining a desired DC voltage range on a DC bus by connecting at least one battery or supercapacitor directly to the DC bus, and further maintaining a sufficient charge on the at least one battery or supercapacitor to maintain the desired DC voltage range on the DC bus. Such embodiments may prevent voltage spikes that may be damaging to components of a hybrid-electric or electric aircraft (e.g., electric motors and inverters for propulsion) and avoid voltage spikes or sags that may negatively impact the reliability and/or performance and safety of the aircraft or systems of the aircraft.

In electrified aviation, various embodiments of an overall architecture may include one or more electric power creation devices (e.g., an electric generator) connected via a low-impedance connection to a high voltage DC bus and feeding electrical power and energy onto that bus. In the same vehicle and attached to that same DC bus may be one or more power consuming devices (e.g., electric motors) that receive electrical power and energy from that DC bus. Various embodiments of electrified aircraft may also include energy storage devices such as battery packs or capacitors (e.g., supercapacitors), which may receive or deliver power as desired depending on bus voltage and battery pack voltage.

If a high-voltage electric generator is directly generating DC power or is operating through a passive rectifier, for example, the DC voltage created by the motor may be a function primarily of motor rotations per minute (RPM) of the shaft rotating the electric generator. A permanent magnet electric motor, for example, may create a voltage based on rotational speed (RPM). For many uses, the coupling of voltage with RPM may create an issue for motor control that limits the value of that electric motor in a system. To gain additional usefulness from a brushless motor without permanent magnets, an external voltage reference may be used to maintain a desired voltage level. A unique problem in aviation is that flight safety requires precise control of power consumers over a wide range of flight conditions (electric motors driving fans, propellers, or other devices) that may not match the characteristics of contributors (such as an electric brushless generator). If a high-voltage generator used is turning slower than expected for any reason, the bus voltage may be lower than desired and any motors on that bus may perform below expectations, which may lead to an unsafe or undesirable condition. If such a high-voltage generator is turning faster than expected, bus voltage may be high and motor performance may again be outside expected or desired values. As such, it may be desirable for applications of generators and motors sharing a common bus to design the generators and motors used accordingly. For electrified aviation, precise control of any motor(s) is desirable to provide lift, thrust, aircraft attitude, etc. for an aircraft. As such, as compared to other, non-aviation related implementations, it is desirable to have better control over a power supplied to any motor(s) (e.g., over the DC bus) by maintaining power supplied to the motor(s) at a voltage that keeps the motor(s) operating at a desired performance level. In addition, the power supplied to the motor(s) may be quickly adjustable so that a pilot or control system of an aircraft may control the motor(s) over a wide range of use as needed (e.g., provide a pilot or control system with a flexible, wide range over which they may control the motor(s)). In various embodiments, inverters may be used to regulate an output voltage of an upstream electric generator(s), which may be used to feed a high voltage bus. Inverters may also be used to precisely control downstream motors under varying load conditions.

Inverters may allow a system designer to expand an operating envelope of any motors and/or generators by controlling current. In order for these inverters to function properly, a bus voltage feeding power to the inverters may advantageously be set and maintained by other methods besides motor RPM (as voltage on a bus may be difficult to control precisely where only motor RPM is used). The maintenance of the bus voltage relates to capacitance and the expected variations in load present under all system operating conditions. If that bus has loads that are varying too rapidly or capacitance (which acts like inertia in an analogous mechanical system) that is too low, for example, then the high voltage bus and power electronic system may become unstable.

In various embodiments, bus voltage may be established and maintained using battery pack(s), capacitor(s), or any combination thereof. Such devices may add capacitance and/or electrical inertia to the bus and are passive, meaning their intended function is ruled completely by physics and may not require control or intervention (e.g., by a controller or control system). Supercapacitors (or ultracapacitors) additionally have a desirable feature of high capacitance, though they typically lack significant energy storage. Supercapacitors may respond to very rapid fluctuations with enormous power (e.g., energy over time). In short, they may provide stability to a bus for fluctuations that are relatively short in duration, low in amplitude, or where the product of those two values is relatively low. Batteries may also be desirable because they have significant capacitance for bus stability and may also store high energy. Batteries may not be able to respond to a change in voltage as quickly as a supercapacitor, as batteries often have more limited rate of power applications, particularly in charging (where discharging power capacity is often 10X or more higher than charging capacity). For example, if it is necessary to pull current off a bus to maintain a desired voltage level (e.g., charge a battery), a battery may not absorb that current as quickly as would be desired in certain embodiments (depending on the specific characteristics of a selected battery). In some embodiments, however, one or more battery packs alone may be sufficient to maintain a desired voltage level on a bus.

Accordingly, various embodiments are described herein that enable independent control of one or multiple upstream electric generators and downstream motors by adding a battery pack and/or supercapacitor bank with an appropriate design to maintain a desired voltage on a DC bus. With an architecture where the voltage and capacitance of those storage elements are directly electrically connected to the main motor control elements on the bus (and not shielded by other switches, chargers, or like devices), the battery pack and/or supercapacitor bank provide a lightweight and effective anchor or setpoint for a high voltage DC bus.

A battery pack in an aircraft may be deployed along with a hybrid-electric generation system to support system safety standards applied to flight articles. If these battery packs and/or supercapacitors are chosen not only to provide required power or energy but are also set at a correct or desired voltage and are connected to high voltage motor controllers, the battery pack and/or supercapacitor bank may provide a second and valuable benefit of bus stabilization by connecting the battery pack and/or supercapacitor bank directly to a DC bus. The battery pack and/or supercapacitor bank may also be advantageously chosen for a given aircraft such that it has a target voltage, though actual voltage on the bus may naturally fluctuate some with state-of-charge (SOC) and varying electric loads. The battery pack and/or supercapacitor bank may also be advantageously chosen so that the actual voltage is unlikely to go outside of a desired range. In instances where the actual voltage does go out of the desired range or is expected to go out of the desired range, a controller of the aircraft or a hybrid-electric genset in the aircraft may adjust the power (e.g., torque) supplied to the generator to add or reduce electric power supplied to the DC bus to maintain the voltage within a proper, desired range. RPM may further be maintained at a constant or relatively constant level or within a predetermined range. Therefore, power supplied to the generator or otherwise output to a power shaft may be adjusted by adjusting the torque output by the engine rather than through adjustment of the RPM of the output of the engine. It may further be desirable to maintain an actual voltage set point that may fluctuate at a range that remains within desired tolerances for operating electric motors or other components of an aircraft. In addition, a battery pack may advantageously serve as an auxiliary source of power to drive motors or other components of an aircraft in the event of a fault in the generator(s) or other component of a hybrid-electric genset. This may therefore add a level of system safety and fault tolerance.

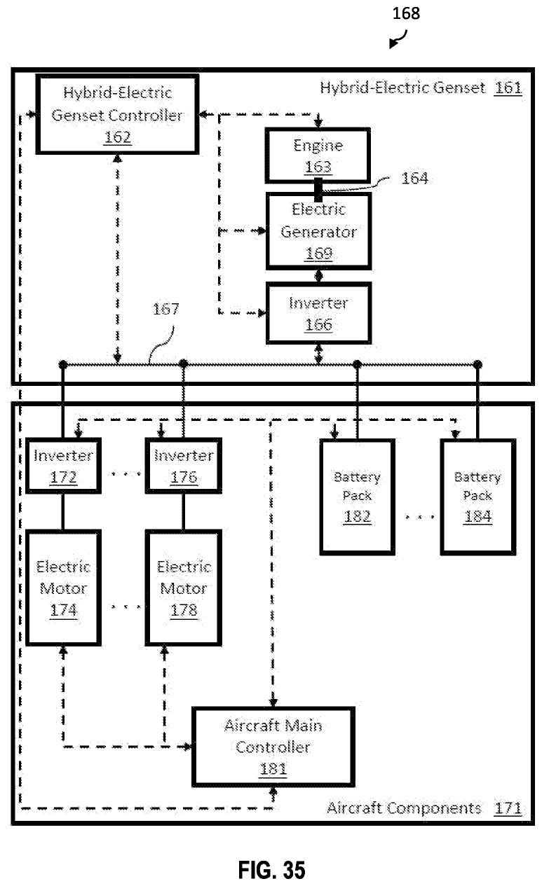

FIG. 35 is a diagrammatic view of an example system 168 for providing a direct current (DC) bus with a stable voltage, in accordance with an illustrative embodiment. The system 168 includes a hybrid-electric genset 161, which includes a controller 162, an engine 163 connected to an electric generator 169 by a shaft 164, an inverter 166, and a direct current (DC) bus 167. The engine 163 may supply mechanical (e.g., rotational) power to the electric generator 169 via the shaft 164 so that the electric generator 169 may produce electric power (e.g., alternating current (AC) power). The AC power from the electric generator 169 may be converted to DC power by the inverter 166 and supplied to the DC bus 167. The inverter 166 may also be able to convert AC power from the DC bus 167 into AC power that may be used by the electric generator 169 to provide power output to a shaft (e.g., where the electric generator 169 acts as a motor to power a component of an aircraft such as a propulsion mechanism). The controller 162 may control any of the components of the hybrid-electric genset 161 (e.g., control an RPM that is output to the electric generator 169). The controller 162 may also measure characteristics of the DC bus 167, such as voltage on the DC bus and/or current flowing through the DC bus 167.

The system 168 further includes aircraft components such as inverters 172 and 176 connected to the DC bus 167, electric motors 174 and 178 connected to the inverters 172 and 176, a controller 181, and battery packs 182 and 184. In various embodiments, the aircraft components may have supercapacitors instead of or in addition to the battery packs 182 and 184. In various embodiments one or more battery packs and/or supercapacitors may be included as part of the hybrid-electric genset 161 and connected directly to the DC bus within the hybrid-electric genset 161, whether or not the aircraft components have separate batteries and/or supercapacitors. While FIG. 35 shows multiple connections running from the DC bus 167 of the hybrid-electric genset 161 to the aircraft components 171, other configurations are contemplated herein, such as a single connection to another bus of the aircraft components 171, or where the DC bus 167 itself is part of the aircraft components 171, etc. The controller 181 may be in communication with the control 162. In this way, the controller 181 may transmit information to the controller 162 about how the inverters 172 and 176, electric motors 174 and 178 are being controlled/used at a present time or how the controller plans to use those components in the future. The controller 181 may also monitor and measure the state of the battery packs 182 and 184 and send information related to that state (e.g., any measurement related to the charge state, voltage, current flowing into or out of battery, etc.) to the controller 162. In embodiments where a battery or supercapacitor is included in the hybrid-electric genset 161, the controller 162 may monitor such components for similar information.

In various embodiments, fewer, additional, or different elements to those shown in FIG. 35 may be included in an aircraft.

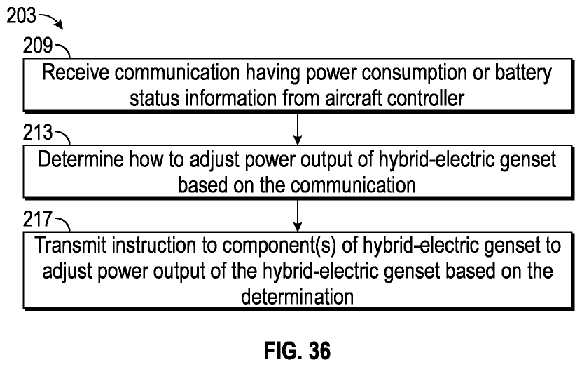

FIG. 36 is a flow chart illustrating an example method 203 for maintaining a stable DC bus voltage based on communications from an aircraft-level controller, in accordance with an illustrative embodiment. At an operation 209, a controller (e.g., the controller 162 of FIG. 35) may receive a communication that includes power consumption or battery status information from an aircraft controller (e.g., the controller 181 of FIG. 35). The power consumption information may relate to how power is currently being used by inverters or electric motors, for example, of an aircraft. The power consumption information may also relate to how will be used by the inverters or electric motors of an aircraft (e.g., information on how the controller is intends to increase or decrease power supplied to motors at a specified time in the future). The battery status information may include a charge state, actual voltage of, and/or current flowing into or out of the batteries or supercapacitors of a system.

At an operation 213, a controller may therefore be able to determine how a power output of a hybrid-electric genset should be adjusted to maintain a desired voltage range on a DC bus. For example, if a battery's charge level is too low such that it is in danger of not being able to maintain a desired voltage, the controller may transmit instructions at an operation 217 to increase the power output of the hybrid-electric genset so that there is sufficient power to charge the battery. In another example, if a motor of the aircraft is currently using or is expected to require significantly more power than is currently being used, the controller may transmit instructions at an operation 217 to increase power output of the hybrid-electric genset. The power output may also similarly be decreased. In either instance, the controller may adjust this overall power output to the DC bus by varying the RPM supplied to an electric generator by an engine. As such, while the battery packs and supercapacitors may reduce a need to provide real time adjustments to power output of a hybrid-electric genset, as the battery packs and/or supercapacitors may maintain the DC bus at a desired voltage level, some control or adjustment of the RPM and therefore output power to the DC bus may still be desirable in various embodiments.

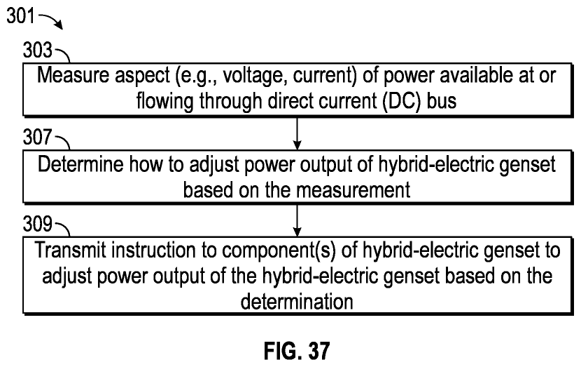

FIG. 37 is a flow chart illustrating an example method 301 for maintaining a stable DC bus voltage based on measurements by a hybrid-electric genset-level controller, in accordance with an illustrative embodiment. The method 301 is similar to the method 203, except it contemplates measurements that may be made by a hybrid-electric genset controller itself (e.g., the controller 162), rather than receiving such measurements or information from another controller (e.g., an aircraft system-wide controller such as the controller 181 of FIG. 35).

At an operation 303, aspects of power available at or flowing through a DC bus is measured by the controller. If the DC bus is measurable by a system-wide aircraft controller, the operation 303 may be carried out by the system-wide aircraft controller as well. Similarly, if batteries and/or supercapacitors are packaged as part of a hybrid-electric genset rather than being positioned as part of an overall aircraft system, the controller may at operation 303 also measure a state of the batteries/supercapacitors (e.g., charge state, current, voltage, etc.). At an operation 307, the controller determines how power output of the hybrid-electric genset should be adjusted based on the measurements. For example, if a DC bus voltage is getting close to going outside of a desired range, it may be desirable to transmit instructions at an operation 309 to the components of the hybrid-electric genset to adjust power output of the hybrid-electric genset based on the determination at the operation 307 to ensure the DC bus voltage stays within a desired voltage range.

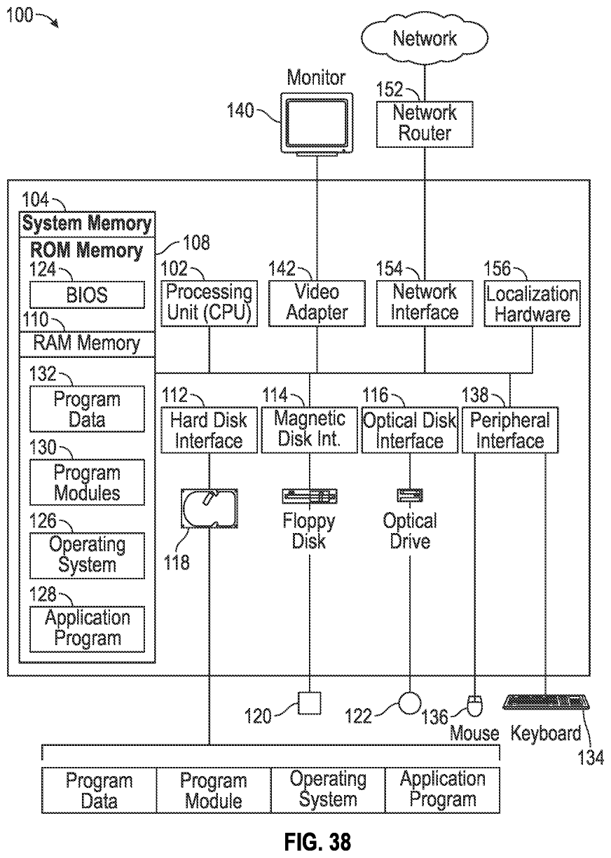

FIG. 38 is a diagrammatic view of an example of a computing environment that includes a general-purpose computing system environment 100, such as a desktop computer, laptop, smartphone, tablet, or any other such device having the ability to execute instructions, such as those stored within a non-transient, computer-readable medium. Various computing devices as disclosed herein (e.g., the controller 162, the controller 181, the processor(s)/controller(s) 205, the main aircraft controller 220, the processor(s)/controller(s) 280, or any other computing device in communication with those controllers that may be part of other components of an aircraft) may be similar to the computing system 100 or may include some components of the computing system 100. Furthermore, while described and illustrated in the context of a single computing system 100, those skilled in the art will also appreciate that the various tasks described hereinafter may be practiced in a distributed environment having multiple computing systems 100 linked via a local or wide-area network in which the executable instructions may be associated with and/or executed by one or more of multiple computing systems 100.

In its most basic configuration, computing system environment 100 typically includes at least one processing unit 102 and at least one memory 104, which may be linked via a bus 106. Depending on the exact configuration and type of computing system environment, memory 104 may be volatile (such as RAM 110), non-volatile (such as ROM 108, flash memory, etc.) or some combination of the two. Computing system environment 100 may have additional features and/or functionality. For example, computing system environment 100 may also include additional storage (removable and/or non-removable) including, but not limited to, magnetic or optical disks, tape drives and/or flash drives. Such additional memory devices may be made accessible to the computing system environment 100 by means of, for example, a hard disk drive interface 112, a magnetic disk drive interface 114, and/or an optical disk drive interface 116. As will be understood, these devices, which would be linked to the system bus 106, respectively, allow for reading from and writing to a hard disk 118, reading from or writing to a removable magnetic disk 120, and/or for reading from or writing to a removable optical disk 122, such as a CD/DVD ROM or other optical media. The drive interfaces and their associated computer-readable media allow for the nonvolatile storage of computer readable instructions, data structures, program modules and other data for the computing system environment 100. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 100.

A number of program modules may be stored in one or more of the memory/media devices. For example, a basic input/output system (BIOS) 124, containing the basic routines that help to transfer information between elements within the computing system environment 100, such as during start-up, may be stored in ROM 108. Similarly, RAM 110, hard drive 118, and/or peripheral memory devices may be used to store computer executable instructions comprising an operating system 126, one or more applications programs 128 (which may include the functionality disclosed herein, for example), other program modules 130, and/or program data 132. Still further, computer-executable instructions may be downloaded to the computing environment 100 as needed, for example, via a network connection.

An end-user may enter commands and information into the computing system environment 100 through input devices such as a keyboard 134 and/or a pointing device 136. While not illustrated, other input devices may include a microphone, a joystick, a game pad, a scanner, etc. These and other input devices would typically be connected to the processing unit 102 by means of a peripheral interface 138 which, in turn, would be coupled to bus 106. Input devices may be directly or indirectly connected to processor 102 via interfaces such as, for example, a parallel port, game port, firewire, or a universal serial bus (USB). To view information from the computing system environment 100, a monitor 140 or other type of display device may also be connected to bus 106 via an interface, such as via video adapter 142. In addition to the monitor 140, the computing system environment 100 may also include other peripheral output devices, not shown, such as speakers and printers.

The computing system environment 100 may also utilize logical connections to one or more computing system environments. Communications between the computing system environment 100 and the remote computing system environment may be exchanged via a further processing device, such a network router 152, that is responsible for network routing. Communications with the network router 152 may be performed via a network interface component 154. Thus, within such a networked environment, e.g., the Internet, World Wide Web, LAN, or other like type of wired or wireless network, it will be appreciated that program modules depicted relative to the computing system environment 100, or portions thereof, may be stored in the memory storage device(s) of the computing system environment 100.

The computing system environment 100 may also include localization hardware 186 for determining a location of the computing system environment 100. In some instances, the localization hardware 156 may include, for example only, a GPS antenna, an RFID chip or reader, a WiFi antenna, or other computing hardware that may be used to capture or transmit signals that may be used to determine the location of the computing system environment 100.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

### Noise Reduction Elements

Described herein are various embodiments for reducing noise emitted by an aircraft component such as an aircraft powerplant or component thereof. Although several embodiments described herein relate to enclosures for aircraft powerplants, such as engine cowlings, the various embodiments described herein may be used for components of aircraft other than powerplants and engines, and further still may be used to reduce noise emitted from components other than those of aircraft (e.g., helicopters, airplanes, vertical takeoff and landing (VTOL) aircraft, short takeoff and landing aircraft (STOL), etc.). For example, the embodiments described herein may also be implemented for any source of noise through which or around which air may pass, such as components of boats, motorcycles, automobiles, any other motor vehicle, or even for stationary components that generate noise around which or through which air passes.

Inlet and outlet airflow of noise producing components such as aircraft powerplants can be sources of noise, as the airflow into or out of those components can act as a medium through which noise and vibration can propagate. For example, in an aircraft having a hybrid powerplant, that hybrid powerplant may include a piston, rotary, or turbine engine that emits noise and has inlet and outlet airflow through which that noise may travel. Described herein are various embodiments for designing the geometry of the inlet and/or outlet airflow to reduce the amount of noise that is ultimately emitted from an enclosure having a noise emitting component therein, such as the cowling of an engine. For example, the various embodiments described herein, different air inlets and/or outlets may be configured to have a desired aspect ratio (e.g., length/width aspect ratio), eliminate line of sight from an engine (e.g., a noisy combustion engine) to any directions outside the aircraft that are noise sensitive, and/or line any internal noise-reflective surfaces with noise attenuating materials. Such embodiments as described herein advantageously provide for a weight-efficient and effective means of reducing operating noise from a noise emitting component, such as an aircraft hybrid powerplant.

The noise reducing embodiments described herein may be particularly advantageous for use in certain implementations. For example, some aircraft may have a hybrid powerplant that includes a combustion engine (e.g., turbine, rotary, piston) as well as an electric machine such as an electric motor/generator. Noise from such a hybrid generator will may be generated in and travel via the exhaust stream from the combustion engine, and further may escape via an airflow inlet for the combustion engine as well. While noise in an exhaust stream may be minimized with methods such as a muffler, other components of a hybrid powerplant and/or combustion engine may also generate noise, such as throughout the engine core, any cooling fans, pumps, and/or other accessory devices. Since that noise may generated at multiple places at once (e.g., from multiple sources/components), the noise may be hard to minimize.

Thus, the embodiments described herein are configured to reduce noise emitted by multiple sources (e.g., multiple powerplant or engine components that emit noise simultaneously). Noise may be carried from a noise source to a human ear via a medium such as air. The embodiments herein include enclosing noise sources (e.g., an aircraft powerplant) and manage airflow into and out of such an enclosure (and subsequently to the aircraft powerplant). The embodiments described herein further provide for additional noise reduction through the addition of noise attenuating material to various portions of the enclosure and in various configurations to reduce noise that may escape the enclosure (including noise that may escape through air inlets or outlets of the enclosure). That noise attenuating material may be a noise attenuating foam or any other type of suitable material.

Such noise attenuating material may further be placed within the enclosure (e.g., within the air inlet and/or outlet) in specific orientations and/or geometries to limit noise while also not hindering overall system performance (e.g., not hindering airflow to or from the powerplant). Accordingly, described herein are also orientations and geometries that are advantageously sized so as to not introduce unwanted pressure loss to an inlet or exit cooling airflow stream (e.g., backpressure to an exit cooling airflow stream). In various embodiments, noise attenuating materials used may also be selected based on their noise attenuating properties, resistance to fluids, heat, and/or fire, resistance to humidity, resistance to mold, resistance to corrosion, etc., so that the noise attenuating material has properties that are desirable for a given application.

Advantageously, the embodiments described herein therefore enable noise emitting components to be operated with a lower noise signature, which may be desirable, for example, in hybrid electric power for aviation.

As just one example of a system where it may be advantageous to use the systems and methods described herein, a hybrid powerplant configured to generate electrical and mechanical power for an aircraft may emit or produce noise that is desirable to minimize. For example, such a hybrid powerplant may include a prime mover such as an engine using combustion to create shaft work/power. That combustion may create noise, and noise from combustion engines in other applications is often released to an environment directly or conditioned using a muffler or similar method.

However, in addition to the noise created by the prime mover (e.g., combustion engine), a hybrid powerplant may have one or more other sources of noise, which may include, but are not limited to: (i) fuel injectors opening and closing, (ii) pistons slapping the cylinder walls inside a piston engine, (iii) fans whipping the air and/or slot gaps on fans creating noise, (iv) fluid pumps (e.g., oil, water, fuel), and/or (v) mechanical vibrations traveling through various parts and pieces.

The collective noise of the above and any other components of a hybrid powerplant may be referred to herein as the ambient noise of running a hybrid powerplant. Such ambient noise emission and propagation to a surrounding environment may be greatly reduced using the various systems and methods described herein.

A hybrid powerplant may have another feature that permits noise emitted from the powerplant to be released into an environment. An air intake or inlet for cool air may be used for combustion in the engine and/or other cooling tasks of the powerplant. An air exhaust or outlet for warm or hot air may also be released into the atmosphere. Since airflow velocities at intakes and exhaust for an engine are typically low compared to the speed of sound (e.g., less than 0.3 Mach (Ma)), any noise generated by components of the hybrid powerplant may travel through either intake and/or exhaust airstreams of the engine. In other words, the air moving into and out of a hybrid powerplant may carry sound waves, and the systems and methods described herein advantageously describe geometries and materials for air intake and/or exhausts that provide for significant reduction of noise emitted from an enclosure (e.g., a cowling) for a noise emitting component (e.g., a hybrid powerplant, combustion engine, related components of the combustion engine, etc.).

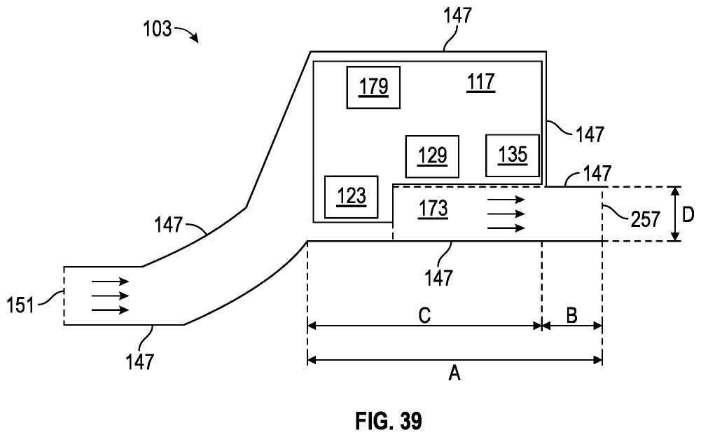

FIG. 39 illustrates a side cross-sectional view of an enclosure 103 having noise reduction components in accordance with an illustrative embodiment. The enclosure 103 includes an air inlet 151 (e.g., intake) and an air outlet 157 (e.g., exhaust) that may be fluidly connected so that air may flow from the air inlet 151 to the air outlet 157. Inside the enclosure 103 is a cavity 117 for components that may use that airflow, such as a combustion engine (e.g., piston, turbine, rotary). In various embodiments, the components in the cavity 117 may block a flow of air between the air inlet 151 and the air outlet 157 when the components are not operational. However, when the components are operational, those components may use and/or move air from the air inlet 151 to the air outlet 157. As such, even if components fill the cavity 117 and completely block and/or seal the inside of the enclosure between the air inlet 151 and the air outlet 157, the air inlet 151 and the air outlet 157 may still be considered to be fluidly connected while the components in the cavity are operation (e.g., while an engine is running). In various other embodiments, the components in the cavity 117 may not fully block a fluid path between the air inlet 151 and the air outlet 157. In such embodiments, air may still flow through the enclosure even when components in the cavity 117 are not operational.

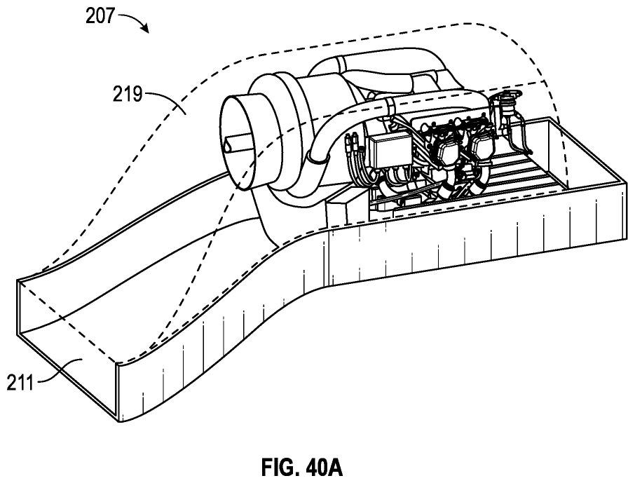

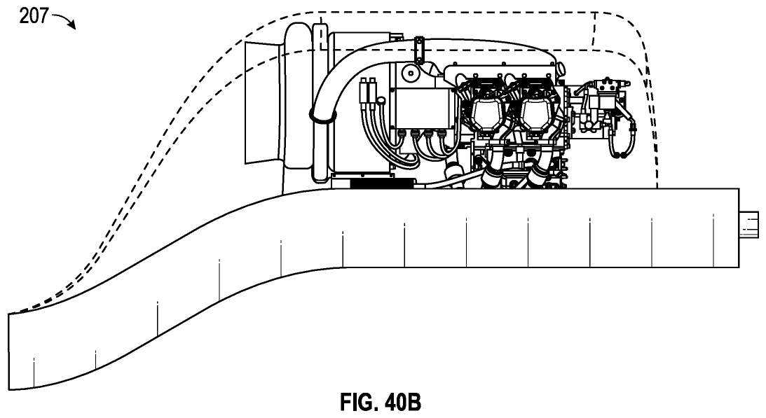

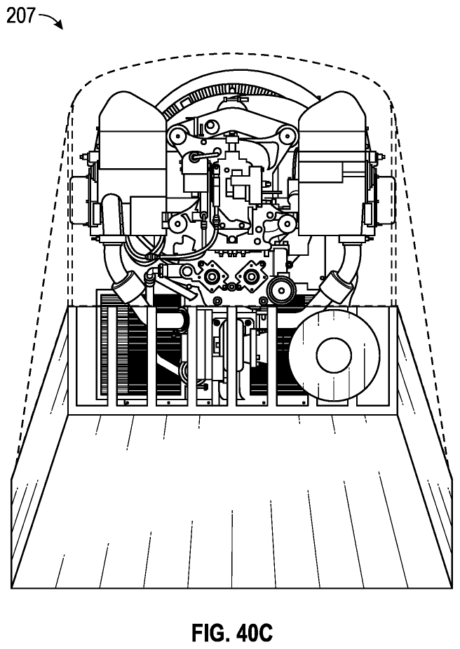

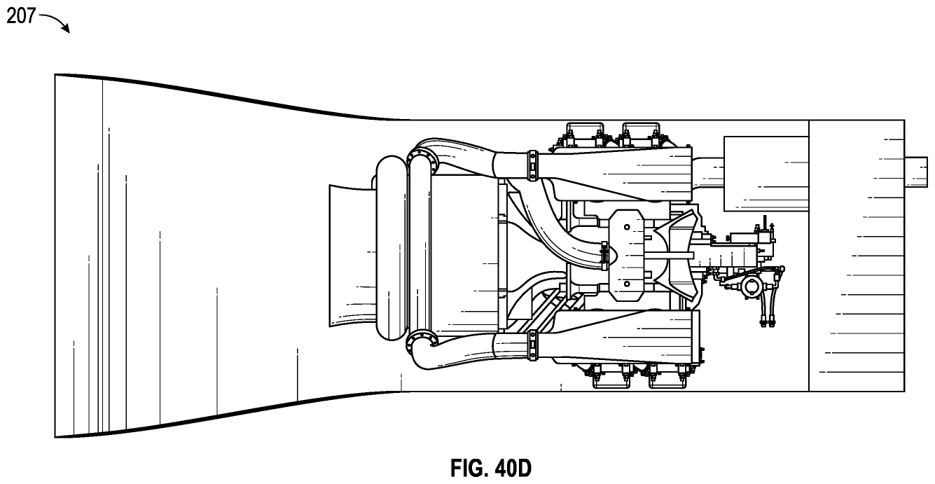

As further shown in FIG. 39, the enclosure 103 may be made up of various sidewalls 147. In various embodiments, the sidewalls 147 may be in varying configurations or shapes as desired based on the application, components to be fit inside the enclosure, where air inlets and outlets are desired, etc. The sidewalls 147 may also be configured to permit desired flow of air through the air inlet 151 and the air outlet 157, and subsequently supply enough air to an intake of the components in the cavity 117 as well as permitting sufficient exhaust from the components in the cavity 117. Examples of a differently shaped enclosures are shown in and further described below with respect to FIGS. 40-51. Any or all of the sidewalls 147 may be coated with, covered with, or be formed from or incorporating noise attenuating material to reduce noise within the enclosure 103, and therefore reduce noise that may escape the enclosure 103.

The sidewalls 147 of FIG. 39 are configured to have an opening to form the air inlet 151 and an opening to form the air outlet 157. In addition to forming the cavity 117, the sidewalls 147 also form a noise reduction chamber 173. While the noise reduction chamber 173 in FIG. 39 is shown between the cavity 117 and the air outlet 157, various embodiments may additionally or alternatively include a noise reduction chamber between the air inlet 151 and the cavity 117, or anywhere else that there is air flow within the enclosure 103.

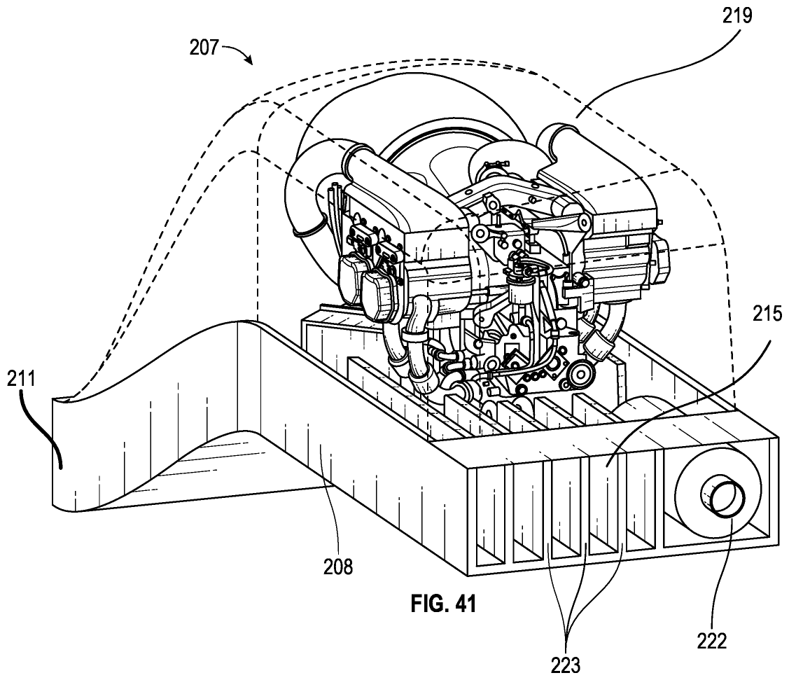

The noise reduction chamber 173 may include noise attenuating elements, such as channels formed by vertically oriented walls within the noise reduction chamber. Examples of such channels are shown in and described further with respect to FIGS. 41, 42, and 47-51. In various embodiments, channels that oriented in different ways may be used. For example, in addition to vertically oriented walls, walls may be oriented horizontally, at any angle, etc. In various embodiments, individual walls or multiple walls may be shaped to be vertically oriented, horizontally oriented, angled, or any combination thereof at different points in a wall. In such embodiments, the walls may be any shape as long as channels between the walls permit airflow to pass through.

Merely by way of example, various components 123, 129, 135, and 179, such as components of a hybrid powerplant for an aircraft, may be mounted or otherwise located at different positions within the cavity 117. More or less components may be typically included in the cavity 117, and various components may be in different locations with the cavity 117 than is shown in FIG. 39.

Because different components 123, 129, 135, and 179 may be in different locations within the cavity 117, those components 123, 129, 135, and 179 may produce or emit noise that is emitted from different locations within the cavity. Therefore, as discussed herein, it may be difficult to specifically tune noise reduction elements for each and every potential source of noise within the enclosure 103. Thus, the noise reduction chamber 173 may attenuate noise or vibration propagating in the exhaust air as it travels through the noise reducing chamber 173 to the air outlet 157 (or may attenuate noise or vibration propagating in inlet air as it travels from the air inlet to the components in the cavity 117, in embodiments where noise attenuating elements (e.g., a noise reduction chamber) is placed along an air inlet path). For example, the plurality of channels in the noise reducing chamber may be formed of noise attenuating material, such that noise or vibration is absorbed by the walls of those channels, thereby reducing the amount of noise or vibration that is present in any air output at the air outlet 157.

As shown in FIG. 39, different components 123, 129, 135, and 179 may be located further or closer to the air outlet 157 relative to one another based on their placement within the cavity 117. Accordingly, while the noise reducing chamber may have a total length of A as shown in FIG. 39, some of the components 123, 129, 135, and 179 may have noise and/or air exhaust that travels, at minimum, through the length B of the noise reduction chamber 173. Other of the components 123, 129, 135, and 179 may have noise and/or exhaust air that additionally travels through some or all of the length C of the noise reduction chamber 173 in addition to the length B of the noise reduction chamber 173. As such, it may be desirable in various embodiments to extend the noise reduction chamber beyond the cavity 117 (e.g., the length B) to ensure that noise emitted from any source within cavity travels at least a minimum distance B within the noise reduction chamber 173. As such, the noise reduction chamber 173 may have a first section associated with length C that is immediately adjacent to the cavity 117 and a second section associated with length B that is not immediately adjacent to the cavity 117. In other words, air from the cavity 117 would pass through the first section (e.g., length C) of the noise reduction chamber 173 prior to passing through the second section (e.g., length B) and then out through the air outlet 157.

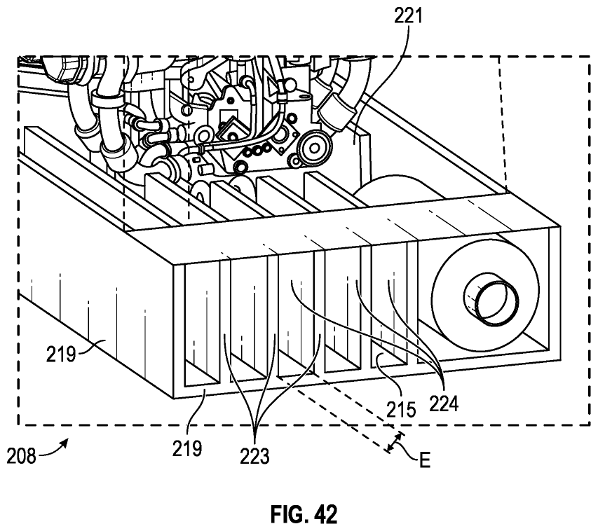

The noise reduction chamber 173 may also have a height D. A plurality of walls within the noise reduction chamber 173 may be configured to have a height approximately equal to D and a length approximately equal to A, such that the walls substantially fill the space of the noise reduction chamber 173 (e.g., as shown in FIG. 42). Since there is an opening between the cavity 117 and the noise reduction chamber 173, as well as an opening in the sidewalls 147 at the air outlet 157, air may therefore flow from the cavity 117, between the plurality of walls within the noise reduction chamber 173, and out through the air outlet 157. Since the plurality of walls within the noise reduction chamber 173 may be formed from a noise attenuating material, noise in air moving the noise reduction chamber 173 may be removed or reduced prior to the air's output at the air outlet 157. Although a noise reduction chamber associated with an outlet has been discussed and shown with respect to FIG. 39, it should be understood that a similar noise reduction chamber may be implemented in any space formed by the sidewalls between the cavity 117 and the air inlet 151, or even in any space within the cavity 117 itself.

FIG. 40A is a front perspective view showing an air inlet 211 of an example enclosure 207 having noise reduction components therein in accordance with an illustrative embodiment. The enclosure 207 is similar to that depicted in FIG. 39, and specifically shows the air inlet 211 side of the enclosure 207, as well as a sidewall 219 that, in part, forms a cavity within the enclosure 207 configured to hold components of a hybrid powerplant for an aircraft, such as a combustion engine and related components. FIG. 40B is a side view showing the example enclosure of FIG. 40A in accordance with an illustrative embodiment. FIG. 40C is a rear view showing the example enclosure of FIG. 40A in accordance with an illustrative embodiment. FIG. 40D is a top view showing the example enclosure of FIG. in accordance with an illustrative embodiment.

FIG. 41 is a rear perspective view showing an air outlet 215 of the enclosure 207 of FIG. 40A in accordance with an illustrative embodiment. The enclosure 207 as shown in FIG. 41 shows the air outlet similar to the air outlet 157 of FIG. 39. Also visible in FIG. 41 is an edge of the air inlet 211 and another sidewall 219 that, in part, forms a cavity for a hybrid powerplant of an aircraft.

FIG. 41 also shows a plurality of walls 223 that may be formed within a noise reduction chamber 208 of the enclosure 207 (which is similar to the noise reduction chamber 173 of FIG. 39). A muffler 222 is also shown that may be within the noise reduction chamber 208 and between two of the plurality of walls 223, which may further reduce noise that is released to the atmosphere. The plurality of walls 223 may extend into the noise reduction chamber 208, where an opening at the top of the channels between the plurality of walls 223 between the noise reduction chamber 208 allows air flow between a cavity of the enclosure 207 and noise reduction chamber 208 (as further shown in FIG. 42).

FIG. 42 is a top perspective view of noise reducing channels 224 in the noise reducing chamber 208 of the enclosure 207 of FIG. 40A in accordance with an illustrative embodiment. In particular, the sidewalls 219 further form the noise reducing chamber 208, and the plurality of walls 223 form the plurality of channels 224. One wall 221 may be a different shape than the other plurality of walls 223 to, for example, accommodate the muffler 222 shown in FIG. 41. The plurality of walls 223 may be formed from a noise attenuating material such as foam, or any other suitable material. The plurality of channels 224 may have a width E. However, in various embodiments, the plurality of channels 224 may not all have the same width, and/or may have variable widths (e.g., may be wider closer to an enclosure cavity and get narrower near the air outlet 215, may be narrower closer to the enclosure cavity and get wider near the air outlet 215). In embodiments where the noise reduction chamber has an irregular shape or any other shape than that depicted in FIGS. 39-42, the plurality of walls may also be formed to have varying shapes to fit the noise reduction chamber and have desired proportions to create desired channel size (e.g., width E; lengths A, B, C; height D; etc.). The plurality of walls 223 may also have varying widths as desired, or may have a desired width that is optimized for noise reduction based on a particular application, material selected, etc. In addition, the plurality of channels may each have a cross-sectional area through which air flow. That cross-sectional area may be constant over a length of an individual channel, over the length of more than one (or all) channels, or may be variable. As discussed above, since the dimensions of the plurality of walls and the spacing between those walls may be varied, so too may the cross-sectional area of the channels formed by the walls be varied. For example, the cross-sectional area may be larger closer to the air outlet 215 than it is near a cavity of the enclosure 207, or the cross-sectional area may be smaller closer to the air outlet 215 than it is near a cavity of the enclosure 207.

As such, the plurality of walls within a noise reduction chamber, or other portion of an enclosure or cowling, may be arranged in any manner desired to achieve noise attenuation. The varying possible sizes of the plurality of walls and their associated channels may be referred to based on different aspect ratios applied to the geometry of the walls and channels. For example, a length/width ratio of a second section only (e.g., the part of the noise reducing chamber 208 that sticks out the back of the cavity) may be a length B of FIG. 39 over a width E of FIG. 42. As just one example, a desirable length width ratio of at least 1.3 may be desirable, for example a length B of twelve (12) inches and a width E of nine (9) inches for an aspect ratio of 1.333 may be used. Other aspect ratios may be used to configure the walls and channels of a noise reducing chamber, including any of the dimensions A, B, C, D, and/or E as demonstrated in FIGS. 39 and 42.

These aspect ratios may be advantageously configured to create channels with desirable aspect ratios from a perspective of permitting adequate airflow through a noise reducing chamber. For example, low pressure drop passage of air may be desired either at an enclosure input or output. On one hand, if the channels formed by parallel walls are too wide (e.g., if the spacing of the foam compared to the length and height of the channel is too broad) then noise reduction qualities may be reduced. On the other hand, if the channels are narrow and very long, there is ample opportunity for the pressure waves of the noise to be attenuated by coming into contact with the plurality of walls. Accordingly, for a given application, wall material type, etc., a balance of channel width (e.g., length E or distance between two parallel planes), height (e.g., length D), and length (e.g., length A or distance along the axis of airflow principal direction) is important to advantageously achieve to balance desirable noise reduction qualities of the channels without meaningfully affecting performance of the engine or other components within the enclosure.

One example noise attenuating material that may be used in the embodiments described herein includes a melamine open-cell foam made from melamine resin. This foam may be characterized by excellent noise absorption with high fire retardancy and resistance to flame and smoke. For example, open-cell or closed-cell foams may be used, and may be formed from varying materials such as melamine, cellulose, polyethylene, cotton, any other suitable material, or any combination thereof. The plurality of walls described herein may have any desired thickness, and merely by way of example, thicknesses of one (1) inch to two (2) inches may be used. If different materials are used as the noise attenuating material, the thickness may be varied based on the properties of that material or combination of materials. The noise attenuating material and/or walls described herein may also be lined/coated with another material or may not be lined/coated with any other material. The walls configured to attenuate noise described herein may also be patterned in different ways to reduce resistance for airflow (e.g., smoother patterns) and/or increase noise attenuation. For example, the materials described herein may be formed to have a smooth surface, egg-crate surface pattern, pyramid-shaped surface pattern, wedge-shaped surface pattern, hemisphere-shaped surface pattern, wave-shaped surface pattern, any other pattern, or any combination thereof.

In the embodiment shown in FIG. 42, the foam walls are thick enough such that the walls can be freestanding without having an internal support system within the foam of another type of material. Optionally, other materials could be used within the foam to support it, such as a thin center plate (e.g., carbon fiber) that is then coated on either side by a noise attenuating material such as foam.

The walls are further arranged to create channels as described herein, such that air may pass between parallel or substantially parallel planes of foam. In this way, sound pressure waves may be attenuated while the core flow of air through a noise reduction chamber has minimal restriction as it heads into or out of the system. As such, it is desirable to configure the walls and the channels between them such that there is not too much aerodynamic resistance (e.g., pressure loss) airflow streams (e.g., for air flow used for cooling engine components), then performance of an engine (including e.g., performance of cooling systems) may degrade. With properly sized channels such an effect of decreased performance may be minimized. In various embodiments, as described herein, non-parallel walls may additionally or alternatively be used.

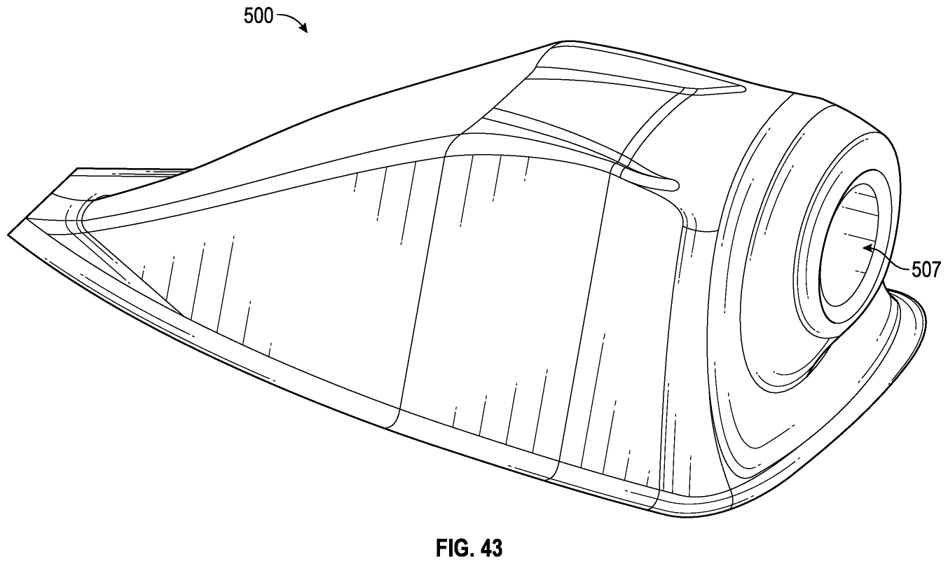

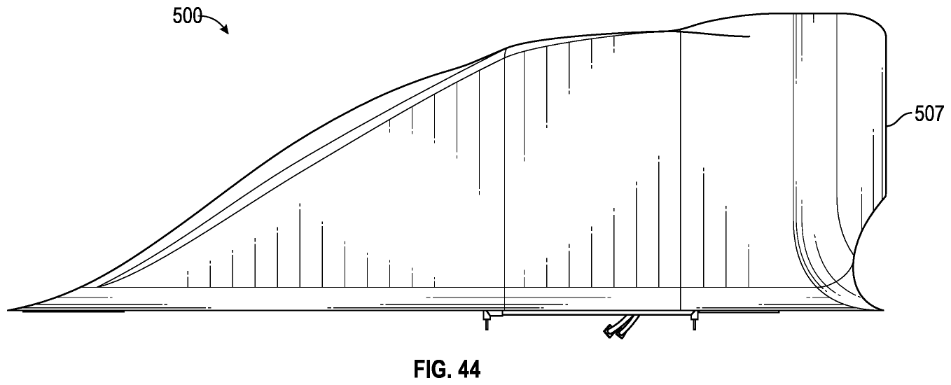

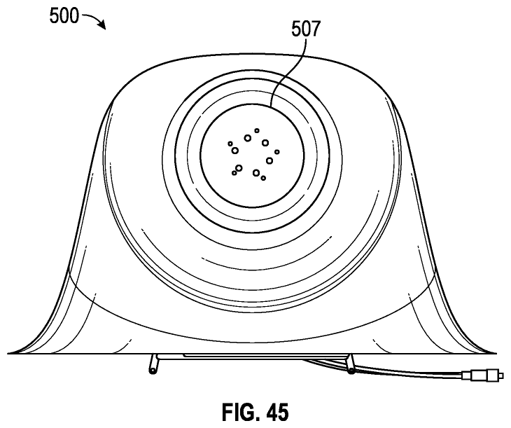

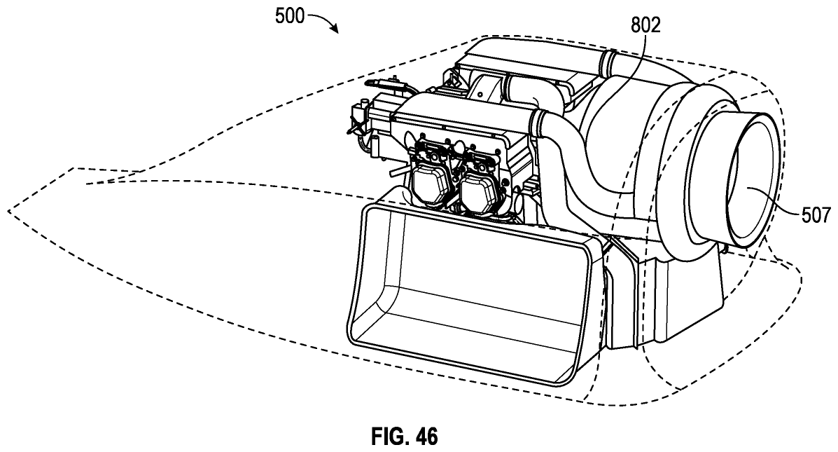

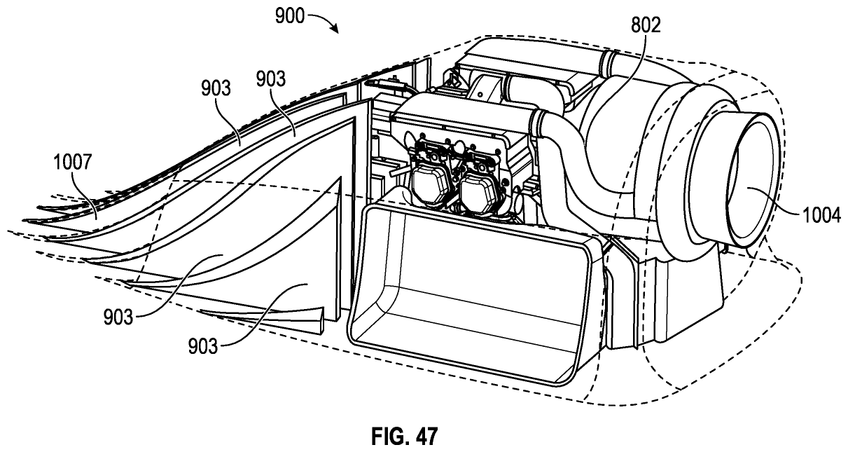

FIG. 43 is a top perspective view of another example enclosure 500 having noise reduction components therein in accordance with an illustrative embodiment. FIG. 44 is a side view of the enclosure 500 of FIG. 43 in accordance with an illustrative embodiment. FIG. 45 is a front view of the enclosure 500 of FIG. 43 in accordance with an illustrative embodiment. FIG. 46 is a perspective view of the enclosure 500 of FIG. 43, showing the enclosure as being partially transparent in accordance with an illustrative embodiment. The enclosure 500 of FIGS. 43-46 includes an air inlet 507 and an air outlet (not shown in FIGS. 43-46, but a similar enclosure with an outlet 1007 is shown in FIGS. 47-51). The enclosure 500 may specifically be a cowling of an engine or hybrid powerplant for an aircraft. The enclosure 500 may also be designed to be an external surface of an aircraft, such that the enclosure 500 is aerodynamic and the air inlet 507 is oriented toward a front of the aircraft. As shown in FIG. 46 where the enclosure 500 is partially transparent, engine components 802 may be in a cavity of the enclosure 500. As shown and described further below with respect to FIGS. 47-51, an enclosure similar to the enclosure 500 may have a plurality of noise attenuating walls therein in order to implement the noise reducing advantages described herein.

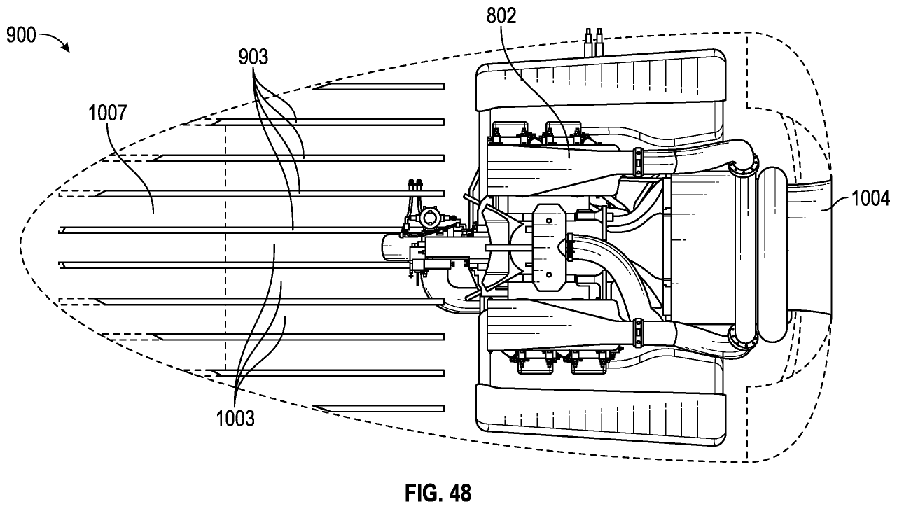

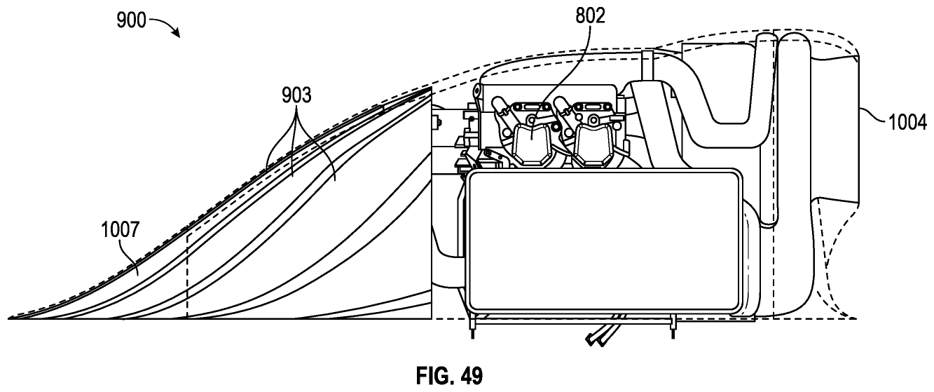

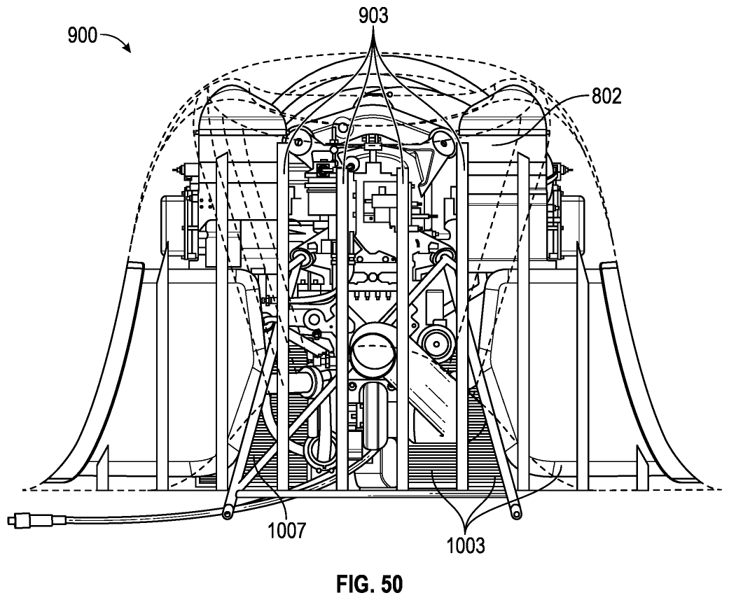

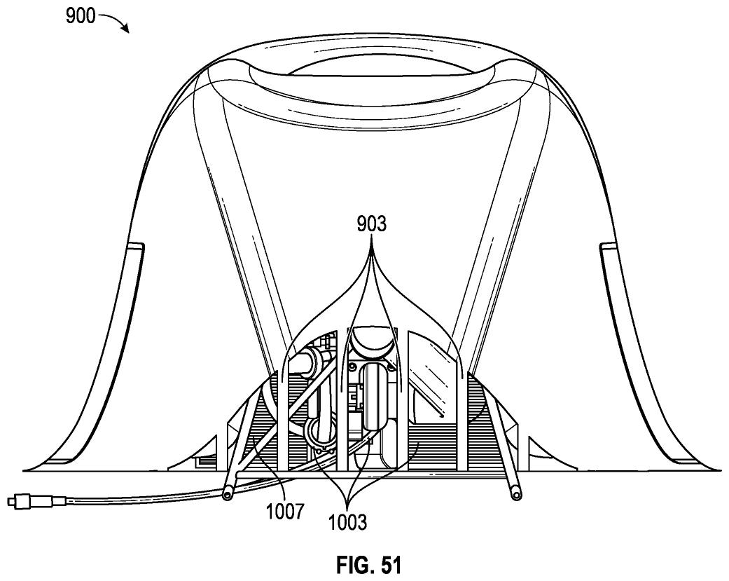

FIG. 47 is a perspective view of another example enclosure 900, showing the enclosure as being partially transparent and having noise reduction components therein in accordance with an illustrative embodiment. FIG. 48 is a top view of the enclosure 900 of FIG. 47 in accordance with an illustrative embodiment. FIG. 49 is a side view of the enclosure 900 of FIG. 47 in accordance with an illustrative embodiment. FIG. 50 is a rear view of the enclosure 900 of FIG. 47 in accordance with an illustrative embodiment. FIG. 51 is a rear view of the enclosure 900 of FIG. 47, except showing the enclosure as opaque in accordance with an illustrative embodiment.

In particular, FIGS. 47-51 show a plurality of walls 903 within the enclosure 900 that form a plurality of channels 1003 for reducing noise emitted by and/or produced by engine components 802. The enclosure 900 further includes an air inlet 1004 and an air outlet 1007 so that air may be used by the engine components 802 and output out of the outlet 1007 after use. The enclosure 900 may be attached to an aircraft to supply electrical power to such an aircraft. While FIGS. 47-50 show the enclosure as partially transparent such that the components inside the enclosure 900 are apparent, FIG. 51 shows the enclosure as opaque so as to better demonstrate the air outlet 1007. As shown in FIGS. 47-51, the plurality of walls may be varying in shape as a result of the shape of the enclosure itself. Thus, as shown in this example, a plurality of walls may be customized to fit any space within a cowling or enclosure to reduce noise emitted by the components therein.

In an illustrative embodiment, any of the operations described herein may be implemented at least in part as computer-readable instructions stored on a computer-readable medium or memory. Upon execution of the computer-readable instructions by a processor, the computer-readable instructions may cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or from practice of the disclosed embodiments. It is intended that the scope of the invention be defined by the claims appended hereto and their equivalents.

What is claimed is:

1. An energy source for an aircraft comprising:
an enclosure;
an engine;
an electric generator;
at least one fuel tank configured to provide fuel to the engine; and
electrical connectors for outputting power to a propulsion system of the aircraft, wherein the power is generated by the electric generator and output to at least one electrical component or electrical bus of the aircraft,
wherein the engine, the electric generator, and the at least one fuel tank are each housed within the enclosure, and
wherein the propulsion system of the aircraft is not within the enclosure of the energy source.

2. The energy source of claim 1, wherein:
the energy source is a first energy source,
the propulsion system of the aircraft comprises a propulsion motor,
the aircraft comprises a second energy source separate from the first energy source, and
a powerplant of the aircraft is flyable and configured to provide power to the propulsion motor using the second energy source with or without use of the first energy source.

3. The energy source of claim 1, wherein the propulsion system is located elsewhere on the aircraft than a location where the energy source is mounted to the aircraft.

4. The energy source of claim 1, wherein the power generated by the electric generator propulsion system passes through wiring or the electrical bus of the aircraft before being provided to the propulsion system of the aircraft, wherein the wiring or the bus of the aircraft is not within the enclosure of the energy source.

5. The energy source of claim 1, wherein the at least one electrical component or the electrical bus of the aircraft is connected to at least one of an electric propulsion motor or a propulsive battery of the aircraft.

6. The energy source of claim 1, wherein the energy source is configured to power a same propulsive motor that is fed by one or more batteries of the aircraft, wherein the one or more batteries is not housed within the enclosure of the energy source.

7. The energy source of claim 1, wherein the power output via the electrical connectors is direct current (DC) power or alternating current (AC) power.

8. The energy source of claim 1, wherein the electrical connectors are removably connectable to a corresponding electrical connector of the aircraft.

9. The energy source of claim 1, wherein the electric generator is configured to generate electricity as the engine rotates a shaft connected to a shaft of the electric generator.

10. The energy source of claim 1, wherein the engine is a rotary, turbine, or piston combustion engine.

11. The energy source of claim 10, wherein the at least one fuel tank comprises a first fuel tank and a second fuel tank, wherein the first fuel tank and the second fuel tank are oriented on opposite sides of an axis bisecting the enclosure from front to back.

12. The energy source of claim 1, further comprising a noise reduction chamber housed within the enclosure, wherein the noise reduction chamber comprises a plurality of channels configured to permit air to pass through the noise reduction chamber.

13. The energy source of claim 12, wherein walls of the plurality of channels are configured to absorb noise or vibration present in the exhaust air, and further wherein the walls are formed from a noise attenuating material

14. The energy source of claim 13, wherein the walls within the noise reduction chamber are substantially parallel to one another.

15. The energy source of claim 12, wherein the noise reduction chamber is located in a fluid path between the engine and an air outlet of the enclosure.

16. The energy source of claim 1, further comprising an air-cooling system housed within the enclosure, wherein the air-cooling system comprises a fan or blower mechanically driven by output power from the engine.

17. The energy source of claim 16, wherein the fan or blower is configured to direct air toward:
components of at least one of the engine or the electric generator, or
cooling elements comprising at least one of a heat exchanger or a finned heat sink configured to cool the components of at least one of the engine or the electric generator.

18. The energy source of claim 16, wherein the fan or blower is configured to direct air through at least two different air ducts housed within the enclosure.

19. The energy source of claim 18, wherein the at least two different air ducts are configured to direct air toward at least two of:
cylinder cooling components of the engine,
a heat exchanger for engine oil,
the electric generator, or
a charge air cooler of a turbocharger.

20. The energy source of claim 19, wherein each of the cylinder cooling components, the heat exchanger, and/or the charge air cooler are housed within the enclosure.

21. The energy source of claim 1, wherein the energy source is configured to attach to a wing of the aircraft.

22. The energy source of claim 21, wherein the energy source is configured to attach to an underside of the wing of the aircraft.

23. The energy source of claim 1, wherein wiring of the electrical connectors passes outside the enclosure of the energy source.

24. The energy source of claim 1, further comprising mounting hardware that is configured to permit non-destructive removal of the energy source from the aircraft.

25. The energy source of claim 1, further comprising mounting hardware that is configured to permit only destructive removal of the energy source from the aircraft.

26. A method for using a first energy source for an aircraft comprising:
mounting the first energy source to the aircraft, wherein:
the first energy source comprises an engine and an electric generator,
the engine and the electric generator are each housed within the enclosure,
the aircraft comprises a second energy source configured to provide power to a propulsion motor of the aircraft, and
the second energy source is not located within the enclosure of the first energy source;
connecting first electrical connectors of the first energy source to second electrical connectors of the aircraft; and
outputting power from the electric generator of the first energy source to at least one electrical component or electrical bus of the aircraft via the first and second electrical connectors, wherein the at least one electrical component or the electrical bus is connected to the propulsion motor of the aircraft, and further wherein the propulsion motor of the aircraft is configured to be powered by the second energy source without use of the first energy source.

27. The method of claim 26, wherein the first electrical connectors and second electrical connectors further comprise controls wiring, and further wherein the method comprises receiving, from a controller of the aircraft at a controller of the first energy source, a throttle control signal or power request signal via the first electrical connectors and second electrical connectors.

28. The method of claim 26, wherein the first energy source further comprises third electrical connectors for connecting the first energy source to another power consuming device separate from the aircraft.

29. The method of claim 26, further comprising:
powering down the first energy source such that power is no longer being output to the at least one electrical component or the electrical bus of the aircraft from the first energy source;
disconnecting the first electrical connectors of the first energy source from the second electrical connectors of the aircraft; and
removing the first energy source from the aircraft.

30. The method of claim 29, wherein the aircraft is flyable after the first energy source is removed from the aircraft.
